(19) United States
(12) Patent Application Publication
(10) Pub. No.: US 2026/0164367 A1
(43) Pub. Date: Jun. 11, 2026

(54) METHOD AND DEVICE FOR POWER HEADROOM REPORTING FOR MULTI-PANEL SIMULTANEOUS TRANSMISSION TECHNIQUE

(71) Applicant: Samsung Electronics Co., Ltd., Suwon-si (KR)

(72) Inventors: Seongmok LIM, Suwon-si (KR); Youngrok JANG, Suwon-si (KR); Hyoungju JI, Suwon-si (KR)

(21) Appl. No.: 19/302,510

(22) Filed: Aug. 18, 2025

(30) Foreign Application Priority Data
Aug. 16, 2024 (KR) 10-2024-0109851

(51) Int. Cl. H04W 52/36; H04L 5/00; H04W 52/42

(52) U.S. Cl. CPC H04W 52/365; H04L 5/0094; H04W 52/42

(57) ABSTRACT

The disclosure relates to a 5G or 6G communication system for supporting a higher data transmission rate. A method performed by a terminal in a communication system is provided. The method includes receiving, from a base station, a radio resource control (RRC) message including a power headroom reporting (PHR) configuration and a control resource set (CORESET) configuration, identifying that a PHR is triggered, and in case that two PHR mode is not included in the PHR configuration and two physical uplink shared channel (PUSCH) transmissions associated with different coresetPoolIndex values included in the CORESET configuration are overlapped in time, transmitting, to the base station, one PHR for a PUSCH transmission associated with coresetPoolIndex value 0.

### CROSS-REFERENCE TO RELATED APPLICATION(S)

This application is based on and claims priority under 35 U.S.C. § 119(a) of a Korean patent application number 10-2024-0109851, filed on Aug. 16, 2024, in the Korean Intellectual Property Office, the disclosure of which is incorporated by reference herein in its entirety.

### BACKGROUND

### 1. Field

The disclosure relates to operations of a terminal and a base station in a wireless communication system. More particularly, the disclosure relates to a method for power headroom reporting for supporting a multi-panel simultaneous transmission technique in network cooperative communication and a device capable of performing the same.

### 2. Description of Related Art

Fifth generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz bands (for example, 95 GHz to 3 terahertz (THz) bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple-input and multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an apparatus and a method capable of effectively providing services in a mobile communication system.

Additional aspects will be set forth in part in the description which follows and, in part, will be apparent from the description, or may be learned by practice of the presented embodiments.

In accordance with an aspect of the disclosure, a method performed by a terminal in a communication system is provided. The method includes receiving, from a base station, a radio resource control (RRC) message including a power headroom reporting (PHR) configuration and a control resource set (CORESET) configuration, identifying that a PHR is triggered, and in case that two PHR mode is not included in the PHR configuration and two physical uplink shared channel (PUSCH) transmissions associated with different coresetPoolIndex values included in the CORESET configuration are overlapped in time, transmitting, to the base station, one PHR for a PUSCH transmission associated with coresetPoolIndex value 0.

In accordance with another aspect of the disclosure, a method performed by a base station in a communication system is provided. The method includes transmitting, to a terminal, a radio resource control (RRC) message including a power headroom reporting (PHR) configuration and a control resource set (CORESET) configuration, and in case that a PHR is triggered, receiving, from the terminal, one PHR for a physical uplink shared channel (PUSCH) transmission associated with coresetPoolIndex value 0 based on two PHR mode being not included in the PHR configuration and two PUSCH transmissions associated with different coresetPoolIndex values included in the CORESET configuration overlapping in time.

In accordance with another aspect of the disclosure, a terminal in a communication system is provided. The terminal includes at least one transceiver, at least one processor communicatively coupled to the at least one transceiver, and at least one memory, communicatively coupled to the at least one processor, storing instructions executable by the at least one processor individually or in any combination to cause the terminal to receive, from a base station, a radio resource control (RRC) message including a power headroom reporting (PHR) configuration and a control resource set (CORESET) configuration, identify that a PHR is triggered, and in case that two PHR mode is not included in the PHR configuration and two physical uplink shared channel (PUSCH) transmissions associated with different coresetPoolIndex values included in the CORESET configuration are overlapped in time, transmit, to the base station, one PHR for a PUSCH transmission associated with coresetPoolIndex value 0.

In accordance with another aspect of the disclosure, a base station in a communication system is provided. The base station includes at least one transceiver, at least one processor communicatively coupled to the at least one transceiver, and at least one memory, communicatively coupled to the at least one processor, storing instructions executable by the at least one processor individually or in any combination to cause the base station to transmit, to a terminal, a radio resource control (RRC) message including a power headroom reporting (PHR) configuration and a control resource set (CORESET) configuration, and in case that a PHR is triggered, receive, from the terminal, one PHR for a physical uplink shared channel (PUSCH) transmission associated with coresetPoolIndex value 0 based on two PHR mode being not included in the PHR configuration and two PUSCH transmissions associated with different coresetPoolIndex values included in the CORESET configuration overlapping in time.

In accordance with another aspect of the disclosure, one or more non-transitory computer-readable storage media storing one or more computer programs including computer-executable instructions that, when executed by one or more processors of a terminal individually or collectively, cause the terminal to perform operations are provided. The operations include receiving, by the terminal from a base station, a radio resource control (RRC) message including a power headroom reporting (PHR) configuration and a control resource set (CORESET) configuration, identifying, by the terminal, that a PHR is triggered, and based on two PHR mode being not included in the PHR configuration and two physical uplink shared channel (PUSCH) transmissions associated with different coresetPoolIndex values included in the CORESET configuration are overlapped in time, transmitting, by the terminal to the base station, one PHR for a PUSCH transmission associated with coresetPoolIndex value 0.

Embodiments set forth herein provide an apparatus and a method capable of effectively providing services in a mobile communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a beam application time which may be considered in a case where a unified transmission configuration indicator (TCI) scheme is used in a wireless communication system according to an embodiment of the disclosure;

FIG. 2 illustrates another medium access control (MAC)-control element (CE) structure for activation and indication of a joint TCI state or separate downlink (DL) or uplink (UL) TCI state in a wireless communication system according to an embodiment of the disclosure;

FIG. 3 illustrates an MAC CE structure including a single piece of power headroom reporting (PHR) information according to an embodiment of the disclosure;

FIG. 4A illustrates an MAC CE structure including multiple pieces of PHR information according to various embodiments of the disclosure;

FIG. 4B illustrates an MAC CE structure including multiple pieces of PHR information according to various embodiments of the disclosure;

FIG. 5 illustrates radio protocol structures of a base station and a user equipment (UE) in single cell, carrier aggregation, and dual connectivity situations according to an embodiment of the disclosure;

FIG. 6 illustrates an example of an antenna port configuration and resource allocation for cooperative communication in a wireless communication system according to an embodiment of the disclosure;

FIG. 7 illustrates an example of a downlink control information (DCI) configuration for cooperative communication in a wireless communication system according to an embodiment of the disclosure;

FIG. 8 illustrates an example of a case where two fully overlapping PUSCHs scheduled by two DCIs associated with different values of coresetPoolIndex received at the same time point are simultaneously transmitted in slot n in which a PUSCH for power headroom reporting is transmitted, according to an embodiment of the disclosure;

FIG. 9 illustrates an example where two PUSCHs scheduled by two DCIs associated with different values of coresetPoolIndex received at the same time point are partially overlapping, and the two PUSCHs are simultaneously transmitted in slot n in which a PUSCH for power headroom reporting is transmitted, according to an embodiment of the disclosure;

FIG. 10 illustrates an example of a case where two PUSCHs scheduled by two DCIs associated with different values of coresetPoolIndex received at the same time point are partially overlapping, and one PUSCH is transmitted in slot n in which a PUSCH for power headroom reporting is transmitted, but the other PUSCH is transmitted in slot n and/or slot n+1 that is another slot, according to an embodiment of the disclosure;

FIG. 11 illustrates an example of a case where two PUSCHs scheduled by two DCIs associated with different values of coresetPoolIndex received at different time points are fully overlapping, and simultaneously transmitted in slot n in which a PUSCH for power headroom reporting is transmitted, according to an embodiment of the disclosure;

FIG. 12 illustrates an example where two PUSCHs scheduled by two DCIs associated with different values of coresetPoolIndex received at different time points are partially overlapping in the time domain, and the two PUSCHs are simultaneously transmitted in slot n in which a PUSCH for power headroom reporting is transmitted, according to an embodiment of the disclosure;

FIG. 13 illustrates an example of a case where two PUSCHs scheduled based on two DCIs associated with different values of coresetPoolIndex received at different time points are partially overlapping in the time domain, and one PUSCH is transmitted in slot n in which a PUSCH for power headroom reporting is transmitted, but the other PUSCH is transmitted in slot n and slot n+1 that is another slot, according to an embodiment of the disclosure;

FIG. 14 is a diagram illustrating an operation of a UE according to an embodiment of the disclosure;

FIG. 15 illustrates a structure of a UE in a wireless communication system according to an embodiment of the disclosure; and

FIG. 16 illustrates a structure of a base station in a wireless communication system according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and wors used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reason, in the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, long-term evolution (LTE) or LTE-Advanced (LTE-A) systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more central processing units (CPUs) within a device or a security multimedia card. Furthermore, the “unit” in embodiments may include one or more processors.

A wireless communication system is advancing to a broadband wireless communication system for providing high-speed and high-quality packet data services using communication standards, such as high-speed packet access (HSPA) of 3rd generation partnership project (3GPP), LTE or evolved universal terrestrial radio access (E-UTRA), LTE-Advanced (LTE-A), LTE-Pro, high-rate packet data (HRPD) of 3rd generation partnership project 2 (3GPP2), ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS) (or eNode B), and the downlink refers to a radio link via which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

Enhanced mobile broadband (eMBB) aims at providing a data rate higher than that supported by existing LTE, LTE-A, or LTE-Pro. For example, in the 5G communication system, eMBB must provide a peak data rate of 20 gigabits per second (Gbps) in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multiple-input and multiple-output (MIMO) transmission technique are required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 milliseconds (ms), and also requires a packet error rate of 10-5 or less. Therefore, for the services supporting URLLC, a 5G system must provide a transmit time interval (TTI) shorter than those of other services, and also may require a design for assigning a large number of resources in a frequency band in order to secure reliability of a communication link.

The three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

In the following description, the term “a/b” may be understood as at least one of a and b.

### Unified TCI State

Hereinafter, a method for indicating and activating a single TCI state, based on a unified TCI scheme, will be described. The unified TCI scheme may refer to a scheme wherein, although existing Rel-15 and 16 have used a TCI state scheme for a UE's downlink reception and have used a spatial relation info scheme for uplink transmission (separate transmission/reception beam management scheme), the same is managed in an integrated manner by using a TCI state. Therefore, if a UE receives an instruction from a base station based on the unified TCI scheme, the UE may perform beam management by using a TCI state with regard to uplink transmission as well. If the base station has configured a TCI-State (higher layer signaling) having a tci-stateId-r17 (higher layer signaling) for the UE, the UE may perform an operation based on the unified TCI scheme by using the TCI-State. The TCI-State may exist in two types including a joint TCI state or a separate TCI state.

The first type is a joint TCI state in which all TCI states to be applied to uplink transmission and downlink reception may be indicated to a UE by a base station through one TCI-State. If a TCI-State based on a joint TCI state has been indicated to the UE, a parameter to be used for downlink channel estimation may be indicated to the UE by using a reference signal (RS) corresponding to qcl-Type1 in the TCI-State based on a joint TCI state, and a parameter to be used as a downlink reception beam or reception filter may be indicated to the UE by using an RS corresponding to qcl-Type2 therein. If a TCI-State based on a joint TCI state has been indicated to the UE, a parameter to be used as an uplink transmission beam or transmission filter may be indicated to the UE by using an RS corresponding to qcl-Type2 therein in the TCI-State based on a joint DL/UL TCI state. If a joint TCI state has been indicated to the UE, the UE may apply the same beam to both uplink transmission and downlink reception.

According to the second type (separate TCI state), the base station may individually indicate a UL TCI state to be applied to uplink transmission and a DL TCI state to be applied to downlink reception to the UE. If a UL TCI state has been indicated to the UE, a parameter to be used as an uplink transmission beam or transmission filter may be indicated to the UE by using a reference RS or source RS configured in the UL TCI state. If a DL TCI state has been indicated to the UE, a parameter to be used for downlink channel estimation may be indicated to the UE by using an RS corresponding to qcl-Type1 in the DL TCI state, and a parameter to be used as a downlink reception beam or reception filter may be indicated to the UE by using an RS corresponding to qcl-Type2 therein.

If both a DL TCI state and an UL TCI state have been indicated to the UE, a parameter to be used as an uplink transmission beam or transmission filter may be indicated to the UE by using a reference RS or source RS configured in the UL TCI state, a parameter to be used for downlink channel estimation may be indicated to the UE by using an RS corresponding to qcl-Type1 configured in the DL TCI state, and a parameter to be used as a downlink reception beam or reception filter may be indicated to the UE by using an RS corresponding to qcl-Type2 configured therein. If the DL TCI state indicated to the UE and the reference RS or source RS configured in the UL TCI state are different, the UE may apply individual beams to uplink transmission and downlink reception, respectively, based on the UL TCI state and DL TCI state indicated thereto.

A maximum of 128 joint TCI states may be configured for a particular bandwidth part in a particular cell for the UE by the base station through higher layer signaling, a maximum of 64 or 128 DL TCI states among separate TCI states may be configured for a particular bandwidth part in a particular cell through higher layer signaling, based on a UE capability report, and a DL TCI state among separate TCI states and a joint TCI state may use the same higher layer signaling structure. As an example, if 128 joint TCI states have been configured, and if 64 DL TCI states have been configured among separate TCI states, the 64 DL TCI states may be included in the 128 joint TCI states.

A maximum of 32 or 64 UL TCI states among separate TCI states may be configured for a particular bandwidth part in a particular cell through higher layer signaling, based on a UE capability report, and a UL TCI state among separate TCI states and a joint TCI state may also use the same higher layer signaling structure like the relation between a DL TCI state among separate TCI states and a joint TCI state, or a UL TCI state among separate TCI states may also use a higher layer signaling structure different from that of a joint TCI state and a DL TCI state among separate TCI states.

Such use of different or identical higher layer signaling structures may be defined in specifications, or may be distinguished through different higher layer signaling configured by the base station, based on a UE capability report containing information regarding which is to be used among two schemes that the UE may support.

The UE may use one scheme, among a joint TCI state and a separate TCI state configured by the base station, thereby receiving an indication regarding transmission/reception beam according to a unified TCI scheme. The base station may configure, for the UE, whether or not one of the joint TCI state and the separate TCI state is to be used, through higher layer signaling.

The UE may receive an indication regarding transmission/reception beam by using a scheme selected from a joint TCI state and a separate TCI state through higher layer signaling, and the base station may indicate a transmission/reception beam in two methods (a MAC-CE-based indication method and a MAC-CE-based activation and DCI-based indication method).

If the UE receives an indication regarding transmission/reception beam by using a joint TCI state through higher layer signaling, the UE may receive a MAC-CE indicating a joint TCI state from the base station, thereby performing a transmission/reception beam application operation, and the base station may schedule reception regarding a physical downlink shared channel (PDSCH) including the MAC-CE for the UE through a physical downlink control channel (PDCCH). If the MAC-CE includes one joint TCI state set, the UE may determine an uplink transmission beam or transmission filter and a downlink reception beam or reception filter by using joint TCI states included in the indicated joint TCI state set 3 ms after transmission of a physical uplink control channel (PUCCH) including hybrid automatic repeat request-acknowledgment (HARQ-ACK) information indicating whether or not the PDSCH is successfully received. If the MAC-CE includes two or more joint TCI state sets, the UE may identify that multiple joint TCI state sets indicated by the MAC-CE correspond to respective codepoints of the TCI state field of DCI format 1_1 or 1_2 and then activate the indicated joint TCI state sets, 3 ms after transmission of a PUCCH including HARQ-ACK information indicating whether or not the PDSCH is successfully received. Thereafter, the UE may receive DCI format 1_1 or 1_2 and may apply one joint TCI state indicated by the TCI state field in corresponding DCI to uplink transmission and downlink reception beams. DCI format 1_1 or 1_2 may include downlink data channel scheduling information (with DL assignment) or may not include the same (without DL assignment).

If the UE receives an indication regarding transmission/reception beam by using a separate TCI state through higher layer signaling, the UE may receive a MAC-CE indicating a separate TCI state from the base station, thereby performing a transmission/reception beam application operation, and the base station may schedule reception regarding a PDSCH including the MAC-CE for the UE through a PDCCH. If the MAC-CE includes one separate TCI state set, the UE may determine an uplink transmission beam or transmission filter and a downlink reception beam or reception filter by using separate TCI states included in the indicated separate TCI state set 3 ms after transmission of a PUCCH including HARQ-ACK information indicating whether or not the PDSCH is successfully received. A separate TCI state set may indicate a single or multiple separate TCI states which one codepoint of a TCI state field in DCI format 1_1 or 1_2 may have, and one separate TCI state set may include one DL TCI state, include one UL TCI state, or include one DL TCI state and one UL TCI state. If the MAC-CE includes two or more separate TCI state sets, the UE may identify that multiple separate TCI state sets indicated by the MAC-CE correspond to respective codepoints of the TCI state field of DCI format 1_1 or 1_2 and then activate the indicated separate TCI state sets, 3 ms after transmission of a PUCCH including HARQ-ACK information indicating whether or not the PDSCH is successfully received. Each codepoint of the TCI state field of DCI format 1_1 or 1_2 may indicate one DL TCI state, may indicate one UL TCI state, or may indicate one DL TCI state and one UL TCI state. The UE may receive DCI format 1_1 or 1_2 and may apply separate TCI state sets indicated by the TCI state field in corresponding DCI to uplink transmission and downlink reception beams. DCI format 1_1 or 1_2 may include downlink data channel scheduling information (with DL assignment) or may not include the same (without DL assignment).

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

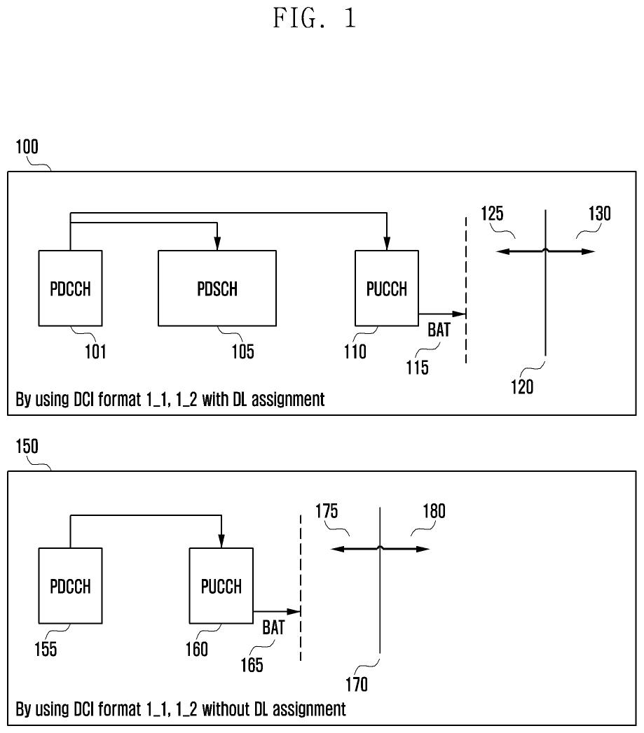

FIG. 1 illustrates a beam application time which may be considered in a case where a unified TCI scheme is used in a wireless communication system according to an embodiment of the disclosure.

Referring to FIG. 1, the UE may receive DCI format 1_1 or 1_2 including downlink data channel scheduling information (with DL assignment) or not including the same (without DL assignment) from the base station, and may apply one joint TCI state or separate TCI state set indicted by the TCI state field in corresponding DCI to uplink transmission and downlink reception beams.
DCI format 1_1 or 1_2 with DL assignment (100): If a UE receives, from a base station, DCI format 1_1 or 1_2 including downlink data channel scheduling information (101) so that one joint TCI state or one separate TCI state set based on a unified TCI scheme is indicated, the UE may receive a PDSCH scheduled based on the received DCI (105), and transmit a PUCCH including a HARQ-ACK indicating whether reception of the DCI and the PDSCH has been successful (110). The HARQ-ACK may include whether reception has been successful, for both the DCI and the PDSCH, if the UE fails to receive at least one of the DCI and the PDSCH, the UE may transmit a NACK, and if the UE succeeds in receiving both of them, the UE may transmit an ACK.
DCI format 1_1 or 1_2 without DL assignment (150): If a UE receives, from a base station, DCI format 1_1 or 1_2 not including downlink data channel scheduling information (155) so that one joint TCI state or one separate TCI state set based on a unified TCI scheme is indicated, the UE may assume at least one combination of the following items for the DCI.
The DCI includes a cyclic redundancy check (CRC) scrambled using a configured scheduling radio network temporary identifier (CS-RNTI).
The values of all bits assigned to all fields used as redundancy version (RV) fields are 1.
The values of all bits assigned to all fields used as modulation and coding scheme (MCS) fields are 1.
The values of all bits assigned to all fields used as new data indication (NDI) fields are 0.
In a case of frequency domain resource allocation (FDRA) type 0, the values of all bits assigned to an FDRA field are 0, in a case of FDRA type 1, the values of all bits assigned to an FDRA field are 1, and in a case of an FDRA scheme being dynamicSwitch, the values of all bits assigned to an FDRA field are 0.

The UE may transmit a PUCCH including a HARQ-ACK indicating whether DCI format 1_1 or 1_2 for which the items described above are assumed has been successfully received (160).
With regard to both DCI format 1_1 or 1_2 with DL assignment (100) and without DL assignment (150), if the new TCI state indicated through DCI 101 or 155 is the same as a TCI state that has previously been indicated and thus been being applied to uplink transmission and downlink reception beams, the UE may maintain the previously applied TCI state. If the new TCI state is different from the previously indicated TCI state, the UE may determine, as a time point for application of the joint TCI state or separate TCI state set, which is indicatable by a TCI state field included in the DCI, a time point 130 or 180 after first slot 120 or 170 after passage of a time interval as long as a beam application time (BAT) 115 or 165 after PUCCH transmission, and may use the previously indicated TCI state at a time point 125 or 175 before the first slot 120 or 170.
With regard to both DCI format 1_1 or 1_2 with DL assignment (100) and without DL assignment (150), the BAT is a particular number of OFDM symbols and may be configured through higher layer signaling, based on UE capability report information, and numerologies of the BAT and the first slot after the BAT may be determined based on the smallest numerology among all cells to which a joint TCI state or separate TCI state set indicated through DCI is applied.

A UE may apply one joint TCI state indicated through a MAC-CE or DCI to reception for control resource sets connected to all UE-specific search spaces, reception of a PDSCH scheduled by a PDCCH transmitted from the control resource sets and transmission of a PUSCH, and transmission of all PUCCH resources.

If one separate TCI state set indicated through a MAC-CE or DCI includes one DL TCI state, a UE may apply the one separate TCI state set to reception for control resource sets connected to all UE-specific search spaces and to reception of a PDSCH scheduled by a PDCCH transmitted from the control resource sets, and apply a previously indicated UL TCI state to all PUSCH and PUCCH resources.

If one separate TCI state set indicated through a MAC-CE or DCI includes one UL TCI state, a UE may apply the one separate TCI state set to all PUSCH and PUCCH resources, and apply a previously indicated DL TCI state to reception for control resource sets connected to all UE-specific search spaces and reception of a PDSCH scheduled by a PDCCH transmitted from the control resource sets.

If one separate TCI state set indicated through a MAC-CE or DCI includes one DL TCI state and one UL TCI state, a UE may apply the DL TCI state to reception for control resource sets connected to all UE-specific search spaces and reception of a PDSCH scheduled by a PDCCH transmitted from the control resource sets, and apply the UL TCI state to all PUSCH and PUCCH resources.

### Unified TCI State MAC-CE

Hereinafter, a single TCI state indication and activation method based on a unified TCI scheme is described. A PDSCH including a MAC-CE described below may be scheduled to a UE by a base station, and the UE may interpret each codepoint of a TCI state field in DCI format 1_1 or 1_2, based on information in the MAC-CE received from the base station, after 3 slots from transmission of a HARQ-ACK for the PDSCH to the base station. That is, the UE may activate each entry of the MAC-CE received from the base station in each codepoint of the TCI state field in DCI format 1_1 or 1_2.

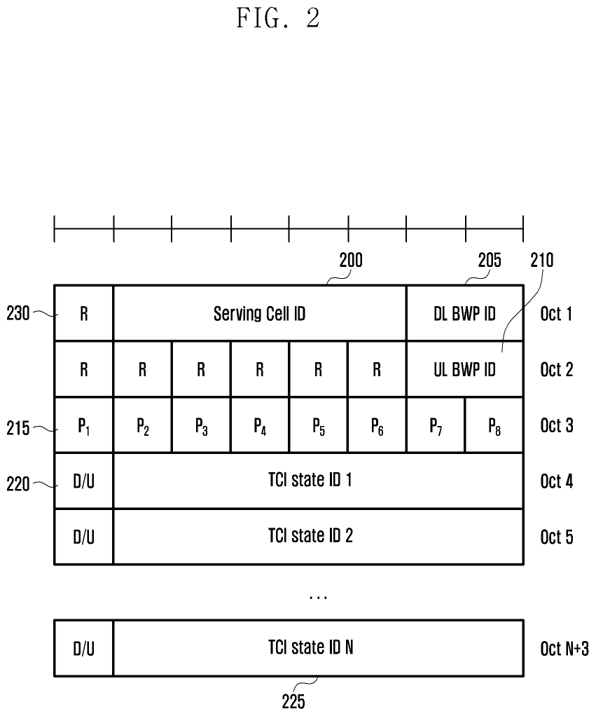

FIG. 2 illustrates another MAC-CE structure for activation and indication of a joint TCI state or a separate DL or UL TCI state in a wireless communication system according to an embodiment of the disclosure.

Referring to FIG. 2, each field in the MAC-CE structure may have the following meaning.
Serving Cell identifier (ID) 200: This field may indicate which serving cell to which a corresponding MAC-CE is to be applied. The length of this field may be 5 bits. If a serving cell indicated by this field is included in at least one of the higher layer signaling simultaneousU-TCI-UpdateList1, simultaneousU-TCI-UpdateList2, simultaneousU-TCI-UpdateList3, or simultaneousU-TCI-UpdateList4, the MAC-CE may be applied to all serving cells included in one or more lists among simultaneousU-TCI-UpdateList1, simultaneousU-TCI-UpdateList2, simultaneousU-TCI-UpdateList3, or simultaneousU-TCI-UpdateList4, in which the serving cell indicated by the field is included.
DL BWP ID 205: This field may indicate which DL BWP to which the MAC-CE is to be applied, and the meanings of codepoints in the field may correspond to codepoints of a bandwidth part indicator in DCI, respectively. The length of this field may be 2 bits.
UL BWP ID 210: This field may indicate which UL BWP to which the MAC-CE is to be applied, and the meanings of codepoints in the field may correspond to codepoints of a bandwidth part indicator in DCI, respectively. The length of this field may be 2 bits.
Pᵢ 215: This field may indicate whether each codepoint of a TCI state field in DCI format 1_1 or 1_2 has multiple TCI states or one TCI state. If the value of Pᵢ is 1, this indicates that a corresponding i-th codepoint has multiple TCI states, and may imply that the codepoint may include a separate DL TCI state and a separate UL TCI state. If the value of Pᵢ is 0, this indicates that a corresponding i-th codepoint has a single TCI state, and may imply that the codepoint may include one type among a joint TCI state, a separate DCI TCI state, or a separate UL TCI state.
D/U 220: This field may indicate whether a TCI state ID field in the same octet is a joint TCI state, a separate DL TCI state, or a separate UL TCI state. If the field is 1, a TCI state ID field in the same octet may be a joint TCI state or a separate DL TCI state, and If the field is 0, a TCI state ID field in the same octet may be a separate UL TCI state.
TCI state ID 225: This field may indicate a TCI state identifiable by the higher layer signaling TCI-StateId. If the D/U field is configured to be 1, the TCI state ID field may be used to represent TCI-StateId expressible by 7 bits. If the D/U field is configured to be 0, a most significant bit (MSB) of the TCI state ID field may be considered as a reserved bit, and the remaining 6 bits may be used to represent the higher layer signaling UL-TCIState-Id. The number of maximally activatable TCI states may be 8 in a case of joint TCI states, and may be 16 in a case of separate DL or UL TCI states.
R 230: This indicates a reserved bit and may be configured to be 0.

With regard to the MAC-CE structure of FIG. 2, a UE may include, in the MAC-CE structure, a third octet including P1, P2, . . . , and P8 fields in FIG. 2 regardless of unifiedTCI-StateType-r17 in MIMOparam-r17 in the higher layer signaling ServingCellConfig being configured to be joint or separate. In this case, the UE may perform TCI state activation by using a fixed MAC-CE structure regardless of higher layer signaling configured by a base station. As another example, with regard to the MAC-CE structure of FIG. 2, a UE may omit the third octet including P1, P2, . . . , and P8 fields illustrated in FIG. 2, in a case where unifiedTCI-StateType-r17 in MIMOparam-r17 in the higher layer signaling ServingCellConfig being configured to be joint. In this case, the UE may save the payload of the MAC-CE by a maximum of 8 bits according to higher layer signaling configured by a base station. In addition, all D/U fields positioned on the first bits in octets starting from a fourth octet in FIG. 2 may be considered as R fields, and all the R fields may be configured to be 0 bits.

### PUSCH: Regarding Transmission Scheme

Next, a PUSCH transmission scheduling scheme will be described. PUSCH transmission may be dynamically scheduled by a UL grant inside DCI, or operated by means of configured grant Type 1 or Type 2. Dynamic scheduling indication regarding PUSCH transmission may be made by DCI format 0_0 or 0_1.

Configured grant Type 1PUSCH transmission may be configured semi-statically by receiving configuredGrantConfig including rrc-ConfiguredUplinkGrant in Table 1 through upper signaling, without receiving a UL grant inside DCI. Configured grant Type 2PUSCH transmission may be scheduled semi-persistently by a UL grant inside DCI after receiving configuredGrantConfig not including rrc-ConfiguredUplinkGrant in Table 1 through upper signaling. If PUSCH transmission is operated by a configured grant, parameters applied to the PUSCH transmission are applied through configuredGrantConfig (upper signaling) in Table 1 except for dataScramblingIdentityPUSCH, txConfig, codebookSubset, maxRank, and scaling of UCI-OnPUSCH, which are provided by pusch-Config (upper signaling) in Table 2. If provided with transformPrecoder inside configuredGrantConfig (upper signaling) in Table 1, the UE applies tp-pi2BPSK inside pusch-Config in Table 2 to PUSCH transmission operated by a configured grant.

TABLE 1

| | |
|---|---|
| ConfiguredGrantConfig ::= | SEQUENCE { |
| frequencyHopping | ENUMERATED {intraSlot, interSlot} |

OPTIONAL, -- Need S,

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease {CG-UCI-OnPUSCH } |

OPTIONAL, -- Need M

| | |
|---|---|
| resourceAllocation | ENUMERATED {resourceAllocationType0, |

resourceAllocationType1, dynamicSwitch },

| | | |
|---|---|---|
| rbg-Size | ENUMERATED {config2} | OPTIONAL, |

-- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |
| | sym2, sym7, sym1x14, sym2x14, sym4x14, sym5x14, |

sym8x14, sym10x14, sym16x14, sym20x14,

sym32x14, sym40x14, sym64x14, sym80x14, sym128x14,

sym160x14, sym256x14, sym320x14, sym512x14,

sym640x14, sym1024x14, sym1280x14, sym2560x14,

sym5120x14,

sym6, sym1x12, sym2x12, sym4x12, sym5x12, sym8x12,

sym10x12, sym16x12, sym20x12, sym32x12,

sym40x12, sym64x12, sym80x12, sym128x12, sym160x12,

sym256x12, sym320x12, sym512x12, sym640x12,

sym1280x12, sym2560x12

}

| | | |
|---|---|---|
| configuredGrantTimer | INTEGER (1..64) | OPTIONAL, |

-- Need R

| rrc-ConfiguredUplinkGrant | SEQUENCE { | |
|---|---|---|
| timeDomainOffset | INTEGER (0..5119), | |
| timeDomainAllocation | INTEGER (0..15), | |
| frequencyDomainAllocation | BIT STRING (SIZE(18)), | |
| antennaPort | INTEGER (0..31), | |
| dmrs-SeqInitialization | INTEGER (0..1) | OPTIONAL, |

-- Need R

| precodingAndNumberOfLayers | INTEGER (0..63), | |
|---|---|---|
| srs-ResourceIndicator | INTEGER (0..15) | OPTIONAL, |

-- Need R

| | |
|---|---|
| mcsAndTBS | INTEGER (0..31), |
| frequencyHoppingOffset | INTEGER (1.. maxNrofPhysicalResourceBlocks−1) |

OPTIONAL, -- Need R

| | |
|---|---|
| pathlossReferenceIndex | INTEGER (0..maxNrofPUSCH- |

```
PathlossReferenceRSs−1),
    ...
  }
```

OPTIONAL, -- Need

R
...
}

Next, a PUSCH transmission method will be described. The demodulation reference signal (DMRS) antenna port for PUSCH transmission is identical to an antenna port for SRS transmission. PUSCH transmission may follow a codebook-based transmission method and a non-codebook-based transmission method according to whether the value of txConfig inside pusch-Config in Table 2, which is upper signaling, is “codebook” or “nonCodebook”.

As described above, PUSCH transmission may be dynamically scheduled through DCI format 0_0 or 0_1, and may be semi-statically configured by a configured grant. Upon receiving indication of scheduling regarding PUSCH transmission through DCI format 0_0, the UE performs beam configuration for PUSCH transmission by using pucch-spatialRelationInfoID corresponding to a UE-specific PUCCH resource corresponding to the minimum ID inside an activated uplink BWP inside a serving cell, and the PUSCH transmission is based on a single antenna port. The UE does not expect scheduling regarding PUSCH transmission through DCI format 0_0 inside a BWP having no configured PUCCH resource including pucch-spatialRelationInfo. If the UE has no configured txConfig inside pusch-Config in Table 2, the UE does not expect scheduling through DCI format 0_1.

TABLE 2

| | |
|---|---|
| PUSCH-Config ::= | SEQUENCE { |
| dataScramblingIdentityPUSCH | INTEGER (0..1023) |

OPTIONAL, -- Need S

| | |
|---|---|
| txConfig | ENUMERATED {codebook, nonCodebook} |

OPTIONAL, -- Need S

| | |
|---|---|
| dmrs-UplinkForPUSCH-MappingTypeA | SetupRelease {DMRS-UplinkConfig } |

OPTIONAL, -- Need M

| | |
|---|---|
| dmrs-UplinkForPUSCH-MappingTypeB | SetupRelease {DMRS-UplinkConfig } |

OPTIONAL, -- Need M

| | |
|---|---|
| pusch-PowerControl PUSCH-PowerControl | OPTIONAL, -- Need M |
| frequencyHopping | ENUMERATED {intraSlot, interSlot} |

OPTIONAL, -- Need S

| | |
|---|---|
| frequencyHoppingOffsetLists | SEQUENCE (SIZE (1..4)) OF INTEGER (1.. |

maxNrofPhysicalResourceBlocks−1)

OPTIONAL, -- Need

M

| | |
|---|---|
| resourceAllocation | ENUMERATED {resourceAllocationType0, |

resourceAllocationType1, dynamicSwitch},

| | |
|---|---|
| pusch-TimeDomainAllocationList | SetupRelease { PUSCH- |
| TimeDomainResourceAllocationList } | OPTIONAL, -- Need M |
| pusch-AggregationFactor | ENUMERATED {n2, n4, n8 } |

OPTIONAL, -- Need S

| | |
|---|---|
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| transformPrecoder | ENUMERATED {enabled, disabled} |

OPTIONAL, -- Need S

| | |
|---|---|
| codebookSubset | ENUMERATED {fullyAndPartialAndNonCoherent, |

partialAndNonCoherent,nonCoherent}

OPTIONAL, -- Cond

codebookBased

| | | |
|---|---|---|
| maxRank | INTEGER (1..4) | OPTIONAL, -- |

Cond codebookBased

| | | |
|---|---|---|
| rbg-Size | ENUMERATED { config2} | OPTIONAL, |

-- Need S

| | | |
|---|---|---|
| uci-OnPUSCH | SetupRelease { UCI-OnPUSCH} | OPTIONAL, |

-- Need M

| | | |
|---|---|---|
| tp-pi2BPSK | ENUMERATED {enabled} | OPTIONAL, |

-- Need S
...
}

Hereinafter, codebook-based PUSCH transmission will be described. The codebook-based PUSCH transmission may be dynamically scheduled through DCI format 0_0 or 0_1, and may be operated semi-statically by a configured grant. If a codebook-based PUSCH is dynamically scheduled through DCI format 0_1 or configured semi-statically by a configured grant, the UE determines a precoder for PUSCH transmission, based on an SRS resource indicator (SRI), a transmission precoding matrix indicator (TPMI), and a transmission rank (the number of PUSCH transmission layers).

The SRI may be given through the SRS resource indicator (a field inside DCI) or configured through srs-ResourceIndicator (upper signaling). During codebook-based PUSCH transmission, the UE has at least one SRS resource configured therefor, and may have a maximum of two SRS resources configured therefor. If the UE is provided with the SRI through DCI, the SRS resource indicated by the corresponding SRI refers to the SRS resource corresponding to the SRI, among SRS resources transmitted prior to the PDCCH including the corresponding SRI. In addition, the TPMI and the transmission rank may be given through “precoding information and number of layers” (a field inside DCI) or configured through precodingAndNumberOfLayers (upper signaling). The TPMI is used to indicate a precoder to be applied to PUSCH transmission. If one SRS resource is configured for the UE, the TPMI may be used to indicate a precoder to be applied in the configured one SRS resource. If multiple SRS resources are configured for the UE, the TPMI is used to indicate a precoder to be applied in an SRS resource indicated through the SRI.

The precoder to be used for PUSCH transmission is selected from an uplink codebook having the same number of antenna ports as the value of nrofSRS-Ports inside SRS-Config (upper signaling). In connection with codebook-based PUSCH transmission, the UE determines a codebook subset, based on codebookSubset inside pusch-Config (upper signaling) and TPMI. The codebookSubset inside pusch-Config (upper signaling) may be configured to be one of “fullyAndPartialAndNonCoherent”, “partialAndNonCoherent”, or “nonCoherent”, based on UE capability reported by the UE to the base station. If the UE reported “partialAndNonCoherent′” as UE capability, the UE does not expect that the value of codebookSubset (upper signaling) will be configured as “fullyAndPartialAndNonCoherent”. In addition, if the UE reported “nonCoherent” as UE capability, UE does not expect that the value of codebookSubset (upper signaling) will be configured as “fullyAndPartialAndNonCoherent” or “partialAndNonCoherent”. If nrofSRS-Ports inside SRS-ResourceSet (upper signaling) indicates two SRS antenna ports, the UE does not expect that the value of codebookSubset (upper signaling) will be configured as “partialAndNonCoherent”.

The UE may have one SRS resource set configured therefor, wherein the value of usage inside SRS-ResourceSet (upper signaling) is “codebook”, and one SRS resource may be indicated through an SRI inside the corresponding SRS resource set. If multiple SRS resources are configured inside the SRS resource set wherein the value of usage inside SRS-ResourceSet (upper signaling) is “codebook”, the UE expects that the value of nrofSRS-Ports inside SRS-Resource (upper signaling) is identical for all SRS resources.

The UE transmits, to the base station, one or multiple SRS resources included in the SRS resource set wherein the value of usage is configured as “codebook” according to upper signaling, and the base station selects one from the SRS resources transmitted by the UE and indicates the UE to be able to transmit a PUSCH by using transmission beam information of the corresponding SRS resource. In connection with the codebook-based PUSCH transmission, the SRI is used as information for selecting the index of one SRS resource, and is included in DCI. Additionally, the base station adds information indicating the rank and TPMI to be used by the UE for PUSCH transmission to the DCI. Using the SRS resource indicated by the SRI, the UE applies, in performing PUSCH transmission, the precoder indicated by the rank and TPMI indicated based on the transmission beam of the corresponding SRS resource, thereby performing PUSCH transmission.

Next, non-codebook-based PUSCH transmission will be described. The non-codebook-based PUSCH transmission may be dynamically scheduled through DCI format 0_0 or 0_1, and may be operated semi-statically by a configured grant. If at least one SRS resource is configured inside an SRS resource set wherein the value of usage inside SRS-ResourceSet (upper signaling) is “nonCodebook”, non-codebook-based PUSCH transmission may be scheduled for the UE through DCI format 0_1.

With regard to the SRS resource set wherein the value of usage inside SRS-ResourceSet (upper signaling) is “nonCodebook”, one connected non-zero power (NZP) channel state information reference signal (CSI-RS) resource may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than 42 symbols, the UE does not expect that information regarding the precoder for SRS transmission will be updated.

If the configured value of resourceType inside SRS-ResourceSet (upper signaling) is “aperiodic”, the connected NZP CSI-RS is indicated by an SRS request which is a field inside DCI format 0_1 or 1_1. If the connected NZP CSI-RS resource is an aperiodic NZP CSI-RS resource, the existence of the connected NZP CSI-RS is indicated with regard to the case in which the value of SRS request (a field inside DCI format 0_1 or 1_1) is not “00”. The corresponding DCI should not indicate cross carrier or cross BWP scheduling. In addition, if the value of SRS request indicates the existence of a NZP CSI-RS, the NZP CSI-RS is located in the slot used to transmit the PDCCH including the SRS request field. In this case, TCI states configured for the scheduled subcarrier are not configured as QCL-TypeD.

If there is a periodic or semi-persistent SRS resource set configured, the connected NZP CSI-RS may be indicated through associatedCSI-RS inside SRS-ResourceSet (upper signaling). With regard to non-codebook-based transmission, the UE does not expect that spatialRelationInfo which is upper signaling regarding the SRS resource and associatedCSI-RS inside SRS-ResourceSet (higher signaling) will be configured together.

If multiple SRS resources are configured for the UE, the UE may determine a precoder to be applied to PUSCH transmission and the transmission rank, based on an SRI indicated by the base station. The SRI may be indicated through the SRS resource indicator (a field inside DCI) or configured through srs-ResourceIndicator (upper signaling). Similarly to the above-described codebook-based PUSCH transmission, if the UE is provided with the SRI through DCI, the SRS resource indicated by the corresponding SRI refers to the SRS resource corresponding to the SRI, among SRS resources transmitted prior to the PDCCH including the corresponding SRI. The UE may use one or multiple SRS resources for SRS transmission, and the maximum number of SRS resources that can be transmitted simultaneously in the same symbol inside one SRS resource set and the maximum number of SRS resources are determined by UE capability reported to the base station by the UE. SRS resources simultaneously transmitted by the UE occupy the same RB. The UE configures one SRS port for each SRS resource. There may be only one configured SRS resource set wherein the value of usage inside SRS-ResourceSet (upper signaling) is “nonCodebook”, and a maximum of four SRS resources may be configured for non-codebook-based PUSCH transmission.

The base station transmits one NZP-CSI-RS connected to the SRS resource set to the UE, and the UE calculates the precoder to be used when transmitting one or multiple SRS resources inside the corresponding SRS resource set, based on the result of measurement when the corresponding NZP-CSI-RS is received. The UE applies the calculated precoder when transmitting, to the base station, one or multiple SRS resources inside the SRS resource set wherein the configured usage is “nonCodebook”, and the base station selects one or multiple SRS resources from the received one or multiple SRS resources. In connection with the non-codebook-based PUSCH transmission, the SRI indicates an index that may express one SRS resource or a combination of multiple SRS resources, and the SRI is included in DCI. The number of SRS resources indicated by the SRI transmitted by the base station may be the number of transmission layers of the PUSCH, and the UE transmits the PUSCH by applying the precoder applied to SRS resource transmission to each layer.

### PUSCH: Regarding Transmission Power

As an example of the disclosure, descriptions are provided for a method of, when uplink data is transmitted through an uplink data channel (physical uplink shared channel (PUSCH)) in response to a power control command received from a base station, configuring and transmitting transmission power of the uplink data channel by a UE. Uplink data channel transmission power of the UE may be determined as in the following Equation 1 expressed in dBm, together with a PUSCH power control adjustment state corresponding to an i-th transmission occasion, parameter set configuration index j, and closed-loop index l. In the following Equation 1, when the UE supports multiple carrier frequencies in multiple cells, each parameter may be determined for each cell c, carrier frequency f, and bandwidth part b, and may be identified by index b, f, or c.

$$Equation 1$$

$${P}_{PUSCH , b , f , c} ( i , j , {q}_{d} , l ) = min \{ \begin{matrix}{P}_{CMAX , f , c} ( i ) , \\ \begin{matrix}{P}_{{0}_{PUSCH} , b , f , c} ( j ) + 10 {log}_{10} ( \text{?} * {M}_{RB , b , f , c}^{PUSCH} ( i ) ) + \\ \text{?} \cdot {PL}_{b , f , c} ( {q}_{d} ) + Δ \text{?} * i ) + {f}_{b , f , c} ( \text{?} )\end{matrix}\end{matrix} \} [ dBm ]$$

$$\text{?} \text{indicates text missing or illegible when filed}$$

P_{CMAX,f,c}(i): is a maximum transmission power available to the UE in an i-th transmission occasion and is determined by a power class of the UE, parameters activated by the base station, and various parameters embedded in the UE.
P₀_{_{PUSCH,b,f,c}}(j):P₀_{_{PUSCH,b,f,c}}(j) is composed of the sum of P_{0 NOMINAL PUSCH,f,c}(j) and P_{0 UE PUSCH, b,f,c}(j). _{P0 NOMINAL PUSCH,f,c}(j) is configured for the UE via cell-specific higher-layer signaling, and P_{0 UE PUSCH, b,f,c}(j) is a value configured via UE-specific higher-layer signaling. Here, j=0 indicates a PUCCH for transmission of msg3, j=1 indicates a configured grant PUSCH, and if j is one value among {2, . . . , J−1} (j={2, . . . , J−1}), a grant PUSCH is indicated.
μ: subcarrier spacing configuration value

$${M}_{RB , b , f , c}^{PUSCH} ( i ) :$$

may indicate a resource amount used in the i-th PUSCH transmission occasion (e.g., the number of resource blocks (RBs) used for PUSCH transmission in the frequency axis).
α_{b,c,f}(j): is a value to compensate for a pathloss, and indicates a value that may be determined (in the case of a dynamic grant PUSCH) via a higher-layer configuration and an SRS resource indicator (SRI).
PL_{b,f,c}(q_{d}): denotes a pathloss between the base station and the UE, and the UE calculates the pathloss from a difference between a transmission power of a reference signal (RS) resource q_{d} signaled by the base station and a UE reception signal level of the reference signal. This indicates a downlink pathloss estimation value estimated by the UE via a reference signal having reference signal index q_{d}, and reference signal index q_{d} may be determined by the UE via a higher-layer configuration and an SRI (in the case of a dynamic grant PUSCH or a configured grant PUSCH (type 2 configured grant PUSCH) based on ConfiguredGrantConfig that does not include higher-layer configuration rrc-ConfiguredUplinkGrant) or via a higher-layer configuration.
Δ_{TF,b,f,c}(i): indicates a value determined according to a modulation coding scheme (MCS) and a format of information transmitted on a PUSCH (transport format (TF), for example, whether UL-SCH is included or CSI is included, etc.).
f_{b,f,c}(i,l): is a closed-loop power control value and indicates a value for closed-loop index l which may be determined via a higher-layer configuration and an SRI for a PUSCH. Here, the closed-loop power control for PUSCH transmission may be supported by divided methods of an accumulation method of accumulating and applying values indicated by transmit power control (TPC) commands and an absolute method of directly applying a value indicated by a TPC command, and this may be determined according to whether higher-layer parameter tpc-Accumulation has been configured. If higher-layer parameter tpc-Accumulation is configured to disabled, the closed-loop power control for PUSCH transmission is performed by the absolute method, and if tpc-Accumulation is not configured, the closed-loop power control for PUSCH transmission is performed by the accumulation method.

PUSCH power control adjustment state f_{b,f,c}(i,l) may be determined via bandwidth part b, carrier frequency f, cell c, the i-th transmission occasion, and closed loop index l.
δ_{PUSCH,b,f,c}(i,l): may be a value indicated by a TPC command field included in DCI format 0_0, 0_1, or 0_2 for scheduling of the i-th PUSCH transmission occasion corresponding to closed loop index l within bandwidth part b, carrier frequency f, and cell c, or may be a value indicated by a TPC command field included in DCI format 2_2 transmitted with a CRC scrambled by TPC-PUSCH-RNTI.
If the UE has been configured with higher-layer signaling of twoPUSCH-PC-AdjustmentStates, closed loop index l may have a value of 0 or 1.
If the UE has not been configured with higher-layer signaling of twoPUSCH-PC-AdjustmentStates, or has been scheduled for RAR UL grant-based PUSCH transmission, closed loop index l may have a value of 0.
If the UE has been configured with higher-layer signaling of ConfiguredGrantConfig, and performs PUSCH transmission or retransmission for the same, closed loop index l may conform to higher-layer signaling of a powerControlLoopToUse value.
If the UE has been configured with higher-layer signaling of SRI-PUSCH-PowerControl, the UE may obtain a connection relationship between a value indicated by an SRS resource indicator (SRI) field in a DCI format used for PUSCH transmission scheduling and closed loop index l configured via higher-layer signaling of sri-PUSCH-ClosedLoopIndex, and may determine, based on the connection relationship, closed loop index l based on the value indicated by the SRI field in the DCI format.
If the UE has been scheduled for PUSCH transmission based on a DCI format that does not include an SRI field, or has not been configured with higher-layer signaling of SRI-PUSCH-PowerControl, the UE may consider closed loop index l to be 0.
If the UE has been indicated with a TPC command value via a TPC command field included in DCI format 2_2 transmitted with a CRC scrambled by TPC-PUSCH-RNTI, closed loop index l may be indicated via a closed loop index field included in DCI format 2_2.
If the UE has not been configured with higher-layer signaling of tpc-Accumulation, that is, if a TPC command accumulation operation is possible for the UE, PUSCH power control adjustment state f_{b,f,c}(t,l) for the i-th PUSCH transmission occasion corresponding to closed loop index l within bandwidth part b, carrier frequency f, and cell c may be calculated as in Equation 2.

$${f}_{b , f , c} ( i , l ) = {f}_{b , f , c} ( i - {i}_{0} , l ) + {\sum }_{m = 0}^{c ( {D}_{i} ) - 1} {δ}_{PUSCH , b , f , c} ( m , l ) \qquad Equation 2$$

δ_{PUSCH,b,f,c}(m,l), as described above, may be a value indicated by a TPC command field included in DCI format 0_0, 0_1, or 0_2 for scheduling of an m-th transmission occasion corresponding to closed loop index l within bandwidth part b, carrier frequency f, and cell c, or may be a value indicated by a TPC command field included in DCI format 2_2 transmitted with a CRC scrambled by TPC-PUSCH-RNTI. When the TPC command accumulation operation is possible, a SPUSCH, b,f,c value may have a corresponding value in [dB] units according to a value indicated by the TPC command field included in DCI format 0_0, 0_1, 0_2, or 2_2, as in Table 3. For example, if the value of the TPC command field is 0, δ_{PUSCH,b,f,c} may have a value of-1 dB.

$$O {\sum }_{m = 0}^{c ( {D}_{i} ) - 1} {δ}_{PUSCH , b , f , c} ( m , l )$$

may denote the sum of δ_{PUSCH,b,f,c} for all transmission occasions corresponding to specific set Dᵢ, based on the described TPC command values. In this case, c(Dᵢ) may denote the number of all elements belonging to set Dᵢ. Dᵢ may denote a set of DCIs including all TPC command values on which the TPC command accumulation operation is to be performed for an i-th PUSCH transmission occasion. In order to determine Dᵢ, a start point and an end point may be defined on the time domain, and all DCIs received by the UE between the two points may be included as elements of Dᵢ.
The end point for determining Dᵢ may be a point that is K_{PUSCH}(i) symbols before the start symbol of the i-th PUSCH transmission occasion.
The start point for determining Dᵢ may be a point that is K_{PUSCH}(i−i₀)−1 symbols before the start symbol of an (i−i₀)th PUSCH transmission occasion. In this case, positive integer i₀ may be determined to be a smallest value that enables a time point, which is K_{PUSCH}(i−i₀) symbols before the start symbol of the (i−i₀)th PUSCH transmission occasion, to be a time point earlier than the end point for determining Dᵢ (a point that is K_{PUSCH}(i) symbols before the start symbol of the i-th PUSCH transmission occasion).

As an example, when the end point for determining Dᵢ may be defined as sym(i), and the time point that is K_{PUSCH}(i−i₀) symbols before the start symbol of the (i−i₀)th PUSCH transmission occasion may be defined as sym(i−i₀), if sym(i)=sym(i−1)>sym(i−2)>sym(i−3) is satisfied, i₀ may be determined to be 2.
If the UE has been configured with higher-layer signaling of tpc-Accumulation, that is, if the TPC command accumulation operation is impossible for the UE, PUSCH power control adjustment state f_{b,f,c}(i,l) for the i-th PUSCH transmission occasion corresponding to closed loop index l within bandwidth part b, carrier frequency f, and cell c may be calculated as in Equation 3.

$${f}_{b , f , c} ( i , l ) = {δ}_{PUSCH , b , f , c} ( i , l ) \qquad Equation 3$$

δ_{PUSCH,b,f,c}(i,l), as described above, may be a value indicated by a TPC command field included in DCI format 0_0, 0_1, or 0_2 for scheduling of an i-th transmission occasion corresponding to closed loop index l within bandwidth part b, carrier frequency f, and cell c, or may be a value indicated by a TPC command field included in DCI format 2_2 transmitted with a CRC scrambled by TPC-PUSCH-RNTI. When the TPC command accumulation operation is impossible, a δ_{PUSCH,b,f,c} value may have a corresponding value in [dB] units according to a value indicated by the TPC command field included in DCI format 0_0, 0_1, 0_2, or 2_2, as in [Table 3]. For example, if the value of the TPC command field is 0, δ_{PUSCH,b,f,c} may have a value of-4 dB.

TABLE 3

| TPC command | Accumulated | Absolute |
|---|---|---|
| field | [dBδ_{PUSCH, b, f, c}] | δ_{PUSCH, b, f, c} [dB] |
| 0 | −1 | −4 |
| 1 | 0 | −1 |
| 2 | 1 | 1 |
| 3 | 3 | 4 |

### Regarding PHR

Power headroom reporting indicates that a UE measures the difference (i.e., this represents the available transmission power of the UE) between the nominal maximum transmission power of the UE (nominal UE maximum transmit power) and estimated power for uplink transmission and transmits the difference to a base station. Power headroom reporting may be used to support power aware packet scheduling. The estimated power for uplink transmission may be estimated power for UL-SCH (PUSCH) transmission per activated serving cell, estimated power for UL-SCH and PUCCH transmission of, in an SpCell, another MAC entity (e.g., E-UTRA MAC entity in EN-DC, NE-DC, and NGEN-DC cases in a 3GPP specification), and estimated power for SRS transmission per activated serving cell. The UE may trigger power headroom reporting if at least one of the following trigger events is satisfied.
[Trigger event 1] When the higher layer parameter phr-ProhibitTimer expires and a MAC entity has an uplink resource for new transmission, a pathloss for at least one activated support cell is changed by an amount greater than the higher layer parameter phr-Tx-PowerFactorChange dB after the latest PHR transmission. Here, an activated downlink bandwidth for the at least one activated support cell is not a dormant bandwidth. The change in the pathloss for one cell is determined by the difference between a pathloss currently measured for a current pathloss reference and a pathloss measured at a corresponding time point for a pathloss reference at the latest PHR transmission time point.
[Trigger event 2] The higher layer parameter phr-PeriodicTimer expires.
[Trigger event 3] Rather than configuration or reconfiguration of not supporting power headroom reporting, configuration or reconfiguration of a power headroom reporting function by a higher layer is performed.
[Trigger event 4] An SCell for a MAC entity having an uplink for which firstActiveDownlinkBWP-Id is not configured to be a dormant bandwidth part is activated. The firstActiveDownlinkBWP-Id indicates an identifier of a DL BWP to be activated at the time of RRC (re) configuration (when same is configured for an SpCell) or an identifier of a DL BWP to be used at the time of activation of an SCell (when same is configured for an SCell).
[Trigger event 5] A PSCell is added (that is, a PSCell is newly added or changed).
[Trigger event 6] When the higher layer parameter phr-PrhoibitTimer expires and a MAC entity has an uplink resource for new transmission, the following items a) and b) are both satisfied for activated support cells of a MAC entity having a configured uplink:
a) There is an uplink resource allocated for transmission or a PUCCH is transmitted to a corresponding cell.
b) When a MAC entity has an uplink resource for transmission or transmits a PUCCH to a corresponding cell, a power backoff required for power management for the cell is greater than the higher layer parameter phr-Tx-PowerFactorChange dB after the latest PHR transmission.
[Trigger event 7] An activated bandwidth part of an SCell for a MAC entity having a configured uplink is changed from a dormant bandwidth part to a non-dormant downlink bandwidth.
[Trigger event 8] If the higher layer parameter mpe-Reporting-FR2 for indicating whether to report a maximum permissible exposure maximum allowed UE output power reduction (MPE P-MPR) for satisfying an MPE in FR2 is configured for the UE and mpe-ProhibitTimer is not operating, when power headroom reporting is called “MPE P-MPR reporting”, a measured P-MPR applied to satisfy an FR2 MPE requirement for at least one activated FR2 support cell equal to or greater than the higher layer parameter mpe-Threshold after the latest power headroom reporting.

Power headroom reporting may be triggered according to trigger events and the UE may determine power headroom reporting according to the following additional conditions.
[Additional condition according to temporary required power backoff] A MAC entity needs to avoid triggering power headroom reporting when a required power backoff temporarily (for up to a few tens of milliseconds) decreases due to power management. If the required power backoff temporarily decreases and power headroom reporting is triggered by other trigger events, resultant temporary decrease in the value of PCMAX,f,c/PH representing the ratio between the maximum power and the remaining (available) power needs to be prevented. That is, prevention of PHR being triggered by temporary power backoff is required. For example, the condition is added so that, if PHR is triggered by other PHR trigger events (expiration of periodictimer), PH reflecting temporary power reduction caused by a required power backoff is not reported and PH excluding the effect of the required power backoff is reported.
[Condition for power headroom reporting according to UE implementation] If a single HARQ process is configured by cg-RetransmissionTimer and a power headroom report is already included in a MAC PDU for transmission by the HARQ process, but not yet transmitted through a lower layer, a method of processing the PHR content is determined according to UE implementation.

If one or more events among the trigger events occur and power headroom reporting is triggered, and an uplink transmission resource allocated through downlink control information is able to accommodate a MAC entity for power headroom reporting and a subheader therefor, the UE performs power headroom reporting through the uplink resource. The uplink resource indicates a resource for uplink transmission scheduled by the first uplink grant or the first downlink control information format (first DCI format) scheduling the initial transmission of a transport block (TB) after power headroom triggering. That is, after a power headroom trigger occurs, the UE may perform power headroom reporting through an uplink transmission scheduled by the first uplink grant or the first downlink control information format among uplink resources which are able to accommodate a MAC entity for a power headroom and a subheader therefor. Alternatively, after a power headroom trigger occurs, the UE may perform power headroom reporting through a configured grant PUSCH transmission which are able to accommodate a MAC entity for a power headroom and a subheader therefor.

The UE may, at the time of power headroom reporting for a particular cell, select, calculate, and report one of two types of pieces of power headroom information. The first type is an actual PHR and is power headroom information calculated based on the transmission power of an actually transmitted uplink signal (e.g., PUSCH). The second type is a virtual PHR (or reference format) and is power headroom information calculated based on a transmission power parameter configured in a higher layer although there is no uplink signal (e.g., PUSCH) actually transmitted. After power headroom reporting is triggered, the UE may, as described above, calculate an actual PHR, based on higher layer information for periodic/semi-persistent SRS transmission and configured grant transmission and downlink control information received until a time point including a PDCCH monitoring interval in which the first DCI format scheduling a PUSCH, through which a MAC CE including a power headroom report is to be transmitted, is received. If the UE receives downlink control information after a PDCCH monitoring interval in which the first DCI format is received, or determines a periodic/semi-persistent SRS transmission or configured grant transmission, the UE may calculate a virtual PHR for a corresponding cell. Alternatively, after power headroom reporting is triggered, the UE may calculate an actual PHR, based on higher layer information for periodic/semi-persistent SRS transmission and configured grant transmission and downlink control information received until a time point before T′_{proc,2}=T_{proc,2} corresponding to a PUSCH preparation process time described above with respect to the first uplink symbol of a configured grant PUSCH through which transmission of corresponding power headroom information is possible. If the UE receives downlink control information after a time point before T′_{proc,2} with respect to the first uplink symbol of a configured grant PUSCH, or determines a periodic/semi-persistent SRS transmission or configured grant transmission, the UE may calculate a virtual PHR for a corresponding cell.

If the UE calculates an actual PHR with respect to actual PUSCH transmission, power headroom reporting information for support cell c, carrier f, bandwidth part b, and PUSCH transmission time point i may be expressed as given in Equation 4 below.

$$\text{?} [ dB ] \qquad Equation 4$$

$$\text{?} \text{indicates text missing or illegible when filed}$$

As another example, if the UE calculates a virtual PHR, based on a transmission power parameter configured by a higher layer, power headroom reporting information for support cell c, carrier f, bandwidth part b, and PUSCH transmission time point i may be expressed as given in Equation 5 below.

$$\text{?} [ dB ] \qquad Equation 5$$

$$\text{?} \text{indicates text missing or illegible when filed}$$

According to Equation 4 above, power headroom information may be calculated by using the difference between transmission power for PUSCH transmission occasion i and maximum output power. According to Equation 5, power headroom information may be calculated by using the difference between \tilde{P}_{CMAX,f,c}, which is maximum output power when it is assumed that a maximum power reduction (MPR)-related parameter (e.g., MPR, additional-MPR (A-MPR), power management MPR (P-MPR), etc.) and ΔT_{c} are 0, and reference PUSCH transmission power using a default transmission power parameter (e.g., P_{0_NOMINAL_PUSCH,f,c}(0), p0 and alpha of P0-PUSCH-AlpahSet having p0-PUSCH-AlphaSetId=0, PL_{b,f,c}(a) corresponding to pusch-PathlossReferenceRS-Id=0, and a closed loop power adjustment value having closed loop index l=0). Description of each variable in Equation 4 and Equation 5 above may be referenced to the description of the variables in Equation 1. The A-MPR is an MPR satisfying an additional emission requirement indicated by the base station via higher layer signaling (for example, network signaling labels are identified by combining NR freq. bands with additionalSpectrumEmission indicated via RRC (Table 6.2.3.1-1A in TS 38.101-1), and A-MPR values according thereto are defined by Table 6.2.3.1-1 in TS 38.101-1). The P-MPR is an MPR which is an output power reduction of a UE maximally allowed for support cell c (maximum allowed UE output power reduction for serving cell c) and has a purpose of satisfying applicable electromagnetic energy absorption requirements. The A-MPR and P-MPR may be referenced to 3GPP specification TS 38.101-1 section 6.2. First type power headroom information in a communication system to which the disclosure is applicable may indicate power headroom information for PUSCH transmission power, second type power headroom information may indicate power headroom information for PUCCH transmission power, and third type power headroom information may indicate power headroom information for SRS transmission power. However, the disclosure is not limited thereto.

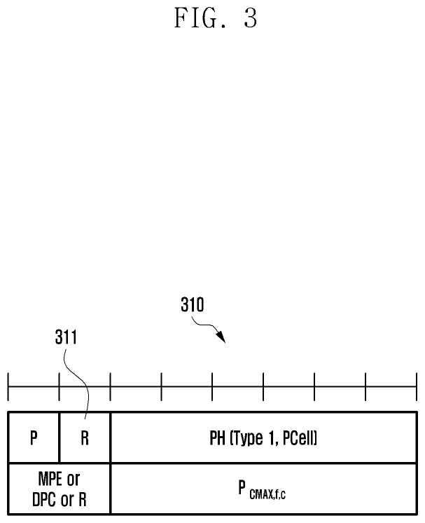

If MR-DC or UL-CA is not supported, a base station configures “false” as the higher layer parameter “multiplePHR” for a corresponding UE. This implies that the UE supports power headroom reporting for a PCell through a MAC CE having a single entry as indicated by reference numeral “310” in FIG. 3.

FIG. 3 illustrates an MAC CE structure including a single piece of PHR information according to an embodiment of the disclosure.

Referring to FIG. 3, each field in FIG. 3 may be defined as shown in Table 4 below. However, this is merely an example and the disclosure is not limited thereto.

TABLE 4
- P: If mpe-Reporting-FR2 is configured, a serving cell operates in FR2, and P-MPR
applied according to TS 38.133 is smaller than P-MPR_00, P including 1 bit is set to 0, and
is set to 1 otherwise. If mpe-Reporting-FR2 is not configured or the serving cell operates
in FR1, P indicates whether power backoff has been applied for transmission power
adjustment. If power backoff is not applied due to power management, and thus a
corresponding P_{cmax,c} field has a different value, a corresponding P field is set to 1;
- P_{CMAX,f,c}: This field indicates a maximum transmission power value used for
calculating a power headroom at the time of power headroom reporting. The field has 6
bits of information, and one of a total of 64 nominal UE transmission power levels may be
selected.
- Maximum permissible exposure (MPE): When mpe-Reporting-FR2 is configured,
the serving cell operates in FR2, and the P field is set to 1, the MPE field indicates a power
backoff value applied to satisfy MPE requirements. MPE is a 2-bit field and indicates one
of a total of four measured P-MPR value levels. If mpe-Reporting-FR2 has not been
configured, the serving cell operates in FR1, or the P field is set to 0, a reversed bit as R
may exist;
- DPC: When dpc-Reporting-FR1 is configured, and the serving cell operates in FR1,
a DPC field indicates ΔP_{PowerClass}. Here, ΔP_{PowerClass} denotes a power class change value
for indicating a maximum transmission power amount that the UE reduces to satisfy a duty
cycle as specified in technical specifications TS 38.101-1 and TS 38.101-3. This field
includes 2 bits and may indicate one of 4 indexes. If the UE does not perform DPC
reporting, the UE configures the DPC field to 0. If this field is configured to one of values
1, 2, and 3, this field indicates DPC_00, DPC_03, and DPC_06 indicating DPC level
measurement values in dB scale, respectively.
- R 311: This is a reserved bit and is set to 0;
- PH: This field indicates a power headroom level. The field includes 6 bits, and one
of a total of 64 power headroom levels may be selected.

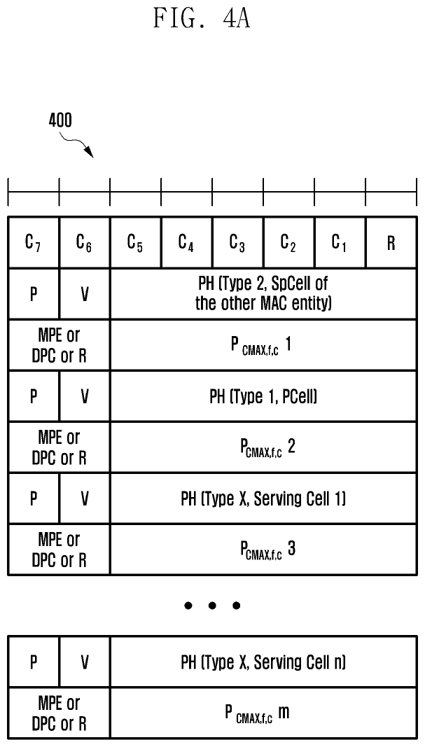

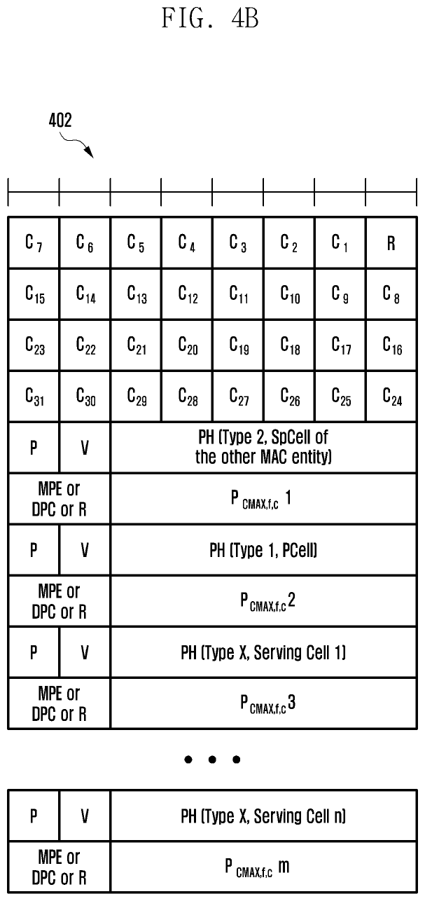

FIGS. 4A and 4B illustrate an MAC CE structure including multiple pieces of PHR information according to various embodiments of the disclosure.

If a UE supports multi-RAT dual connectivity (MR-DC) or uplink carrier aggregation (UL-CA), a base station may configure “true” as the higher layer parameter “multiplePHR” for the UE to perform power headroom reporting for each support cell. This implies that the UE supports power headroom reporting for multiple support cells through a MAC CE having multiple entries, such as a first format 400 illustrated in FIG. 4A or a second format 402 illustrated in FIG. 4B.

Referring to FIGS. 4A and 4B, a first format 400 in FIG. 4A is a PHR MAC CE format which is usable when multiple serving cells are configured and the largest index of the serving cells is smaller than 8. A second format 402 in FIG. 4B is a PHR MAC CE format which is usable when multiple serving cells are configured and the largest index of the serving cells is equal to or greater than 8. The first format 400 or the second format 402 illustrated FIG. 4B may have a variable size according to a set in which serving cells are configured and the number thereof unlike the PHR MAC CE format illustrated in FIG. 3. Corresponding information may include second type of PH information for an SpCell (special cell) of another MAC entity (e.g., LTE), and first type of PH information for a PCell. If the largest index of the serving cells is smaller than 8, a field representing serving cell information may be configured by one octet. If the largest index of the serving cells is equal to or greater than 8, a field representing serving cell information may be configured by four octets. In a PHR MAC CE, power headroom information may be included according to an order of serving cell indexes. An MAC entity may transmit a PHR MAC CE including power headroom information through a transmittable PUSCH when power headroom reporting is triggered. Whether the power headroom information is calculated based on actual transmission (i.e., this is an actual PHR) or is calculated based on a transmission power parameter configured in a higher layer (i.e., this is a virtual PHR) may be determined based on downlink control information and a higher signal received until a particular time point (a time point including a PDCCH monitoring interval in which a first DCI format is detected or a time point before T′proc,2 from the first symbol of an initial PUSCH) as described above. The fields in the PHR MAC CE formats illustrated FIGS. 4A and 4B may have the same meaning (definition) as almost fields of the PHR MAC CE format illustrated in FIG. 3, and Ci and V may have the same meaning as described in Table 5 below.

TABLE 5
- Cᵢ: This field indicates whether a power headroom field exists for a supporting cell
having ServCellIndex i. If a power headroom for supporting cell i is reported, the Cᵢ field is
set to 1. If no power headroom for supporting cell i is reported, the Cᵢ field is set to 0;
- V: This field indicates whether a power headroom value has been calculated based
on actual transmission or a reference format. For type 1 power headroom information, if
PUSCH is actually transmitted, V is set to 0, and if a reference format for PUSCH is used,
V is set to 1. For type 2 PH information, if PUCCH is actually transmitted, V is set to 0, and
if a reference format for PUCCH is used, V is set to 1. For type 3 PH information, if SRS is
actually transmitted, V is set to 0, and if a reference format for SRS is used, V is set to 1. In
addition, for the Type 1, Type 2, and Type 3 power headroom information, if the V value is
0, the P_{cmax,f,c} and MPE fields therefor may exist, and if the V value is 1, the P_{cmax,f,c} and
MPE fields therefor may be omitted.

### Regarding CA/DC

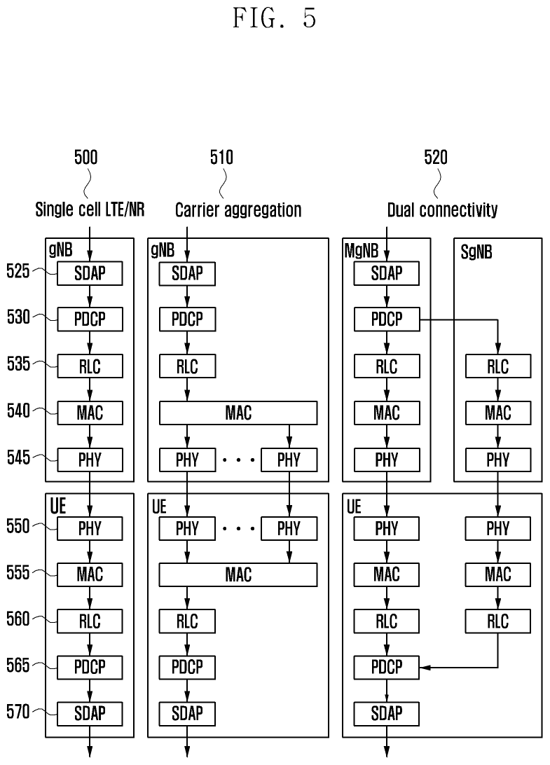

FIG. 5 illustrates radio protocol structures of a base station and a UE in single cell, carrier aggregation, and dual connectivity situations according to an embodiment of the disclosure.

Referring to FIG. 5, a radio protocol of a next-generation mobile communication system includes an NR service data adaptation protocol (SDAP) 525 or 570, an NR packet data convergence protocol (PDCP) 530 or 565, an NR radio link control (RLC) 535 or 560, and an NR medium access controls (MAC) 540 or 555, on each of UE and NR base station sides.

The main functions of the NR SDAP 525 or 570 may include some of functions below.
Transfer of user plane data
Mapping between a quality of service (QoS) flow and a data radio bearer (DRB) for both DL and UL
Marking QoS flow ID in both DL and UL packets
Reflective QoS flow to DRB mapping for the UL SDAP PDUs

With regard to the SDAP layer device, the UE may be configured, through an RRC message, whether to use the header of the SDAP layer device or whether to use functions of the SDAP layer device for each PDCP layer device or each bearer or each logical channel, and if an SDAP header is configured, the non-access stratum (NAS) QoS reflection configuration 1-bit indicator (NAS reflective QoS) and the AS QoS reflection configuration 1-bit indicator (AS reflective QoS) of the SDAP header may be indicated so that the UE can update or reconfigure mapping information regarding the QoS flow and data bearer of the uplink and downlink. The SDAP header may include QoS flow ID information indicating the QoS. The QoS information may be used as data processing priority, scheduling information, etc, for smoothly supporting services.

The main functions of the NR PDCP 530 or 565 may include some of functions below.
Header compression and decompression: robust header compression (ROHC) only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

The above-mentioned reordering of the NR PDCP device refers to a function of reordering PDCP PDUs received from a lower layer in an order based on the PDCP sequence number (SN), and may include a function of transferring data to an upper layer in the reordered sequence. Alternatively, the reordering of the NR PDCP device may include a function of instantly transferring data without considering the order, may include a function of recording PDCP PDUs lost as a result of reordering, may include a function of reporting the state of the lost PDCP PDUs to the transmitting side, and may include a function of requesting retransmission of the lost PDCP PDUs.

The main functions of the NR RLC 535 or 560 may include some of functions below.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The above-mentioned in-sequence delivery of the NR RLC device refers to a function of delivering RLC SDUs, received from the lower layer, to the upper layer in sequence. The in-sequence delivery of the NR RLC device may include at least one of a function of, if one original RLC SDU is segmented into multiple RLC SDUs and the segmented RLC SDUs are received, reassembling the RLC SDUs and delivering the reassembled RLC SDUs, a function of reordering the received RLC PDUs with reference to the RLC sequence number (SN) or PDCP sequence number (SN), a function of recording RLC PDUs lost as a result of reordering, a function of reporting the state of the lost RLC PDUs to the transmitting side, and a function of requesting retransmission of the lost RLC PDUs. The in-sequence delivery of the NR RLC device may include a function of, if there is a lost RLC SDU, successively delivering only RLC SDUs before the lost RLC SDU to the upper layer, and may include a function of, if a predetermined timer has expired although there is a lost RLC SDU, successively delivering all RLC SDUs received before the timer was started to the upper layer. Alternatively, the in-sequence delivery of the NR RLC device may include a function of, if a predetermined timer has expired although there is a lost RLC SDU, successively delivering all RLC SDUs received until now to the upper layer. In addition, the in-sequence delivery of the NR RLC device may include a function of processing RLC PDUs in the received order (regardless of the sequence number order, in the order of arrival) and delivering same to the PDCP device regardless of the order (out-of-sequence delivery), and may include a function of, in the case of segments, receiving segments which are stored in a buffer or which are to be received later, reconfiguring same into one complete RLC PDU, processing, and delivering same to the PDCP device. The NR RLC layer may include no concatenation function, which may be performed in the NR MAC layer or replaced with a multiplexing function of the NR MAC layer.

The above-mentioned out-of-sequence delivery of the NR RLC device refers to a function of instantly delivering RLC SDUs received from the lower layer to the upper layer regardless of the order, may include a function of, if multiple RLC SDUs received, into which one original RLC SDU has been segmented, are received, reassembling and delivering the same, and may include a function of storing the RLC SN or PDCP SN of received RLC PDUs, and recording RLC PDUs lost as a result of reordering.

The NR MAC 540 or 555 may be connected to multiple NR RLC layer devices configured in one UE, and the main functions of the NR MAC may include some of functions below.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
Multimedia broadcast multicast service (MBMS) service identification
Transport format selection
Padding

An NR physical layer (PHY) 545 or 550 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

The detailed structure of the radio protocol structure may be variously changed according to the carrier (or cell) operating scheme. For example, in case that the base station transmits data to the UE, based on a single carrier (or cell), the base station and the UE may use a protocol structure having a single structure with regard to each layer, such as 500. On the other hand, in case that the base station transmits data to the UE, based on carrier aggregation (CA) which uses multiple carriers in a single TRP, the base station and the UE may use a protocol structure which has a single structure up to the RLC, but multiplexes the PHY layer through a MAC layer, such as 510. As another example, in case that the base station transmits data to the UE, based on dual connectivity (DC) which uses multiple carriers in multiple TRPs, the base station and the UE may use a protocol structure which has a single structure up to the RLC, but multiplexes the PHY layer through a MAC layer, such as 520.

### Regarding NC-JT

According to an embodiment of the disclosure, in order to receive a PDSCH from a plurality of TRPs, the UE may use non-coherent joint transmission (NC-JT).

Unlike the conventional system, the 5G wireless communication system may support not only a service requiring a high transmission rate, but also a service having a very short transmission delay and a service requiring a high connection density. In a wireless communication network including multiple cells, transmission and reception points (TRPs), or beams, cooperative communication (coordinated transmission) between the respective cells, TRPs, or/and beams may satisfy various service requirements by enhancing the strength of a signal received by a UE or efficiently performing interference control between the respective cells, TRPs, or/and beams.

Joint transmission (JT) is a representative transmission technology for the aforementioned cooperative communication, and refers to a technology for increasing the strength or throughput of a signal received by a UE, by transmitting the signal to one UE via multiple different cells, TRPs, and/or beams. Here, a channel between respective cells, TRPs, and/or beam and the UE may have different characteristics, and particularly, non-coherent joint transmission (NC-JT) supporting non-coherent precoding between respective cells, TRPs, and/or beams may need individual precoding, MCS, resource allocation, and TCI indication according to the channel characteristics for each link between respective cells, TRPs, and/or beam and the UE.

The above-described NC-JT transmission may be applied to at least one of a downlink data channel (PDSCH), a downlink control channel (PDCCH), an uplink data channel (PUSCH), and an uplink control channel (PUCCH). During PDSCH transmission, transmission information such as precoding, MCS, resource allocation, and TCI may be indicated through DL DCI, and should be independently indicated for each cell, TRP, and/or beam for the NC-JT. This is a significant factor that increases payload required for DL DCI transmission, which may have a bad influence on reception performance of a PDCCH for transmitting the DCI. Accordingly, in order to support JT of the PDSCH, carefully designing a tradeoff between an amount of DCI information and reception performance of control information is required.

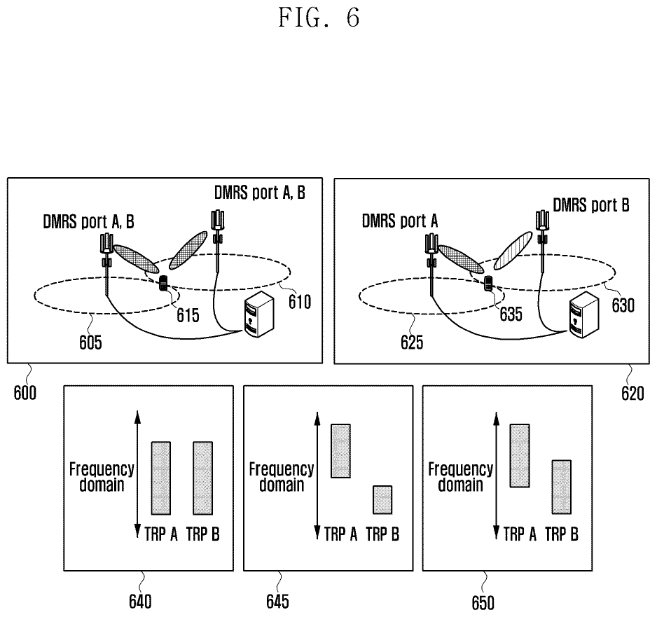

FIG. 6 illustrates a configuration of antenna ports and an example of resource allocation for transmitting a PDSCH using cooperative communication in a wireless communication system according to an embodiment of the disclosure.

Referring to FIG. 6, an example for PDSCH transmission is described for each scheme of joint transmission (JT), and examples for allocating radio resources for each TRP are illustrated.

Referring to FIG. 6, an example 600 for coherent joint transmission (C-JT) supporting coherent precoding between respective cells, TRPs, or/and beams is illustrated.

In the case of C-JT, a TRP A 605 and a TRP B 610 transmit single data (PDSCH) to a UE 615, and multiple TRPs may perform joint precoding. This may signify that the TRP A 605 and a TRP B 610 transmit DMRSs through the same DMRS ports in order to transmit the same PDSCH. For example, the TRP A 605 and a TRP B 610 may transmit DMRSs to the UE through a DMRS port A and a DMRS port B, respectively. In this case, the UE may receive one piece of DCI information for receiving one PDSCH demodulated based on the DMRSs transmitted through the DMRS port A and the DMRS port B.

Referring to FIG. 6, an example 620 of non-coherent joint transmission (NC-JT) supporting non-coherent precoding between respective cells, TRPs, and/or beams for PDSCH transmission, is illustrated.

In the case of NC-JT, the PDSCH is transmitted to a UE 635 per cell, per TPR (e.g., a TRP A 625 and a TRP B 630), and/or per beam, and individual precoding may be applied to each PDSCH. Respective cells, TRPs, and/or beams may transmit different PDSCHs or different PDSCH layers to the UE, thereby improving throughput compared to single cell, TRP, and/or beam transmission. Furthermore, respective cells, TRPs, and/or beams may repeatedly transmit the same PDSCH to the UE, thereby improving reliability compared to single cell, TRP, and/or beam transmission. For convenience of description, the cell, TRP, and/or beam are commonly called a TRP.

In this case, various radio resource allocations may be considered, such as a case 640 where frequency and time resources used in multiple TRPs for PDSCH transmission are all identical, a case 645 where frequency and time resources used in multiple TRPs do not overlap at all, and a case 650 where some of frequency and time resources used in multiple TRPs overlap.

To support NC-JT, DCI of various types, structures, and relations may be considered to assign multiple PDSCHs simultaneously to a single UE.

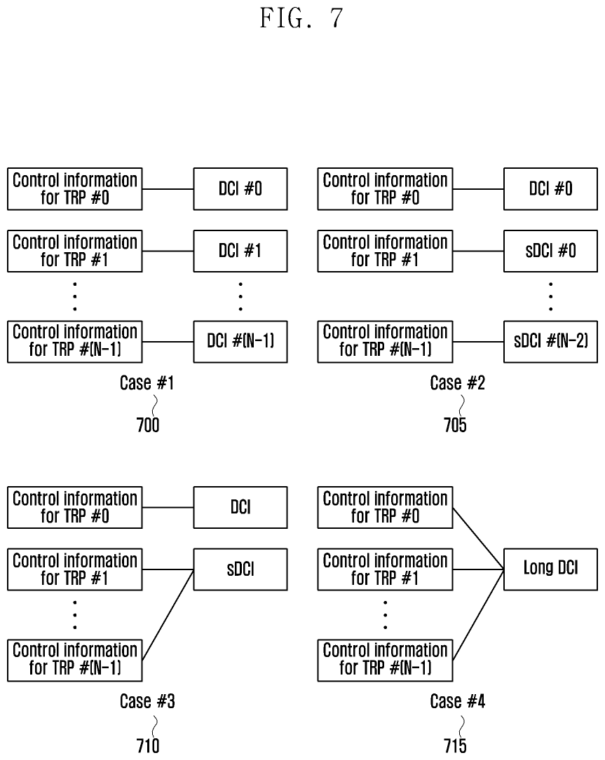

FIG. 7 illustrates an example for a configuration of downlink control information (DCI) for NC-JT in which respective TRPs transmit different PDSCHs or different PDSCH layers to the UE in a wireless communication system according to an embodiment of the disclosure.

Referring to FIG. 7, case #1 700 is an example in which control information for PDSCHs transmitted from (N−1) additional TRPs is transmitted independently from control information for a PDSCH transmitted from a serving TRP in a situation in which (N−1) different PDSCHs are transmitted from the (N−1) additional TRPs (TRP #1 to TRP #(N−1)) other than the serving TRP (TRP #0) used for single PDSCH transmission. That is, the UE may acquire control information for PDSCHs transmitted from different TRPs (TRP #0 to TRP #(N−1)) through independent DCIs (DC1 #0 to DCI #(N−1)). Formats between the independent DCIs may be the same as or different from each other, and payload between the DCIs may also be the same as or different from each other. In case #1 described above, a degree of freedom of PDSCH control or allocation may be completely guaranteed, but when respective pieces of the DCI are transmitted by different TRPs, a difference between DCI coverages may be generated and reception performance may deteriorate.

Case #2 705 is an example in which pieces of control information (DCI) for PDSCHs of (N−1) additional TRPs are transmitted and each piece of the DCI is dependent on control information for the PDSCH transmitted from the serving TRP in a situation in which (N−1) different PDSCHs are transmitted from (N−1) additional TRPs (TRP #1 to TRP #(N−1)) other than the serving TRP (TRP #0) used for single PDSCH transmission.

For example, DCI #0 that is control information for a PDSCH transmitted from the serving TRP (TRP #0) may include all information elements of DCI format 1_0, DCI format 1_1, and DCI format 1_2, but shortened DCIs (hereinafter, referred to as sDCIs) (sDCI #0 to sDCI #(N−2)) that are control information for PDSCHs transmitted from the cooperative TRPs (TRP #1 to TRP #(N−1)) may include only some of the information elements of DCI format 1_0, DCI format 1_1, and DCI format 1_2. Accordingly, in the case of sDCI for transmission of the control information for the PDSCHs transmitted from the cooperative TRPs, a payload is small compared to normal DCI (nDCI) for transmission of the control information related to the PDSCH transmitted from the serving TRP, so that reserved bits may be included in comparison with nDCI.

In case #2 described above, a degree of freedom of each PDSCH control or allocation may be limited according to content of information elements included in the sDCI, but reception capability of the sDCI is better than the nDCI, and thus a probability of the generation of difference between DCI coverages may become lower.

Case #3 710 is an example in which one piece of control information for PDSCHs of (N−1) additional TRPs is transmitted and the DCI is dependent on control information for the PDSCH transmitted from the serving TRP in a situation in which (N−1) different PDSCHs are transmitted from (N−1) additional TRPs (TRP #1 to TRP #(N−1)) other than the serving TRP (TRP #0) used for single PDSCH transmission.

For example, in the case of DCI #0 that is control information for the PDSCH transmitted from the serving TRP (TRP #0), all information elements of DCI format 1_0, DCI format 1_1, and DCI format 1_2 may be included, and in the case of control information for PDSCHs transmitted from cooperative TRPs (TRP #1 to TRP #(N−1)), only some of the information elements of DCI format 1_0, DCI format 1_1, and DCI format 1_2 may be gathered in one “secondary” DCI (sDCI) and transmitted. For example, the sDCI may include at least one piece of HARQ-related information, such as frequency domain resource assignment, time domain resource assignment, and MCS of cooperative TRPs. In addition, information that is not included in the sDCI, such as a bandwidth part (BWP) indicator or a carrier indicator, may be based on the DCI (DCI #0, normal DCI, or nDCI) of the serving TRP.

In case #3 710, a degree of freedom of PDSCH control or allocation may be limited according to content of the information elements included in the sDCI but reception performance of the sDCI can be controlled, and case #3 1130 may have smaller complexity of DCI blind decoding of the UE compared to case #1 700 or case #2 705.

Case #4 715 is an example in which control information for PDSCHs transmitted from (N−1) additional TRPs is transmitted in the DCI (long DCI) that is the same as that of control information for the PDSCH transmitted from the serving TRP in a situation in which different (N−1) PDSCHs are transmitted from the (N−1) additional TRPs (TRP #1 to TRP #(N−1)) other than the serving TRP (TRP #0) used for single PDSCH transmission. That is, the UE may acquire control information for PDSCHs transmitted from different TRPs (TRP #0 to TRP #(N−1)) through single DCI. In case #4 715, complexity of DCI blind decoding of the UE may not be increased, but a degree of freedom of PDSCH control or allocation may be low since the number of cooperative TRPs is limited according to long DCI payload restriction.

In the following description and embodiments, sDCI may refer to various pieces of supplementary DCI such as shortened DCI, secondary DCI, or normal DCI (DCI formats 1_0 and 1_1 described above) including PDSCH control information transmitted in the cooperative TRP, and unless specific restriction is mentioned, the corresponding description may be similarly applied to the various pieces of supplementary DCI.

In the following description and embodiments, case #1 700, case #2 705, and case #3 710 in which one or more pieces of DCI (or PDCCHs) are used to support NC-JT may be classified as multiple PDCCH-based NC-JT, and case #4 715 in which single DCI (or PDCCH) is used to support NC-JT may be classified as single PDCCH-based NC-JT. In multiple-PDCCH-based PDSCH transmission, a CORESET in which DCI of the serving TRP (TRP #0) is scheduled and a CORESET in which DCI of the cooperative TRPs (TRP #1 to TRP #N−1) are scheduled may be distinguished. A method of distinguishing the CORESETs may include a distinguishing method through a higher-layer indicator for each CORESET and a distinguishing method through a beam configuration for each CORESET. Furthermore, in single PDCCH-based NC-JT, single DCI schedules a single PDSCH having a plurality of layers instead of scheduling a plurality of PDSCHs, and the plurality of layers may be transmitted from a plurality of TRPs. In this case, association between a layer and a TRP transmitting the corresponding layer may be indicated through a transmission configuration indicator (TCI) indication for the layer.

In embodiments of the disclosure, “cooperative TRP” may be replaced with various terms, such as “cooperative panel” or “cooperative beam” when actually applied.

According to embodiments of the disclosure, “the case in which NC-JT is applied” may be variously interpreted as “the case in which the UE simultaneously receives one or more PDSCHs in one BWP”, “the case in which the UE simultaneously receives PDSCHs based on two or more transmission configuration indicator (TCI) indications in one BWP”, and “the case in which the PDSCHs received by the UE are associated with one or more DMRS port groups” according to circumstances, but is used by one expression for convenience of description.

In the disclosure, a radio protocol structure for NC-JT may be used in various ways according to a TRP deployment scenario. For example, if there is a small backhaul delay or no backhaul delay between cooperative TRPs, a method (CA-like method) using a structure based on MAC layer multiplexing is possible in a similar manner to reference numeral 510 of FIG. 5. On the other hand, if a backhaul delay between cooperative TRPs is so large that the backhaul delay cannot be ignored (e.g., when a time of 2 ms or longer is required for exchange of information, such as CSI, scheduling, and HARQ-ACK, between the cooperative TRPs), a method (DC-like method) of securing characteristics robust to a delay by using an independent structure for each TRP starting from the RLC layer is possible in a similar manner to reference numeral 520 of FIG. 5.

The UE supporting C-JT/NC-JT may receive a C-JT/NC-JT-related parameter or a setting value from a higher-layer configuration and set an RRC parameter of the UE based on the same. For the higher-layer configuration, the UE may use a UE capability parameter, for example, tci-StatePDSCH. Here, the UE capability parameter, for example, tci-StatePDSCH may define TCI states for PDSCH transmission, the number of TCI states may be configured as 4, 8, 16, 32, 64, and 128 in FR1 and as 64 and 128 in FR2, and a maximum of 8 states which can be indicated by 3 bits of a TCI field of the DCI may be configured through a MAC CE message among the configured numbers. A maximum value 128 refers to a value indicated by maxNumberConfiguredTCI statesPerCC within the parameter tci-StatePDSCH which is included in capability signaling of the UE. In this way, a series of configuration procedures from the higher-layer configuration to the MAC CE configuration may be applied to a beamforming change command or a beamforming indication for at least one PDSCH in one TRP. Hereinafter, embodiments of the disclosure will be described in detail in conjunction with the accompanying drawings. The contents of the disclosure may be applied to frequency division duplex (FDD) and time division duplex (TDD) systems. As used herein, upper signaling (or upper layer signaling) is a method for transferring signals from a base station to a UE by using a downlink data channel of a physical layer, or from the UE to the base station by using an uplink data channel of the physical layer, and may also be referred to as “RRC signaling”, “PDCP signaling”, or “medium access control (MAC) control element (MAC CE)”.

Hereinafter, in the disclosure, the UE may use various methods to determine whether or not to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether or not to apply cooperative communication, or PDCCH(s) that allocates a PDSCH to which cooperative communication is applied are scrambled by a specific RNTI, or cooperative communication application is assumed in a specific range indicated by an upper layer. Hereinafter, it will be assumed for the sake of descriptive convenience that NC-JT case refers to a case in which the UE receives a PDSCH to which cooperative communication is applied, based on conditions similar to those described above.

Hereinafter, determining priority between A and B may be variously described as, for example, selecting an entity having a higher priority according to a predetermined priority rule and performing an operation corresponding thereto, or omitting or dropping operations regarding an entity having a lower priority.

Hereinafter, the above examples may be described through several embodiments, but they are not independent of each other, and one or more embodiments may be applied simultaneously or in combination.

Hereinafter, for the sake of descriptive convenience, a cell, a transmission point, a panel, a beam, and/or a transmission direction which can be distinguished through an upper layer/L1 parameter such as a TCI state or spatial relation information, a cell ID, a TRP ID, or a panel ID may be described as a TRP, a beam, or a TCI state as a whole. Therefore, when actually applied, a TRP, a beam, or a TCI state may be appropriately replaced with one of the above terms.

Hereinafter, in the disclosure, the UE may use various methods to determine whether or not to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether or not to apply cooperative communication, or PDCCH(s) that allocates a PDSCH to which cooperative communication is applied are scrambled by a specific RNTI, or cooperative communication application is assumed in a specific range indicated by an upper layer. Hereinafter, it will be assumed for the sake of descriptive convenience that NC-JT case refers to a case in which the UE receives a PDSCH to which cooperative communication is applied, based on conditions similar to those described above.

Hereinafter, embodiments of the disclosure will be described in detail in conjunction with the accompanying drawings. In the following description, a base station is an entity that allocates resources to terminals, and may be at least one of a gNode B, a gNB, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the following description of embodiments of the disclosure, 5G systems are described by way of example, but the embodiments of the disclosure may also be applied to other communication systems having similar technical backgrounds or channel types. Examples of such communication systems may include LTE or LTE-A mobile communication systems and mobile communication technologies developed beyond 5G. Therefore, based on determinations by those skilled in the art, the embodiments of the disclosure may also be applied to other communication systems through some modifications without significantly departing from the scope of the disclosure. The contents of the disclosure may be applied to FDD and TDD systems.

Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description of the disclosure, higher layer signaling may refer to signaling corresponding to at least one signaling among the following signaling, or a combination of one or more thereof.
Master information block (MIB)
System information block (SIB) or SIB X (X=1, 2, . . . )
Radio resource control (RRC)
Medium access control (MAC) control element (CE)

In addition, L1 signaling may refer to signaling corresponding to at least one signaling method among signaling methods using the following physical layer channels or signaling, or a combination of one or more thereof.
Physical downlink control channel (PDCCH)
Downlink control information (DCI)
UE-specific DCI
Group common DCI
Common DCI
Scheduling DCI (for example, DCI used for the purpose of scheduling downlink or uplink data)
Non-scheduling DCI (for example, DCI not used for the purpose of scheduling downlink or uplink data)
Physical uplink control channel (PUCCH)
Uplink control information (UCI)

Hereinafter, determining priority between A and B may be variously described as, for example, selecting an entity having a higher priority according to a predetermined priority rule and performing an operation corresponding thereto, or omitting or dropping operations regarding an entity having a lower priority.

As used herein, the term “slot” may generally refer to a specific time unit corresponding to a transmit time interval (TTI), may specifically refer to a slot used in a 5G NR system, or may refer to a slot or a subframe used in a fourth generation (4G) LTE system.

Hereinafter, the above examples may be described through several embodiments, but they are not independent of each other, and one or more embodiments may be applied simultaneously or in combination.

The UE may support a simultaneous transmission with multi-panel (STxMP or STx2P) technique of performing uplink transmission by applying different TCI states to uplink signals transmitted via two panels by using the same time and frequency resources as those for the respective panels. The STxMP transmission technique may be divided into an sDCI-based STxMP technique of transmitting uplink signals, which are fully overlapping in the same time and frequency resources based on single DCI, and an mDCI-based STxMP technique in which uplink signals separately scheduled by DCIs associated with different values of coresetPoolIndex (here, two different uplink signals may be fully or partially overlapping in the time domain) may be overlapping in the time domain and transmitted.

If the UE is able to support the STxMP technique, the UE may individually determine a transmission power for each panel, and a maximum transmission power that may be transmitted to each panel may also be different. This is because a radio frequency (RF) structure for uplink signal transmission may be implemented individually for each panel. In this way, the UE supporting STxMP transmits uplink signals based on different maximum transmission powers and different transmission powers, so that the base station may configure twoPHRmode for the UE to identify a maximum transmission power and a power headroom for each panel. If the UE is able to support twoPHRmode for STxMP uplink transmission, the UE may report a UE capability to the base station, and the base station may configure twoPHRmode for supporting STxMP according to the UE capability reported by the UE. If the UE supports twoPHRmode, the UE may report a power headroom value for each panel and a maximum transmission power for each panel by using each field in a MAC CE format for power headroom reporting when a power headroom of a serving cell for which STxMP has been configured is reported.

However, the UE may support the STxMP technique but may not support twoPHRmode. Alternatively, the UE may support twoPHRmode, but the base station may not configure, for the UE, an RRC parameter for twoPHRmode to support STxMP. In this way, if the UE does not support twoPHRmode or the base station does not configure twoPHRmode for the UE, the UE may report only one power headroom and one maximum transmission power to the base station even if a power headroom for STxMP-based uplink transmission is reported.

The UE may support a single-DCI-based multi-panel simultaneous transmission technique and/or a multi-DCI-based multi-panel simultaneous transmission technique, and the UE may support twoPHRmode for both of the different DCI-based multi-panel simultaneous transmission techniques, support some of the multi-panel simultaneous transmission techniques, or support none of the multi-panel simultaneous transmission techniques in order to report two power headrooms and two maximum transmission powers to the base station. A first embodiment describes a method of determining a power headroom and a maximum transmission power for a UE to perform power headroom reporting to a base station if the UE does not support twoPHRmode for the single-DCI-based multi-panel simultaneous transmission technique. A second embodiment describes a method of determining a power headroom and a maximum transmission power for a UE to perform power headroom reporting to a base station in a case where twoPHRmode is supported and in a case where twoPHRmode is not supported for the multi-DCI-based multi-panel simultaneous transmission technique.

### First Embodiment: Method of Power Headroom Reporting when the Single-DCI-Based Multi-Panel Simultaneous Transmission Technique is Supported

According to an embodiment of the disclosure, descriptions are provided for a specific method of determining (or selecting) a power headroom value when a UE supporting the single-DCI-based multi-panel uplink simultaneous transmission technique performs power headroom reporting.

If twoPHRmode for supporting STxMP is not configured, two SRS resource sets, each of which has usage of codebook or nonCodebook, are configured in srs-ResourceSetToAddModList or srs-ResourceSetToAddModListDCI-0-2, two TCI-States or two TCI-UL-States are indicated, and multipanelScheme (e.g., multipanelSchemeSDM or multipanelSchemeSFN) has been configured for the UE, the UE may transmit one power headroom report (e.g., type 1 power headroom report) in slot n. Depending on whether a PUSCH is transmitted via active UL BWP b of carrier f of a serving cell in slot n for power headroom reporting, a method for the UE to calculate type 1 power headroom may vary. If no PUSCH associated with any TCI-State (or TCI-UL-State) is transmitted via active UL BWP b of carrier f of the serving cell in slot n for power headroom reporting, the UE transmits one type 1 power headroom report by using p0AlphaSetforPUSCH and pathlossReferenceRS-Id associated with a first TCI-State or a first TCI-UL-State. If a PUSCH associated with both TCI-States (or TCI-UL-States) is transmitted via active UL BWP b of carrier f of the serving cell in slot n for power headroom reporting, the UE may transmit one power headroom report and one maximum transmission power (configured maximum output power) associated with the first TCI-State or first TCI-UL-State for actual PUSCH transmission performed using a spatial domain filter corresponding to the first TCI-State or the first TCI-UL-State. If a PUSCH associated with one TCI-State (or TCI-UL-State) is transmitted via active UL BWP b of carrier f of the serving cell in slot n for power headroom reporting, the UE may provide one power headroom report and one maximum transmission power (configured maximum output power) associated with the TCI-State or TCI-UL-State associated with actual PUSCH transmission.

### Second Embodiment: Method of Power Headroom Reporting when the Multi-DCI-Based Multi-Panel Simultaneous Transmission Technique is Supported

According to an embodiment of the disclosure, descriptions are provided for a specific method of selecting a power headroom value when a UE supporting the multi-DCI-based (hereinafter, mDCI) multi-panel uplink simultaneous transmission (hereinafter, STxMP) technique performs power headroom reporting.

A UE may support the mDCI-based multi-panel uplink simultaneous transmission technique. A base station may schedule two different PUSCHs overlapping in the time domain for the UE, based on DCI associated with each coresetPoolIndex 0 or coresetPoolIndex 1 (i.e., DCI indicated by a PDCCH received using a CORESET in which each coresetPoolIndex is configured). The two PUSCHs scheduled based on the DCIs associated with different values of coresetPoolIndex may fully or partially overlap in the time domain and may fully or partially overlap or not overlap in the frequency domain.

If power headroom reporting is triggered, the UE may determine a power headroom (hereinafter, actual PHR) based on actual transmission according to an RRC configuration of a configured grant PUSCH (CG PUSCH), periodic SRS, or semi-persistent SRS and DCI received until first DCI for scheduling of a PUSCH for power headroom report transmission is received. That is, the UE may calculate an actual PHR based on actually transmitted signals for an uplink channel (PUSCH, SRS, or the like) scheduled based on DCI received until first DCI for scheduling of a PUSCH for power headroom report transmission is received and/or a CG PUSCH, periodic SRS, or semi-persistent SRS that the UE has determined to transmit at a certain time point (a time point T_{proc,2} symbols before a first transmission symbol) until the first DCI is received. Alternatively, the UE may calculate a virtual PHR based on a reference format other than actually transmitted signals for an uplink channel (PUSCH, SRS, or the like) scheduled based on DCI received after receiving the first DCI, and/or a CG PUSCH, periodic SRS, or semi-persistent SRS that the UE has determined to transmit at a certain time point after receiving the first DCI. In addition, if a power headroom report is transmitted to the base station via a CG PUSCH other than a dynamic grant PUSCH (DG PUSCH) scheduled via DCI, a power headroom may be reported based on a time point that is T_{proc,2} before a time point at which CG PUSCH transmission starts, other than a time point at which the first DCI is received, and the UE may determine an actual PHR based on actual PUSCH transmission or determine a virtual PHR based on reference PUSCH transmission.

If the UE supports the mDCI-based STxMP transmission technique and is able to support an out-of-order transmission method for mDCI-based STxMP, the UE may start, before first PUSCH transmission scheduled based on first DCI (first received DCI) ends, second PUSCH transmission scheduled based on second DCI (DCI in a case where a last symbol of a PDCCH is received later than a last symbol of a PDCCH including the first DCI). If the UE cannot support the out-of-order transmission method for mDCI-based STxMP, the UE may not expect to start another second PUSCH transmission scheduled based on the second DCI before first PUSCH transmission scheduled based on the first DCI ends.

If the UE supports the mDCI-based STxMP transmission technique, the UE may support twoPHRmode for the STxMP technique. In this case, the STxMP technique may indicate only the mDCI-based STxMP transmission technique, or may indicate both the mDCI-based STxMP transmission technique and the sDCI-based STxMP transmission technique. If the UE supports twoPHRmode for the mDCI-based STxMP technique (or for the STxMP technique) and power headroom reporting is triggered, the UE may report both a power headroom reporting value for a PUSCH transmitted via each panel and a maximum transmission power for each PUSCH when performing power headroom reporting for a serving cell. Specifically, if the UE supports twoPHRmode for the STxMP technique and power headroom reporting is triggered to report a power headroom for the STxMP technique to the base station, the UE may configure fields for reporting two power headroom values and two maximum transmission power (P_{CMAX}) values in a MAC CE format for the power headroom reporting, and report the same to the base station.

All various cases for describing the power headroom calculation method of the UE assume that an interval between a last symbol (or, for a CG PUSCH, a first symbol of the CG PUSCH-T_{proc,2} time point) of DCI that the UE has most recently received and a start symbol of a PUSCH that the UE transmits first in each case is greater than or equal to T_{proc,2} or

$${T}_{proc , 2}^{mux} .$$

In addition, une UE assumes the following configurations:
For active UL BWP b on carrier f of serving cell c, a first CORESET indicating a CORESET, in which coresetPoolIndex having a value of 0 is configured or no coresetPoolIndex is configured, and a second CORESET indicating a CORESET, in which coresetPoolIndex having a value of 1 is configured, are configured.
Two SRS resource sets, each of which has usage of codebook or nonCodebook, are configured in srs-ResourceSetToAddModList (or srs-ResourceSetToAddModeListDCI-0-2).
A first indicated TCI-State and a second indicated TCI-State (or a first indicated TCI-UL-State and a second indicated TCI-UL-State) are indicated by DCI received on a CORESET configured using each associated coresetPoolIndex. In this case, the first indicated TCI-State and the second indicated TCI-State (or the first indicated TCI-UL-State and the second indicated TCI-UL-State) may indicate an indicated TCI-State and an indicated TCI-UL-State specified by coresetPoolIndex values of 0 and 1, respectively, and for convenience of description, the first indicated TCI-State or the first indicated TCI-UL-State is referred to as the first TCI, and the second indicated TCI-State or the second indicated TCI-UL-State is referred to as the second TCI.

The UE is configured with RRC parameter sTx-2Panel enabled to support the mDCI-based STxMP transmission technique.

If it is assumed that the aforementioned conditions are satisfied, and that the RRC parameters are configured as described above and the TCI state is indicated to the UE, the UE may determine a PUSCH for power headroom calculation and a power headroom calculation method (e.g., actual PHR or virtual PHR) for various cases as follows:
Case 1) If the UE is configured with twoPHRMode for mDCI-based STxMP (or twoPHRMode for STxMP including sDCI-based STxMP),
Case 1-1) If a PDCCH received by the UE on a first CORESET and a PDCCH received on a second CORESET end at the same time point (e.g., symbol), and
Case 1-1-1) If PUSCH transmission associated with a first TCI (or scheduled by DCI in the PDCCH received on the first CORESET or associated with a CORESET having a coresetPoolIndex value of 0) and PUSCH transmission associated with a second TCI (or scheduled by DCI in the PDCCH received on the second CORESET or associated with a CORESET having a coresetPoolIndex value of 1) are fully overlapped in the time domain, and both the PUSCHs are transmitted in slot n in which a PUSCH for power headroom reporting is transmitted, the UE determines (provides) a first type 1 power headroom report and a first maximum transmission power (configured maximum output power) associated with the first TCI (or associated with the CORESET having a coresetPoolIndex value of 0), based on actual PUSCH transmission transmitted via a spatial domain filter corresponding to the first TCI, and the UE determines a second type 1 power headroom report and a second maximum transmission power, based on actual PUSCH transmission transmitted via a spatial domain filter corresponding to the second TCI.

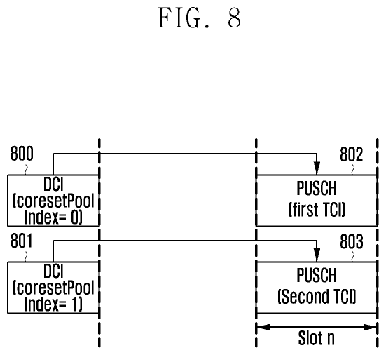

FIG. 8 illustrates an example of a case where two fully overlapping PUSCHs scheduled by two DCIs associated with different values of coresetPoolIndex received at the same time point are simultaneously transmitted in slot n in which a PUSCH for power headroom reporting is transmitted, according to an embodiment of the disclosure.

Referring to FIG. 8, first DCI 800 is associated with a coresetPoolIndex value of 0 and is used to schedule a PUSCH 802 transmitted via a spatial domain filter (or UL beam) corresponding to a first TCI, and second DCI 801 is associated with a coresetPoolIndex value of 1 and is used to schedule a PUSCH 803 transmitted via a spatial domain filter (or UL beam) corresponding to a second TCI. If, in this case, power headroom reporting is triggered, and a UE reports power headroom information to a base station and supports twoPHRmode as described above, the UE may calculate power headrooms for the two PUSCHs 802 and 803 as actual PHRs based on actual PUSCH transmission, and report the same to the base station.
Case 1-1-2) In addition, PUSCH transmission associated with the first TCI (or scheduled by DCI in the PDCCH received on the first CORESET or associated with the CORESET having a coresetPoolIndex value of 0) and PUSCH transmission associated with the second TCI (or scheduled by DCI in the PDCCH received on the second CORESET or associated with the CORESET having coresetPoolIndex value is 1) may partially overlap or may not overlap in the time domain. In this case, if both the partially overlapping or non-overlapping PUSCHs are transmitted in slot n in which a PUSCH for power headroom reporting is transmitted, the UE determines a first type 1 power headroom report and a first maximum transmission power associated with the first TCI (or associated with the CORESET having the coresetPoolIndex value of 0), based on actual PUSCH transmission transmitted via the spatial domain filter corresponding to the first TCI, and determines a second type 1 power headroom report and a second maximum transmission power, based on actual PUSCH transmission transmitted via the spatial domain filter corresponding to the second TCI.

Alternatively, the UE determines, based on actual PUSCH transmission of a PUSCH transmitted earlier among the two PUSCHs transmitted in slot n, a type 1 power headroom report and a maximum transmission power associated with a TCI corresponding to the PUSCH, and determines a type 1 power headroom report and a maximum transmission power associated with a TCI other than the TCI for the PUSCH transmitted earlier, based on reference PUSCH transmission using p0AlphaSetforPUSCH and pathlosReferenceRS-Id associated with the other TCI. That is, the UE determines, based on actual PUSCH transmission, a power headroom and a maximum transmission power (actual PHR and maximum transmission power) for the PUSCH transmitted earlier among the two PUSCHs partially overlapping in the time domain in slot n, and determines, based on reference PUSCH transmission, a power headroom and a maximum transmission power (virtual PHR and maximum transmission power) for the other PUSCH that is subsequently transmitted.

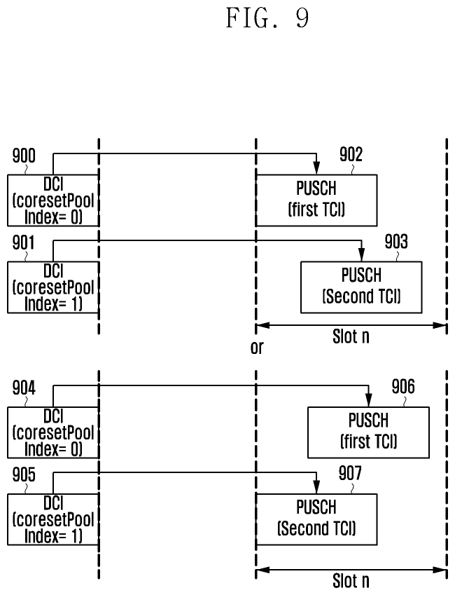

FIG. 9 illustrates an example where two PUSCHs scheduled by two DCIs associated with different values of coresetPoolIndex received at the same time point are partially overlapping, and the two PUSCHs are simultaneously transmitted in slot n in which a PUSCH for power headroom reporting is transmitted, according to an embodiment of the disclosure.

Referring to FIG. 9, first DCI 900 or 904 is associated with a coresetPoolIndex value of 0 and is used to schedule a PUSCH 902 or 906 transmitted via a spatial domain filter (or UL beam) corresponding to a first TCI, and second DCI 901 or 905 is associated with a corsetPoolIndex value of 1 and is used to schedule a PUSCH 903 or 907 transmitted via a spatial domain filter (or UL beam) corresponding to a second TCI. If power headroom reporting is triggered, and a UE reports power headroom information to a base station and supports twoPHRmode (or the UE is configured with twoPHRmode by the base station) as described above, the UE may calculate power headrooms for the two PUSCHs 902 and 903 or 906 and 907 as actual PHRs based on actual PUSCH transmission, and report the same to the base station. Alternatively, if power headroom reporting is triggered, and the UE reports power headroom information to the base station and supports twoPHRmode (or the UE is configured with twoPHRmode by the base station) as described above, the UE calculates a power headroom for the PUSCH 902 or 907, which is transmitted earlier among the two PUSCHs 902 and 903 or 906 and 907, as an actual PHR based on actual PUSCH transmission, and calculates a power headroom for the PUSCH 903 or 906, which is transmitted later, as a virtual PHR based on reference PUSCH transmission. That is, in the first example of FIG. 9, the UE determines a first type 1 power headroom report and a first maximum transmission power associated with the first TCI, based on actual PUSCH 902 transmission transmitted via the spatial filter corresponding to the first TCI, and determines a second type 1 power headroom report and a second maximum transmission power associated with the second TCI, based on reference PUSCH transmission (here, referring to reference transmission of PUSCH 903 other than actual PUSCH transmission) using p0AlphaSetforPUSCH and pathlosReferenceRS-Id associated with the second TCI.

In the second example of FIG. 9, the UE determines a second type 1 power headroom report and a second maximum transmission power associated with the second TCI, based on actual PUSCH 907 transmission transmitted via the spatial filter corresponding to the second TCI, and determines a first type 1 power headroom report and a first maximum transmission power associated with the first TCI, based on reference PUSCH transmission (here, referring to reference transmission other than actual PUSCH 906 transmission) using p0AlphaSetforPUSCH and pathlosReferenceRS-Id associated with the first TCI.
Case 1-1-3) In addition, PUSCH transmission associated with the first TCI (or scheduled by DCI in the PDCCH received on the first CORESET or associated with the CORESET having a coresetPoolIndex value of 0) and PUSCH transmission associated with the second TCI (or scheduled by DCI in the PDCCH received on the second CORESET or associated with the CORESET having coresetPoolIndex value is 1) may partially overlap or may not overlap in the time domain. In this case, if one of the two partially overlapping or non-overlapping PUSCHs is transmitted in slot n in which a PUSCH for power headroom reporting is transmitted, but the other PUSCH is transmitted across slot n and another slot (e.g., slot n+1) or transmitted in a slot other than slot n, the UE determines, based on actual PUSCH transmission of the PUSCH transmitted in slot n, a type 1 power headroom and a maximum transmission power associated with a TCI corresponding to the PUSCH, and determines a type 1 power headroom report and a maximum transmission power associated with a TCI other than the TCI for the PUSCH transmitted in slot n, based on reference PUSCH transmission using p0AlphaSetforPUSCH and pathlosReferenceRS-Id associated with the other TCI. That is, the UE determines, based on actual PUSCH transmission, a power headroom and a maximum transmission power (actual PHR and maximum transmission power) for the PUSCH transmitted in slot n among the two PUSCHs partially overlapping in the time domain, and determines, based on reference PUSCH transmission, a power headroom and a maximum transmission power (virtual PHR and maximum transmission power) for the PUSCH that includes slot n but is transmitted in another slot (or that does not include slot n and is transmitted in another slot).

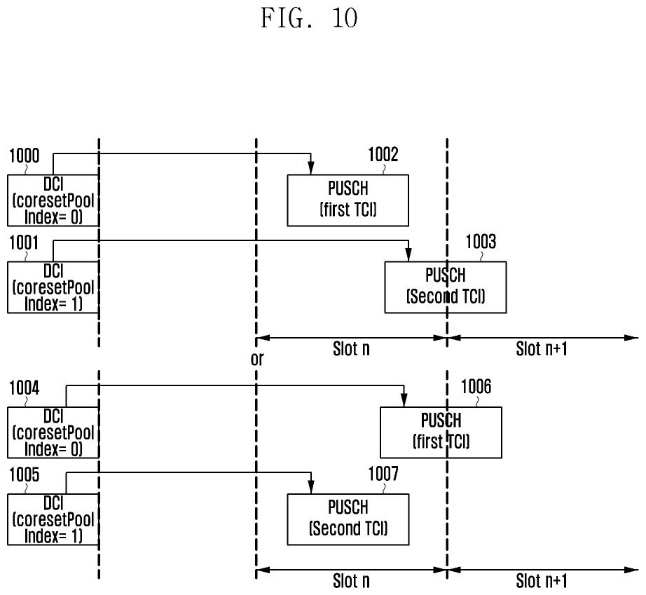

FIG. 10 illustrates an example of a case where two PUSCHs scheduled by two DCIs associated with different values of coresetPoolIndex received at the same time point are partially overlapping, and one PUSCH is transmitted in slot n in which a PUSCH for power headroom reporting is transmitted, but the other PUSCH is transmitted in slot n and/or slot n+1 that is another slot, according to an embodiment of the disclosure.

Referring to FIG. 10, first DCI 1000 or 1004 is associated with a coresetPoolIndex value of 0 and is used to schedule a PUSCH 1002 or 1006 transmitted via a spatial domain filter (or UL beam) corresponding to a first TCI, and second DCI 1001 or 1005 is associated with a corsetPoolIndex value of 1 and is used to schedule a PUSCH 1003 or 1007 transmitted via a spatial domain filter (or UL beam) corresponding to a second TCI.

Alternatively, if power headroom reporting is triggered, and a UE reports power headroom information to a base station and supports twoPHRmode (or the UE is configured with twoPHRmode by the base station) as described above, the UE calculates a power headroom for the PUSCH 1002 or 1007, which is transmitted in slot n among the two PUSCHs 1002 and 1003 or 1006 and 1007, as an actual PHR based on actual PUSCH transmission, and calculates a power headroom for the PUSCH 1003 or 1006, which is transmitted in another slot, as a virtual PHR based on reference PUSCH transmission. That is, in the first example of FIG. 10, the UE determines a first type 1 power headroom report and a first maximum transmission power associated with the first TCI, based on actual PUSCH 1002 transmission transmitted via the spatial filter corresponding to the first TCI, and determines a second type 1 power headroom report and a second maximum transmission power associated with the second TCI, based on reference PUSCH transmission (here, referring to reference transmission of PUSCH 1003 other than actual PUSCH transmission) using p0AlphaSetforPUSCH and pathlosReferenceRS-Id associated with the second TCI. FIG. 10 illustrates a case where another slot includes slot n, but another slot in the disclosure may or may not include slot n. A case where another slot includes slot n may indicate a case of a PUSCH being transmitted via slot n and slot n+1 (across slot n and slot n+1).

In the second example of FIG. 10, the UE determines a second type 1 power headroom report and a second maximum transmission power associated with the second TCI, based on actual PUSCH 1007 transmission transmitted via the spatial filter corresponding to the second TCI, and determines a first type 1 power headroom report and a first maximum transmission power associated with the first TCI, based on reference PUSCH transmission (here, referring to reference transmission other than actual PUSCH 1006 transmission) using p0AlphaSetforPUSCH and pathlosReferenceRS-Id associated with the first TCI.
Case 1-2) If a PDCCH received by the UE on a first CORESET and a PDCCH received on a second CORESET end at different same time points (e.g., symbols or slots), and
Case 1-2-1) If PUSCH transmission associated with the first TCI (or scheduled by DCI in the PDCCH received on the first CORESET or associated with a CORESET having a coresetPoolIndex value of 0) and PUSCH transmission associated with the second TCI (or scheduled by DCI in the PDCCH received on the second CORESET or associated with a CORESET having a coresetPoolIndex value of 1) are fully overlapped in the time domain, and both the PUSCHs are transmitted in slot n in which a PUSCH for power headroom reporting is transmitted, and if an interval between a last symbol of a most recently received PDCCH and a first symbol of a first transmitted PUSCH is equal to or greater than PUSCH preparation time T_{proc,2} or

$${T}_{proc , 2}^{mux}$$

for PUSCH preparation time and multiplexing, the UE determines a first type 1 power headroom report and a first maximum transmission power associated with the first TCI, based on actual PUSCH transmission transmitted via the spatial domain filter corresponding to the first TCI, and determine a second type 1 power headroom report and a second maximum transmission power, based on actual PUSCH transmission transmitted via the spatial domain filter corresponding to the second first TCI.

Alternatively, regardless of the interval between the last symbol of the most recently received PDCCH and the first symbol of the first transmitted PUSCH, the UE determines, based on actual PUSCH transmission of the PUSCH scheduled by the first DCI (or DCI that the UE first starts receiving or DCI that the UE first completes receiving), a type 1 power headroom report and a first maximum transmission power associated with the TCI corresponding to the PUSCH, and determines a type 1 power headroom report and a maximum transmission power associated with a TCI other than the TCI for the PUSCH transmitted earlier, according to reference PUSCH transmission using p0AlphaSetforPUSCH and pathlossReferenceRS-Id associated with the other TCI. That is, the UE determines, based on actual PUSCH transmission, a power headroom and a maximum transmission power (actual PHR and maximum transmission power) for the PUSCH scheduled based on the first DCI (or DCI that the UE first starts receiving or DCI that the UE first completes receiving) among the two PUSCHs fully overlapping in the time domain of slot n, and determines a power headroom and a maximum transmission power (virtual PHR and maximum transmission power) for the other PUSCH, based on reference PUSCH transmission.

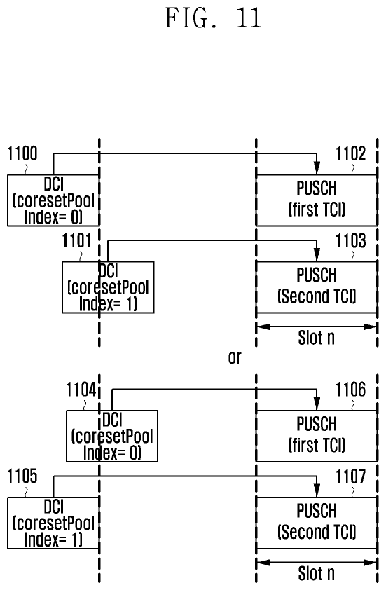

FIG. 11 illustrates an example of a case where two PUSCHs scheduled by two DCIs associated with different values of coresetPoolIndex received at different time points are fully overlapping, and simultaneously transmitted in slot n in which a PUSCH for power headroom reporting is transmitted, according to an embodiment of the disclosure.

Referring to FIG. 11, in the first example of FIG. 11, first DCI 1100 is associated with a coresetPoolIndex value of 0 and is used to schedule a PUSCH 1102 transmitted via a spatial domain filter (or UL beam) corresponding to a first TCI, and second DCI 1101 is associated with a coresetPoolIndex value of 1 and is used to schedule a PUSCH 1103 transmitted via a spatial domain filter (or UL beam) corresponding to a second TCI. If power headroom reporting is triggered, and a UE reports power headroom information to a base station and supports twoPHRmode (or the UE is configured with twoPHRmode by the base station) as described above, the UE may calculate power headrooms for the two PUSCHs 1102 and 1103 as actual PHRs based on actual PUSCH transmission, and report the same to the base station. Alternatively, if power headroom reporting is triggered, and the UE reports power headroom information to the base station and supports twoPHRmode (or the UE is configured with twoPHRmode by the base station) as described above, the UE calculates a power headroom for the PUSCH 1102, which is scheduled by the first DCI 1100 among the two PUSCHs 1102 and 1103, as an actual PHR based on actual PUSCH transmission, and calculates a power headroom for the PUSCH 1103, which is scheduled by the second DCI 1101, as a virtual PHR based on reference PUSCH transmission. That is, in the first example of FIG. 11, the UE determines a first type 1 power headroom report and a first maximum transmission power associated with the first TCI, based on actual PUSCH 1102 transmission transmitted via the spatial filter corresponding to the first TCI, and determines a second type 1 power headroom report and a second maximum transmission power associated with the second TCI, based on reference PUSCH transmission (here, referring to reference transmission of PUSCH 1103 other than actual PUSCH transmission) using p0AlphaSetforPUSCH and pathlosReferenceRS-Id associated with the second TCI.

In the second example of FIG. 11, first DCI 1105 is associated with a coresetPoolIndex value of 1 and is used to schedule a PUSCH 1107 transmitted via a spatial domain filter (or UL beam) corresponding to a second TCI, and second DCI 1104 is associated with a coresetPoolIndex value of 0 and is used to schedule a PUSCH 1106 transmitted via a spatial domain filter (or UL beam) corresponding to a first TCI. If power headroom reporting is triggered, and the UE reports power headroom information to the base station and supports twoPHRmode (or the UE is configured with twoPHRmode by the base station) as described above, the UE may calculate power headrooms for the two PUSCHs 1106 and 1107 as actual PHRs based on actual PUSCH transmission, and report the same to the base station. Alternatively, if power headroom reporting is triggered, and the UE reports power headroom information to the base station and supports twoPHRmode (or the UE is configured with twoPHRmode by the base station) as described above, the UE calculates a power headroom for the PUSCH 1107, which is scheduled by the first DCI 1105 among the two PUSCHs 1106 and 1107, as an actual PHR based on actual PUSCH transmission, and calculates a power headroom for the PUSCH 1106, which is scheduled by the second DCI 1104, as a virtual PHR based on reference PUSCH transmission.

That is, in the second example of FIG. 11, the UE determines a second type 1 power headroom report and a second maximum transmission power associated with the second TCI, based on actual PUSCH 1107 transmission transmitted via the spatial filter corresponding to the second TCI, and determines a first type 1 power headroom report and a first maximum transmission power associated with the first TCI, based on reference PUSCH transmission (here, referring to reference transmission other than actual PUSCH 1106 transmission) using p0AlphaSetforPUSCH and pathlosReferenceRS-Id associated with the first TCI.
Case 1-2-2) In addition, PUSCH transmission associated with the first TCI (or scheduled by DCI in the PDCCH received on the first CORESET or associated with the CORESET having the coresetPoolIndex value of 0) and PUSCH transmission associated with the second TCI (or scheduled by DCI in the PDCCH received on the second CORESET or associated with the CORESET having coresetPoolIndex value is 1) may partially overlap or may not overlap in the time domain. In this case, if both the partially overlapping or non-overlapping PUSCHs are transmitted in slot n in which a PUSCH for power headroom reporting is transmitted, and if an interval between a last symbol of a most recently received PDCCH and a first symbol of a first transmitted PUSCH is equal to or greater than PUSCH preparation time T_{proc,2} or

$${T}_{proc , 2}^{mux}$$

for PUSCH preparation time and multiplexing, the UE determines a first type 1 power headroom report and a first maximum transmission power associated with the first TCI (or associated with the CORESET having the coresetPoolIndex value of 0), based on actual PUSCH transmission transmitted via the spatial domain filter corresponding to the first TCI, and determines a second type 1 power headroom report and a second maximum transmission power, based on actual PUSCH transmission transmitted via the spatial domain filter corresponding to the second TCI. If the interval between the last symbol of the most recently received PDCCH and the first symbol of the first transmitted PUSCH is smaller than PUSCH preparation time T_{proc,2} or

$${T}_{p r oc , 2}^{m u x}$$

for PUSCH preparation time and multiplexing, a type 1 power headroom report for a PUSCH scheduled by DCI in a PDCCH received later may be calculated as a virtual PHR based on reference PUSCH transmission.

Alternatively, if the interval between the last symbol of the most recently received PDCCH and the first symbol of the first transmitted PUSCH is equal to or greater than PUSCH preparation time T_{proc,2} or

$${T}_{p r oc , 2}^{m u x}$$

for PUSCH preparation time and multiplexing, the UE determines, based on actual PUSCH transmission of a PUSCH transmitted earlier among the two PUSCHs transmitted in slot n, a type 1 power headroom report and a maximum transmission power associated with a TCI corresponding to the PUSCH, and determines a type 1 power headroom report and a maximum transmission power associated with another TCI, based on reference PUSCH transmission using p0AlphaSetforPUSCH and pathlosReferenceRS-Id associated with the other TCI.

Alternatively, regardless of the interval between the last symbol of the most recently received PDCCH and the first symbol of the first transmitted PUSCH, the UE determines, based on actual PUSCH transmission of the PUSCH scheduled by the first DCI (or DCI that the UE first starts receiving or DCI that the UE first completes receiving), a type 1 power headroom report and a maximum transmission power associated with the TCI corresponding to the PUSCH, and determines a type 1 power headroom report and a maximum transmission power associated with another TCI, based on reference PUSCH transmission using p0AlphaSetforPUSCH and pathlosReferenceRS-Id associated with the other TCI.

Alternatively, regardless of the interval between the last symbol of the most recently received PDCCH and the first symbol of the first transmitted PUSCH, the UE determines, based on PUSCH transmission scheduled by the first DCI (or DCI that the UE first starts receiving or DCI that the UE first completes receiving), a type 1 power headroom report and a maximum transmission power associated with the TCI corresponding to the PUSCH, and determines a type 1 power headroom report and a maximum transmission power associated with another TCI, based on reference PUSCH transmission using p0AlphaSetforPUSCH and pathlosReferenceRS-Id associated with the other TCI. In this case, if the interval between the last symbol of the most recently received PDCCH and the first symbol of the first transmitted PUSCH is equal to or greater than PUSCH preparation time T_{proc,2} or

$${T}_{p r oc , 2}^{m u x}$$

for PUSCH preparation time and multiplexing, the UE determines a type 1 power headroom report as an actual PHR and determines a maximum transmission power, based on actual PUSCH transmission associated with the first TCI (or TCI-State or TCI-UL-State associated with the CORESET having the coresetPoolIndex value of 0). If the interval between the last symbol of the most recently received PDCCH and the first symbol of the first transmitted PUSCH is smaller than PUSCH preparation time T_{proc,2} or

$${T}_{p r oc , 2}^{m u x}$$

for PUSCH preparation time and multiplexing, and the PUSCH associated with the first TCI is scheduled by DCI in the most recently received PDCCH, the UE determines a type 1 power headroom report as a virtual PHR and determines a maximum transmission power, based on reference PUSCH transmission using p0AlphaSetforPUSCH and pathlosReferenceRS-Id associated with the first TCI (or TCI-State or TCI-UL-State associated with the CORESET having the coresetPoolIndex value of 0).

Alternatively, if the UE determines a type 1 power headroom report and a maximum transmission power, based on PUSCH transmission associated with the first DCI (or TCI-State or TCI-UL-State associated with the CORESET having the coresetPoolIndex value of 0) regardless of the interval between the last symbol of the most recently received PDCCH and the first symbol of the first transmitted PUSCH, the UE may determine the type 1 power headroom report as an actual PHR and determine the maximum transmission power, based on actual PUSCH transmission associated with the first TCT (or TCI-State or TCI-UL-State associated with the CORESET having the coresetPoolIndex value of 0).

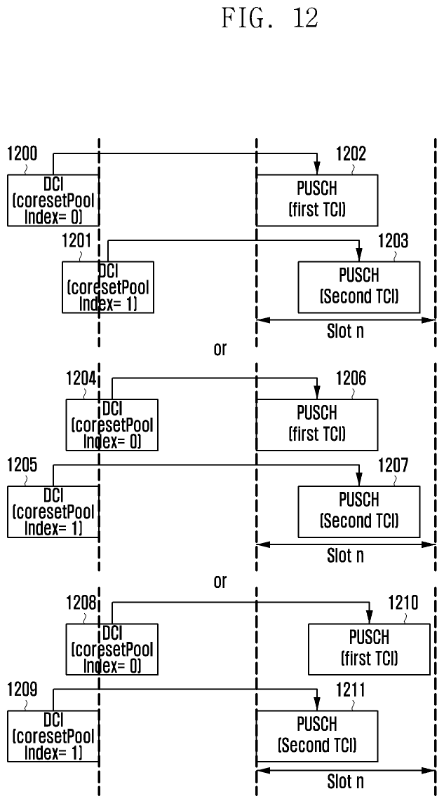

FIG. 12 illustrates an example where two PUSCHs scheduled by two DCIs associated with different values of coresetPoolIndex received at different time points are partially overlapping in the time domain, and the two PUSCHs are simultaneously transmitted in slot n in which a PUSCH for power headroom reporting is transmitted, according to an embodiment of the disclosure.

Referring to FIG. 12, in the first example of FIG. 12, first DCI 1200 is associated with a coresetPoolIndex value of 0 and is used to schedule a PUSCH 1202 transmitted via a spatial domain filter (or UL beam) corresponding to a first TCI, and second DCI 1201 is associated with a coresetPoolIndex value of 1 and is used to schedule a PUSCH 1203 transmitted via a spatial domain filter (or UL beam) corresponding to a second TCI. If power headroom reporting is triggered, and a UE reports power headroom information to a base station and supports twoPHRmode (or the UE is configured with twoPHRmode by the base station) as described above, the UE may calculate power headrooms for the two PUSCHs 1202 and 1203 as actual PHRs based on actual PUSCH transmission, and report the same to the base station. Alternatively, if power headroom reporting is triggered, and the UE reports power headroom information to the base station and supports twoPHRmode (or the UE is configured with twoPHRmode by the base station) as described above, the UE calculates a power headroom for the PUSCH 1202, which is associated with the first TCI and transmitted earlier among the two PUSCHs 1202 and 1203, as an actual PHR based on actual PUSCH transmission, and calculates a power headroom for the subsequently transmitted PUSCH 1203, which is associated with the second TCI, as a virtual PHR based on reference PUSCH transmission. Alternatively, if power headroom reporting is triggered, and the UE reports power headroom information to the base station and supports twoPHRmode (or the UE is configured with twoPHRmode by the base station) as described above, the UE calculates a power headroom for the PUSCH 1202, which is associated with the first TCI and scheduled by the first DCI 1200 among the two PUSCHs 1202 and 1203, as an actual PHR based on actual PUSCH transmission, and calculates a power headroom for the PUSCH 1203, which is associated with the second TCI and scheduled by the second DCI 1201, as a virtual PHR based on reference PUSCH transmission.

In the second example of FIG. 12, first DCI 1205 is associated with a coresetPoolIndex value of 1 and is used to schedule a PUSCH 1207 transmitted via a spatial domain filter (or UL beam) corresponding to a second TCI, and second DCI 1204 is associated with a coresetPoolIndex value of 0 and is used to schedule a PUSCH 1206 transmitted via a spatial domain filter (or UL beam) corresponding to a first TCI. If power headroom reporting is triggered, and a UE reports power headroom information to a base station and supports twoPHRmode (or the UE is configured with twoPHRmode by the base station) as described above, the UE may calculate power headrooms for the two PUSCHs 1206 and 1207 as actual PHRs based on actual PUSCH transmission, and report the same to the base station. Alternatively, if power headroom reporting is triggered, and the UE reports power headroom information to the base station and supports twoPHRmode (or the UE is configured with twoPHRmode by the base station) as described above, the UE calculates a power headroom for the PUSCH 1206, which is associated with the first TCI and transmitted earlier among the two PUSCHs 1206 and 1207, as an actual PHR based on actual PUSCH transmission, and calculates a power headroom for the subsequently transmitted PUSCH 1207, which is associated with the second TCI, as a virtual PHR based on reference PUSCH transmission. Alternatively, the UE calculates a power headroom for the PUSCH 1207, which is associated with the second TCI and scheduled by the first DCI 1205 among the two PUSCHs 1206 and 1207, as an actual PHR based on actual PUSCH transmission, and calculates a power headroom for the PUSCH 1206, which is associated with the first TCI and scheduled by the second DCI 1204, as a virtual PHR based on reference PUSCH transmission.

In the third example of FIG. 12, first DCI 1209 is associated with a coresetPoolIndex value of 1 and is used to schedule a PUSCH 1211 transmitted via a spatial domain filter (or UL beam) corresponding to a second TCI, and second DCI 1208 is associated with a coresetPoolIndex value of 0 and is used to schedule a PUSCH 1210 transmitted via a spatial domain filter (or UL beam) corresponding to a first TCI. If power headroom reporting is triggered, and a UE reports power headroom information to a base station and supports twoPHRmode (or the UE is configured with twoPHRmode by the base station) as described above, the UE may calculate power headrooms for the two PUSCHs 1210 and 1211 as actual PHRs based on actual PUSCH transmission, and report the same to the base station. Alternatively, if power headroom reporting is triggered, and the UE reports power headroom information to the base station and supports twoPHRmode (or the UE is configured with twoPHRmode by the base station) as described above, the UE calculates a power headroom for the PUSCH 1211, which is associated with the second TCI and transmitted earlier among the two PUSCHs 1210 and 1211, as an actual PHR based on actual PUSCH transmission, and calculates a power headroom for the subsequently transmitted PUSCH 1210, which is associated with the first TCI, as a virtual PHR based on reference PUSCH transmission. Alternatively, the UE calculates a power headroom for the PUSCH 1211, which is associated with the second TCI and scheduled by the first DCI 1209 among the two PUSCHs 1210 and 1211, as an actual PHR based on actual PUSCH transmission, and calculates a power headroom for the PUSCH 1210, which is associated with the first TCI and scheduled by the second DCI 1208, as a virtual PHR based on reference PUSCH transmission.

Alternatively, in all the power headroom calculation examples presented in the third example of FIG. 12 described above, if an interval between a last symbol of the most recently received DCI 1208 and a first symbol of the first transmitted PUSCH 1211 is smaller than T_{proc,2} or

$${T}_{p r o c , 2}^{m u x} ,$$

the UE calculates a power headroom for the PUSCH 1210, which is associated with the first TCI, as a virtual PHR based on reference PUSCH transmission.
Case 1-2-3) In addition, PUSCH transmission associated with the first TCI (or scheduled by DCI in the PDCCH received on the first CORESET or associated with the CORESET having the coresetPoolIndex value of 0) and PUSCH transmission associated with the second TCI (or scheduled by DCI in the PDCCH received on the second CORESET or associated with the CORESET having coresetPoolIndex value is 1) may partially overlap or may not overlap in the time domain. In this case, if one of the two partially overlapping or non-overlapping PUSCHs is transmitted in slot n in which a PUSCH for power headroom reporting is transmitted, but the other PUSCH is transmitted across slot n and another slot (e.g., slot n+1) or transmitted in a slot other than slot n, and if the interval between the last symbol of the most recently received PDCCH and the first symbol of the first transmitted PUSCH is equal to or greater than PUSCH preparation time T_{proc,2} or

$${T}_{p r oc , 2}^{m u x}$$

for PUSCH preparation time and multiplexing, the UE determines, based on actual PUSCH transmission of the PUSCH transmitted in slot n, a type 1 power headroom and a maximum transmission power associated with a TCI corresponding to the PUSCH, and determines a type 1 power headroom report and a maximum transmission power associated with a TCI other than the TCI for the PUSCH transmitted in slot n, based on reference PUSCH transmission using p0AlphaSetforPUSCH and pathlosReferenceRS-Id associated with the other TCI.

Alternatively, if the interval between the last symbol of the most recently received PDCCH and the first symbol of the first transmitted PUSCH is smaller than PUSCH preparation time T_{proc,2} or

$${T}_{p r oc , 2}^{m u x}$$

for PUSCH preparation time and multiplexing, or regardless of the interval between the last symbol of the most recently received PDCCH and the first symbol of the first transmitted PUSCH, the UE determines, based on actual PUSCH transmission of the PUSCH scheduled by the first DCI (or DCI that the UE first starts receiving or DCI that the UE first completes receiving), a type 1 power headroom report and a maximum transmission power associated with the TCI corresponding to the PUSCH, and determines a type 1 power headroom report and a maximum transmission power associated with another TCI, based on reference PUSCH transmission using p0AlphaSetforPUSCH and pathlosReferenceRS-Id associated with the other TCI.

Alternatively, regardless of the interval between the last symbol of the most recently received PDCCH and the first symbol of the first transmitted PUSCH, the UE determines, based on PUSCH transmission scheduled by the first DCI (or DCI that the UE first starts receiving or DCI that the UE first completes receiving), a type 1 power headroom report and a maximum transmission power associated with the TCI corresponding to the PUSCH, and determines a type 1 power headroom report and a maximum transmission power associated with another TCI, based on reference PUSCH transmission using p0AlphaSetforPUSCH and pathlosReferenceRS-Id associated with the other TCI. In this case, if the interval between the last symbol of the most recently received PDCCH and the first symbol of the first transmitted PUSCH is equal to or greater than PUSCH preparation time T_{proc,2} or

$${T}_{p r oc , 2}^{m u x}$$

for PUSCH preparation time and multiplexing, and the PUSCH associated with the first TCI is transmitted in slot n, the UE determines a type 1 power headroom report as an actual PHR and determines a maximum transmission power, based on actual PUSCH transmission associated with the first TCI (or TCI-State or TCI-UL-State associated with the CORESET having the coresetPoolIndex value of 0). If the interval between the last symbol of the most recently received PDCCH and the first symbol of the first transmitted PUSCH is smaller than PUSCH preparation time T_{proc,2} or

$${T}_{p r oc , 2}^{m u x}$$

for PUSCH preparation time and multiplexing, and the PUSCH associated with the first TCI is scheduled by DCI in the most recently received PDCCH, or although the interval between the last symbol of the most recently received PDCCH and the first symbol of the first transmitted PUSCH is equal to or greater than PUSCH preparation time T_{proc,2} or for PUSCH

$${T}_{p r oc , 2}^{m u x}$$

for PUSCH preparation time and multiplexing, if the PUSCH associated with the first TCI is transmitted in a slot other than slot n, the UE determines a type 1 power headroom report as a virtual PHR and determines a maximum transmission power, based on reference PUSCH transmission using p0AlphaSetforPUSCH and pathlosReferenceRS-Id associated with the first TCI (or TCI-State or TCI-UL-State associated with the CORESET having the coresetPoolIndex value of 0). Another slot (or the other slot) in the disclosure may or may not include slot n. A case where another slot includes slot n may indicate a case of a PUSCH being transmitted via slot n and slot n+1 (across slot n and slot n+1).

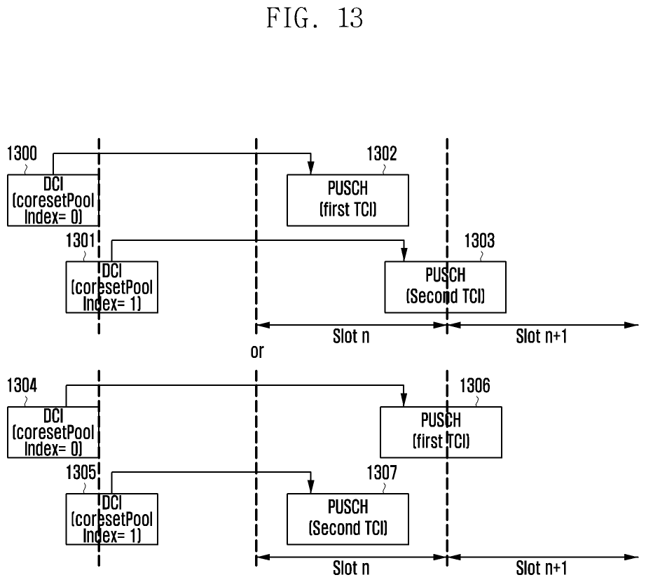

FIG. 13 illustrates an example of a case where two PUSCHs scheduled based on two DCIs associated with different values of coresetPoolIndex received at different time points are partially overlapping in the time domain, and one PUSCH is transmitted in slot n in which a PUSCH for power headroom reporting is transmitted, but the other PUSCH is transmitted in slot n and slot n+1 that is another slot, according to an embodiment of the disclosure.

Referring to FIG. 13, in the first example of FIG. 13, first DCI 1300 is associated with a coresetPoolIndex value of 0 and is used to schedule a PUSCH 1302 transmitted via a spatial domain filter (or UL beam) corresponding to a first TCI, and second DCI 1301 is associated with a coresetPoolIndex value of 1 and is used to schedule a PUSCH 1303 transmitted via a spatial domain filter (or UL beam) corresponding to a second TCI. Alternatively, if power headroom reporting is triggered, and the UE reports power headroom information to the base station and supports twoPHRmode (or the UE is configured with twoPHRmode by the base station) as described above, the UE calculates a power headroom for the PUSCH 1302, which is associated with the first TCI and transmitted in slot n among the two PUSCHs 1302 and 1303, as an actual PHR based on actual PUSCH transmission, and calculates a power headroom for the PUSCH 1303, which is associated with the second TCI and transmitted in another slot, as a virtual PHR based on reference PUSCH transmission. Alternatively, if power headroom reporting is triggered, and the UE reports power headroom information to the base station and supports twoPHRmode (or the UE is configured with twoPHRmode by the base station) as described above, the UE calculates a power headroom for the PUSCH 1302, which is associated with the first TCI and scheduled by the first DCI 1300 among the two PUSCHs 1302 and 1303, as an actual PHR based on actual PUSCH transmission, and calculates a power headroom for the PUSCH 1303, which is associated with the second TCI and scheduled by the second DCI 1301, as a virtual PHR based on reference PUSCH transmission.

In the second example of FIG. 13, second DCI 1305 is associated with a coresetPoolIndex value of 1 and is used to schedule a PUSCH 1307 transmitted via a spatial domain filter (or UL beam) corresponding to a second TCI, and first DCI 1304 is associated with a coresetPoolIndex value of 0 and is used to schedule a PUSCH 1306 transmitted via a spatial domain filter (or UL beam) corresponding to a first TCI. Alternatively, if power headroom reporting is triggered, and the UE reports power headroom information to the base station and supports twoPHRmode (or the UE is configured with twoPHRmode by the base station) as described above, the UE calculates a power headroom for the PUSCH 1307, which is associated with the second TCI and transmitted in slot n among the two PUSCHs 1306 and 1307, as an actual PHR based on actual PUSCH transmission, and calculates a power headroom for the PUSCH 1306, which is associated with the first TCI and transmitted in another slot, as a virtual PHR based on reference PUSCH transmission. Alternatively, if power headroom reporting is triggered, and the UE reports power headroom information to the base station and supports twoPHRmode as described above, the UE calculates a power headroom for the PUSCH 1306, which is associated with the first TCI and scheduled by the first DCI 1304 among the two PUSCHs 1306 and 1307, as an actual PHR based on actual PUSCH transmission, and calculates a power headroom for the PUSCH 1307, which is associated with the second TCI and scheduled by the second DCI 1305, as a virtual PHR based on reference PUSCH transmission. FIG. 13 illustrates a case where another slot includes slot n, but another slot in the disclosure may or may not include slot n. A case where another slot includes slot n may indicate a case of a PUSCH being transmitted via slot n and slot n+1 (across slot n and slot n+1).
Case 2) If the UE is not configured with twoPHRMode for mDCI-based STxMP (or twoPHRMode for STxMP including sDCI-based STxMP),
Case 2-1) If a PDCCH received by the UE on a first CORESET and a PDCCH received on a second CORESET end at the same time point (e.g., symbol), and
Case 2-1-1) If PUSCH transmission associated with a first TCI (or scheduled by DCI in the PDCCH received on the first CORESET or associated with a CORESET having a coresetPoolIndex value of 0) and PUSCH transmission associated with a second TCI (or scheduled by DCI in the PDCCH received on the second CORESET or associated with a CORESET having a coresetPoolIndex value of 1) are fully overlapped in the time domain, and both the PUSCHs are transmitted in slot n in which a PUSCH for power headroom reporting is transmitted, the UE determines a type 1 power headroom report and a maximum transmission power (configured maximum output power), based on actual PUSCH transmission transmitted via a spatial domain filter corresponding to the first TCI (or TCI-State or TCI-UL-State associated with the CORESET having a coresetPoolIndex value of 0).

Referring to FIG. 8, the two DCIs 800 and 801 are received at the same time point, and the two PUSCHs 802 and 803 scheduled by the respective DCIs may fully overlap in the time domain. The first DCI 800 is associated with a coresetPoolIndex value of 0 and is used to schedule the PUSCH 802 transmitted via the spatial domain filter (or UL beam) corresponding to the first TCI, and the second DCI 801 is associated with a coresetPoolIndex value of 1 and is used to schedule the PUSCH 803 transmitted via the spatial domain filter (or UL beam) corresponding to the second TCI. If power headroom reporting is triggered and the UE reports power headroom information to the base station, and if the UE does not support twoPHRmode (or the UE is not configured with twoPHRmode by the base station) as described above, the UE calculates a power headroom for the PUSCH 802 as an actual PHR based on actual PUSCH transmission, the PUSCH 802 being associated with the first TCI (or TCI-State or TCI-UL-State associated with the CORESET having a coresetPoolIndex value of 0) among the two PUSCHs 802 and 803.
Case 2-1-2) In addition, PUSCH transmission associated with the first TCI (or scheduled by DCI in the PDCCH received on the first CORESET or associated with the CORESET having a coresetPoolIndex value of 0) and PUSCH transmission associated with the second TCI (or scheduled by DCI in the PDCCH received on the second CORESET or associated with the CORESET having coresetPoolIndex value is 1) may partially overlap or may not overlap in the time domain. In this case, if both the partially overlapping or non-overlapping PUSCHs are transmitted in slot n in which a PUSCH for power headroom reporting is transmitted, the UE determines a type 1 power headroom report and a maximum transmission power (configured maximum output power), based on actual PUSCH transmission transmitted via the spatial domain filter corresponding to the first TCI (or TCI-State or TCI-UL-State associated with the CORESET having a coresetPoolIndex value of 0).

Alternatively, the UE determines a type 1 power headroom report and a maximum transmission power (configured maximum output power), based on actual PUSCH transmission of the PUSCH transmitted earlier among the two PUSCHs transmitted in slot n.

Referring to FIG. 9, the UE may receive the two DCIs 900 and 901 or 904 and 905 at the same time point. In addition, the two PUSCHs 902 and 903 or 906 and 907 may partially overlap in slot n. The first DCI 900 or 904 is associated with a coresetPoolIndex value of 0 and is used to schedule the PUSCH 902 or 906 transmitted via the spatial domain filter (or UL beam) corresponding to the first TCI, and the second DCI 901 or 905 is associated with a corsetPoolIndex value of 1 and is used to schedule the PUSCH 903 or 907 transmitted via the spatial domain filter (or UL beam) corresponding to the second TCI. In the first example of FIG. 9, the PUSCH 902 associated with the first TCI is transmitted earlier than the PUSCH 903 associated with the second TCI. If power headroom reporting is triggered and the UE reports power headroom information to the base station, and if the UE does not support twoPHRmode (or the UE is not configured with twoPHRmode by the base station) as described above, the UE calculates a power headroom for the PUSCH 902, which is associated with the first TCI among the two PUSCHs 902 and 903, as an actual PHR based on actual PUSCH transmission. Alternatively, if power headroom reporting is triggered and the UE reports power headroom information to the base station, and if the UE does not support twoPHRmode (or the UE is not configured with twoPHRmode by the base station) as described above, the UE calculates a power headroom for the PUSCH 902, which is associated with the first TCI and transmitted earlier among the two PUSCHs 902 and 903, as an actual PHR based on actual PUSCH transmission.

In the second example of FIG. 9, the PUSCH 907 associated with the second TCI is transmitted earlier than the PUSCH 906 associated with the first TCI. If, in this case, power headroom reporting is triggered and the UE reports power headroom information to the base station, and if the UE does not support twoPHRmode (or the UE is not configured with twoPHRmode by the base station) as described above, the UE calculates a power headroom for the PUSCH 906, which is associated with the first TCI among the two PUSCHs 906 and 907, as an actual PHR based on actual PUSCH transmission. Alternatively, if power headroom reporting is triggered and the UE reports power headroom information to the base station, and if the UE does not support twoPHRmode (or the UE is not configured with twoPHRmode by the base station) as described above, the UE calculates a power headroom for the PUSCH 907, which is associated with the second TCI and transmitted earlier among the two PUSCHs 906 and 907, as an actual PHR based on actual PUSCH transmission.
Case 2-1-3) In addition, PUSCH transmission associated with the first TCI (or scheduled by DCI in the PDCCH received on the first CORESET or associated with the CORESET having a coresetPoolIndex value of 0) and PUSCH transmission associated with the second TCI (or scheduled by DCI in the PDCCH received on the second CORESET or associated with the CORESET having coresetPoolIndex value is 1) may partially overlap or may not overlap in the time domain. In this case, if one of the two partially overlapping or non-overlapping PUSCHs is transmitted in slot n in which a PUSCH for power headroom reporting is transmitted, but the other PUSCH is transmitted across slot n and another slot (e.g., slot n+1) or transmitted in a slot other than slot n, the UE determines a type 1 power headroom report and a maximum transmission power (configured maximum output power), based on actual PUSCH transmission of the PUSCH transmitted in slot n.

Alternatively, if the PUSCH transmitted via the spatial domain filter corresponding to the first TCI (or TCI-State or TCI-UL-State associated with the CORESET having a coresetPoolIndex value of 0) is transmitted in slot n, the UE determines a type 1 power headroom report as an actual PHR and determines a maximum transmission power (configured maximum output power), based on actual PUSCH transmission associated with the first TCI.

Alternatively, if the PUSCH transmitted via the spatial domain filter corresponding to the first TCI (or TCI-State or TCI-UL-State associated with the CORESET having a coresetPoolIndex value of 0) is transmitted across slot n and another slot (e.g., slot n+1) or transmitted in a slot other than slot n, the UE determines a type 1 power headroom report as a virtual PHR and determines a maximum transmission power, based on reference PUSCH transmission using p0AlphaSetforPUSCH and pathlosReferenceRS-Id associated with the first TCI (or TCI-State or TCI-UL-State associated with the CORESET having a coresetPoolIndex value of 0).

Referring to FIG. 10, the two DCIs 1000 and 1001 or 1004 and 1005 may be received at the same time point. In addition, the two PUSCHs 1002 and 1003 or 1006 and 1007 are partially overlapped in the time domain, and one PUSCH 1002 or 1007 of the two PUSCHs 1002 and 1003 or 1006 and 1007 may be transmitted in slot n, but the other PUSCH 1003 or 1006 may be transmitted in a slot other than slot n. The first DCI 1000 or 1004 is associated with a coresetPoolIndex value of 0 and is used to schedule the PUSCH 1002 or 1006 transmitted via the spatial domain filter (or UL beam) corresponding to the first TCI, and the second DCI 1001 or 1005 is associated with a corsetPoolIndex value of 1 and is used to schedule the PUSCH 1003 or 1007 transmitted via the spatial domain filter (or UL beam) corresponding to the second TCI. In the first example of FIG. 10, the PUSCH 1002 associated with the first TCI is transmitted earlier than the PUSCH 1003 associated with the second TCI, and the PUSCH 1002 is transmitted in slot n. In contrast, the PUSCH 1003 associated with the second TCI is transmitted across slot n and slot n+1. Alternatively, if power headroom reporting is triggered and the UE reports power headroom information to the base station, and if the UE does not support twoPHRmode (or the UE is not configured with twoPHRmode by the base station) as described above, the UE calculates a power headroom for the PUSCH 1002, which is associated with the first TCI and transmitted in slot n among the two PUSCHs 1002 and 1003, as an actual PHR based on actual PUSCH transmission. Alternatively, if power headroom reporting is triggered and the UE reports power headroom information to the base station, and if the UE does not support twoPHRmode (or the UE is not configured with twoPHRmode by the base station) as described above, the UE calculates a power headroom for the PUSCH 1002 associated with the first TCI (or TCI-State or TCI-UL-State associated with the CORESET having a coresetPoolIndex value of 0) among the two PUSCHs 1002 and 1003. In this case, since the PUSCH 1002 associated with the first TCI is transmitted in slot n that is a slot in which a PUSCH for power headroom reporting is transmitted, the UE calculates a power headroom for the PUSCH 1002, which is associated with the first TCI, as an actual PHR based on actual PUSCH transmission.

In the second example of FIG. 10, the PUSCH 1007 associated with the second TCI is transmitted earlier than the PUSCH 1006 associated with the first TCI, and is transmitted in slot n. In contrast, the PUSCH 1006 associated with the first TCI is transmitted across slot n and slot n+1. Alternatively, if power headroom reporting is triggered and the UE reports power headroom information to the base station, and if the UE does not support twoPHRmode (or the UE is not configured with twoPHRmode by the base station) as described above, the UE calculates a power headroom for the PUSCH 1007, which is associated with the second TCI and transmitted in slot n among the two PUSCHs 1006 and 1007, as an actual PHR based on actual PUSCH transmission. Alternatively, if power headroom reporting is triggered and the UE reports power headroom information to the base station, and if the UE does not support twoPHRmode (or the UE is not configured with twoPHRmode by the base station) as described above, the UE calculates a power headroom for the PUSCH 1002 associated with the first TCI (or TCI-State or TCI-UL-State associated with the CORESET having a coresetPoolIndex value of 0) among the two PUSCHs 1002 and 1007. In this case, since the PUSCH 1006 associated with the first TCI is transmitted across slot n, in which a PUSCH for power headroom reporting is transmitted, and another slot n+1, the UE calculates a power headroom for the PUSCH 1006, which is associated with the first TCI, as a virtual PHR based on reference PUSCH transmission.
Case 2-2) If a PDCCH received by the UE on a first CORESET and a PDCCH received on a second CORESET end at different same time points (e.g., symbols or slots), and
Case 2-2-1) If PUSCH transmission associated with a first TCI (or scheduled by DCI in the PDCCH received on the first CORESET or associated with a CORESET having a coresetPoolIndex value of 0) and PUSCH transmission associated with a second TCI (or scheduled by DCI in the PDCCH received on the second CORESET or associated with a CORESET having a coresetPoolIndex value of 1) are fully overlapped in the time domain, and both the PUSCHs are transmitted in slot n in which a PUSCH for power headroom reporting is transmitted, and if the interval between the last symbol of the most recently received PDCCH and the first symbol of the first transmitted PUSCH is equal to or greater than PUSCH preparation time T_{proc,2} or

$${T}_{p r oc , 2}^{m u x}$$

for PUSCH preparation time and multiplexing, the UE determines a type 1 power headroom report and a maximum transmission power (configured maximum output power), based on actual PUSCH transmission transmitted via a spatial domain filter corresponding to the first TCI (or TCI-State or TCI-UL-State associated with the CORESET having a coresetPoolIndex value of 0).

Alternatively, regardless of the interval between the last symbol of the most recently received PDCCH and the first symbol of the first transmitted PUSCH, the UE determines a type 1 power headroom report and a maximum transmission power, based on actual PUSCH transmission of the PUSCH scheduled by the first DCI (or DCI that the UE first starts receiving or DCI that the UE first completes receiving).

Alternatively, regardless of the interval between the last symbol of the most recently received PDCCH and the first symbol of the first transmitted PUSCH, the UE determines a type 1 power headroom report and a maximum transmission power, based on actual PUSCH transmission associated with the first DCI (or TCI-State or TCI-UL-State associated with the CORESET having a coresetPoolIndex value of 0) or reference PUSCH transmission using p0AlphaSetforPUSCH and pathlosReferenceRS-Id. In this case, if the interval between the last symbol of the most recently received PDCCH and the first symbol of the first transmitted PUSCH is equal to or greater than PUSCH preparation time T_{proc,2} or

$${T}_{p r oc , 2}^{m u x}$$

for PUSCH preparation time and multiplexing, the UE determines a type 1 power headroom report as an actual PHR and determines a maximum transmission power, based on actual PUSCH transmission associated with the first TCI (or TCI-State or TCI-UL-State associated with the CORESET having the coresetPoolIndex value of 0). If the interval between the last symbol of the most recently received PDCCH and the first symbol of the first transmitted PUSCH is smaller than PUSCH preparation time T_{proc,2} or

$${T}_{p r oc , 2}^{m u x}$$

for PUSCH preparation time and multiplexing, and the PUSCH associated with the first TCI is scheduled by DCI in the most recently received PDCCH, the UE determines a type 1 power headroom report as a virtual PHR and determines a maximum transmission power, based on reference PUSCH transmission using p0AlphaSetforPUSCH and pathlosReferenceRS-Id associated with the first TCI (or TCI-State or TCI-UL-State associated with the CORESET having the coresetPoolIndex value of 0). Alternatively, if the UE determines a type 1 power headroom report and a maximum transmission power, based on PUSCH transmission associated with the first DCI (or TCI-State or TCI-UL-State associated with the CORESET having the coresetPoolIndex value of 0) regardless of the interval between the last symbol of the most recently received PDCCH and the first symbol of the first transmitted PUSCH, the UE may determine the type 1 power headroom report as an actual PHR and determine the maximum transmission power, based on actual PUSCH transmission associated with the first TCT (or TCI-State or TCI-UL-State associated with the CORESET having the coresetPoolIndex value of 0).

Referring to FIG. 11, illustrated is a case where the two DCIs 1100 and 1101 or 1104 and 1105 are received at different time points, the two PUSCHs 1102 and 1103 or 1106 and 1107 fully overlap in the time domain, and the two PUSCHs are transmitted simultaneously in slot n in which a PUSCH for power headroom reporting is transmitted. In the first example of FIG. 11, the first DCI 1100 is associated with a coresetPoolIndex value of 0 and is used to schedule the PUSCH 1102 transmitted via a spatial domain filter (or UL beam) corresponding to the first TCI, and the second DCI 1101 is associated with a coresetPoolIndex value of 1 and is used to schedule the PUSCH 1103 transmitted via a spatial domain filter (or UL beam) corresponding to the second TCI. If power headroom reporting is triggered and the UE reports power headroom information to the base station, if the UE does not support twoPHRmode (or the UE is not configured with twoPHRmode by the base station) as described above, and if a difference between start time points of first symbols of the two PUSCHs 1102 and 1103 that are fully overlapped with the most recently received DCI 1101 is equal to or greater than T_{proc,2} or

$${T}_{p r oc , 2}^{m u x}$$

described above, the UE calculates a power headroom for the PUSCH 1102, which is associated with the first TCI (or TCI-State or TCI-UL-State associated with the CORESET having a coresetPoolIndex value of 0), as an actual PHR based on actual PUSCH transmission. Alternatively, if power headroom reporting is triggered and the UE reports power headroom information to the base station, and if the UE does not support twoPHRmode (or the UE is not configured with twoPHRmode by the base station) as described above, the UE calculates a power headroom for the PUSCH 1102, which is associated with the first TCI and scheduled by the first DCI 1100, as an actual PHR based on actual PUSCH transmission. Alternatively, if power headroom reporting is triggered and the UE reports power headroom information to the base station, and if the UE does not support twoPHRmode (or the UE is not configured with twoPHRmode by the base station) as described above, the UE may calculate a power headroom for the PUSCH 1102 associated with the first TCI (or TCI-State or TCI-UL-State associated with the CORESET having a coresetPoolIndex value of 0) regardless of a difference value between the most recently received DCI 1101 and start time points of first symbols of the two PUSCHs 1102 and 1103. In this case, if the difference between the most recently received DCI 1101 and the start time points of the first symbols of the two PUSCHs 1102 and 1103 is equal to or greater than PUSCH preparation time T_{proc,2} or

$${T}_{p r oc , 2}^{m u x}$$

for PUSCH preparation time and multiplexing, the UE may calculate a power headroom for the PUSCH 1102, which is associated with the first TCI (or TCI-State or TCI-UL-State associated with the CORESET having a coresetPoolIndex value of 0), as an actual PHR based on actual PUSCH transmission. In addition, if the difference between the most recently received DCI 1101 and the start time points of the first symbols of the two PUSCHs 1102 and 1103 is smaller than PUSCH preparation time T_{proc,2} or

$${T}_{proc , 2}^{mux}$$

for PUSCH preparation time and multiplexing, the UE calculates a power headroom for the PUSCH 1102, which is associated with the first TCI (or TCI-State or TCI-UL-State associated with the CORESET having a coresetPoolIndex value of 0), as a virtual PHR based on reference PUSCH transmission.

In the second example of FIG. 11, the first DCI 1105 is associated with a coresetPoolIndex value of 1 and is used to schedule the PUSCH 1107 transmitted via a spatial domain filter (or UL beam) corresponding to the second TCI, and the second DCI 1104 is associated with a coresetPoolIndex value of 0 and is used to schedule the PUSCH 1106 transmitted via a spatial domain filter (or UL beam) corresponding to the first TCI. If power headroom reporting is triggered and the UE reports power headroom information to the base station, if the UE does not support twoPHRmode (or the UE is not configured with twoPHRmode by the base station) as described above, and if a difference between the most recently received DCI 1104 and start time points of first symbols of the two PUSCHs 1106 and 1107 is equal to or greater than T_{proc,2} or

$${T}_{proc , 2}^{mux} ,$$

the UE calculates a power headroom for the PUSCH 1106, which is associated with the first TCI (or TCI-State or TCI-UL-State associated with the CORESET having a coresetPoolIndex value of 0), as an actual PHR based on actual PUSCH transmission. Alternatively, if power headroom reporting is triggered and the UE reports power headroom information to the base station, and if the UE does not support twoPHRmode (or the UE is not configured with twoPHRmode by the base station) as described above, the UE calculates a power headroom for the PUSCH 1107, which is associated with the second TCI and scheduled by the first DCI 1105, as an actual PHR based on actual PUSCH transmission. Alternatively, if power headroom reporting is triggered and the UE reports power headroom information to the base station, and if the UE does not support twoPHRmode (or the UE is not configured with twoPHRmode by the base station) as described above, the UE may calculate a power headroom for the PUSCH 1106 associated with the first TCI (or TCI-State or TCI-UL-State associated with the CORESET having a coresetPoolIndex value of 0) regardless of a difference value between the most recently received DCI 1104 and the start time points of the first symbols of the two PUSCHs 1106 and 1107. In this case, if the difference between the most recently received DCI 1104 and the start time points of the first symbols of the two PUSCHs 1106 and 1107 is equal to or greater than PUSCH preparation time T_{proc,2} or

$${T}_{proc , 2}^{mux}$$

for PUSCH preparation time and multiplexing, the UE may calculate a power headroom for the PUSCH 1106, which is associated with the first TCI (or TCI-State or TCI-UL-State associated with the CORESET having a coresetPoolIndex value of 0), as an actual PHR based on actual PUSCH transmission. In addition, if the difference between the most recently received DCI 1104 and the start time points of the first symbols of the two PUSCHs 1106 and 1107 is smaller than PUSCH preparation time T_{proc,2} or

$${T}_{proc , 2}^{mux}$$

for PUSCH preparation time and multiplexing, the UE calculates a power headroom for the PUSCH 1106, which is associated with the first TCI (or TCI-State or TCI-UL-State associated with the CORESET having a coresetPoolIndex value of 0), as a virtual PHR based on reference PUSCH transmission. Alternatively, regardless of the difference between the most recently received DCI 1104 and the start time point of the first symbol of the PUSCH 1106 transmitted earlier, the UE may calculate a power headroom for the PUSCH 1106, which is associated with the first TCI, as an actual PHR based on actual PUSCH transmission.
Case 2-2-2) In addition, PUSCH transmission associated with the first TCI (or scheduled by DCI in the PDCCH received on the first CORESET or associated with the CORESET having the coresetPoolIndex value of 0) and PUSCH transmission associated with the second TCI (or scheduled by DCI in the PDCCH received on the second CORESET or associated with the CORESET having coresetPoolIndex value is 1) may partially overlap or may not overlap in the time domain. In this case, if both the partially overlapping or non-overlapping PUSCHs are transmitted in slot n in which a PUSCH for power headroom reporting is transmitted, and if the interval between the last symbol of the most recently received PDCCH and the first symbol of the first transmitted PUSCH is equal to or greater than PUSCH preparation time T_{proc,2} or

$${T}_{proc , 2}^{mux}$$

for PUSCH preparation time and multiplexing, the UE determines a type 1 power headroom report and a maximum transmission power (configured maximum output power), based on actual PUSCH transmission transmitted via the spatial domain filter corresponding to the first TCI (or TCI-State or TCI-UL-State associated with the CORESET having a coresetPoolIndex value of 0).

Alternatively, if the interval between the last symbol of the most recently received PDCCH and the first symbol of the first transmitted PUSCH is equal to or greater than PUSCH preparation time T_{proc,2} or

$${T}_{proc , 2}^{mux}$$

for PUSCH preparation time and multiplexing, the UE determines a type 1 power headroom report and a maximum transmission power, based on actual PUSCH transmission of the PUSCH transmitted earlier among the two PUSCHs transmitted in slot n.

Alternatively, regardless of the interval between the last symbol of the most recently received PDCCH and the first symbol of the first transmitted PUSCH, the UE determines a type 1 power headroom report and a maximum transmission power, based on actual PUSCH transmission of the PUSCH scheduled by the first DCI (or DCI that the UE first starts receiving or DCI that the UE first completes receiving).

Alternatively, regardless of the interval between the last symbol of the most recently received PDCCH and the first symbol of the first transmitted PUSCH, the UE determines a type 1 power headroom report and a maximum transmission power, based on actual PUSCH transmission associated with the first DCI (or TCI-State or TCI-UL-State associated with the CORESET having a coresetPoolIndex value of 0) or reference PUSCH transmission using p0AlphaSetforPUSCH and pathlosReferenceRS-Id. In this case, if the interval between the last symbol of the most recently received PDCCH and the first symbol of the first transmitted PUSCH is equal to or greater than PUSCH preparation time T_{proc,2} or

$${T}_{proc , 2}^{mux}$$

for PUSCH preparation time and multiplexing, the UE determines a type 1 power headroom report as an actual PHR and determines a maximum transmission power, based on actual PUSCH transmission associated with the first TCI (or TCI-State or TCI-UL-State associated with the CORESET having the coresetPoolIndex value of 0). If the interval between the last symbol of the most recently received PDCCH and the first symbol of the first transmitted PUSCH is smaller than PUSCH preparation time T_{proc,2} or

$${T}_{proc , 2}^{mux}$$

for PUSCH preparation time and multiplexing, and the PUSCH associated with the first TCI is scheduled by DCI in the most recently received PDCCH, the UE determines a type 1 power headroom report as a virtual PHR and determines a maximum transmission power, based on reference PUSCH transmission using p0AlphaSetforPUSCH and pathlosReferenceRS-Id associated with the first TCI (or TCI-State or TCI-UL-State associated with the CORESET having the coresetPoolIndex value of 0). Alternatively, if the UE determines a type 1 power headroom report and a maximum transmission power, based on PUSCH transmission associated with the first DCI (or TCI-State or TCI-UL-State associated with the CORESET having the coresetPoolIndex value of 0) regardless of the interval between the last symbol of the most recently received PDCCH and the first symbol of the first transmitted PUSCH, the UE may determine the type 1 power headroom report as an actual PHR and determine the maximum transmission power, based on actual PUSCH transmission associated with the first TCT (or TCI-State or TCI-UL-State associated with the CORESET having the coresetPoolIndex value of 0).

Referring to FIG. 12, illustrated is an example where two PUSCHs scheduled by two DCIs associated with different values of coresetPoolIndex received at different time points are partially overlapping in the time domain, and the two PUSCHs are simultaneously transmitted in slot n in which a PUSCH for power headroom reporting is transmitted. In the first example of FIG. 12, the first DCI 1200 is associated with a coresetPoolIndex value of 0 and is used to schedule the PUSCH 1202 transmitted via a spatial domain filter (or UL beam) corresponding to the first TCI, and the second DCI 1201 is associated with a coresetPoolIndex value of 1 and is used to schedule the PUSCH 1203 transmitted via a spatial domain filter (or UL beam) corresponding to the second TCI. If power headroom reporting is triggered and the UE reports power headroom information to the base station, if the UE does not support twoPHRmode (or the UE is not configured with twoPHRmode by the base station) as described above, and if a difference between the most recently received DCI 1201 and a start time point of a first symbol of the PUSCH 1202 transmitted earlier is equal to or greater than T_{proc,2} or

$${T}_{proc , 2}^{mux}$$

described above, the UE calculates a power headroom for the PUSCH 1202, which is associated with the first TCI (or TCI-State or TCI-UL-State associated with the CORESET having a coresetPoolIndex value of 0), as an actual PHR based on actual PUSCH transmission. Alternatively, if power headroom reporting is triggered and the UE reports power headroom information to the base station, if the UE does not support twoPHRmode (or the UE is not configured with twoPHRmode by the base station) as described above, and if the difference between the most recently received DCI 1201 and the start time point of the first symbol of the PUSCH 1202 transmitted earlier is equal to or greater than T_{proc,2} or

$${T}_{proc , 2}^{mux}$$

described above, the UE calculates a power headroom for the PUSCH 1202, which is associated with the first TCI and transmitted earlier among the PUSCHs 1202 and 1203 transmitted in slot n, as an actual PHR based on actual PUSCH transmission. Alternatively, if power headroom reporting is triggered and the UE reports power headroom information to the base station, and if the UE does not support twoPHRmode (or the UE is not configured with twoPHRmode by the base station) as described above, the UE calculates a power headroom for the PUSCH 1202, which is associated with the first TCI and scheduled by the first DCI 1200, as an actual PHR based on actual PUSCH transmission, regardless of the difference between the most recently received DCI 1201 and the start time point of the first symbol of the PUSCH 1202 transmitted earlier. Alternatively, if power headroom reporting is triggered and the UE reports power headroom information to the base station, and if the UE does not support twoPHRmode (or the UE is not configured with twoPHRmode by the base station) as described above, the UE may calculate a power headroom for the PUSCH 1202 associated with the first TCI (or TCI-State or TCI-UL-State associated with the CORESET having a coresetPoolIndex value of 0), regardless of the difference between the most recently received DCI 1201 and the start time point of the first symbol of the PUSCH 1202 transmitted earlier. In this case, if the difference between the most recently received DCI 1201 and the start time point of the first symbol of the PUSCH 1202 transmitted earlier is equal to or greater than T_{proc,2} or

$${T}_{proc , 2}^{mux} ,$$

the UE may calculate a power headroom for the PUSCH 1202, which is associated with the first TCI, as an actual PHR based on actual PUSCH transmission. In addition, if the difference between the most recently received DCI 1201 and the start time point of the first symbol of the PUSCH 1202 transmitted earlier is smaller than T_{proc,2} or

$${T}_{proc , 2}^{mux} ,$$

the UE calculates a power headroom for the PUSCH 1202, which is associated with the first TCI, as a virtual PHR based on reference PUSCH transmission.

In the second example of FIG. 12, the first DCI 1205 is associated with a coresetPoolIndex value of 1 and is used to schedule the PUSCH 1207 transmitted via a spatial domain filter (or UL beam) corresponding to the second TCI, and the second DCI 1204 is associated with a coresetPoolIndex value of 0 and is used to schedule the PUSCH 1206 transmitted via a spatial domain filter (or UL beam) corresponding to the first TCI. If power headroom reporting is triggered and the UE reports power headroom information to the base station, if the UE does not support twoPHRmode (or the UE is not configured with twoPHRmode by the base station) as described above, and if a difference between the most recently received DCI 1204 and a start time point of a first symbol of the PUSCH 1206 transmitted earlier is equal to or greater than T_{proc,2} or

$${T}_{proc , 2}^{mux}$$

described above, the UE calculates a power headroom for the PUSCH 1206, which is associated with the first TCI (or TCI-State or TCI-UL-State associated with the CORESET having a coresetPoolIndex value of 0), as an actual PHR based on actual PUSCH transmission. Alternatively, if power headroom reporting is triggered and the UE reports power headroom information to the base station, if the UE does not support twoPHRmode (or the UE is not configured with twoPHRmode by the base station) as described above, and if the difference between the most recently received DCI 1204 and the start time point of the first symbol of the PUSCH 1206 transmitted earlier is equal to or greater than T_{proc,2} or

$${T}_{proc , 2}^{mux}$$

described above, the UE calculates a power headroom for the PUSCH 1206, which is associated with the first TCI and transmitted earlier among the PUSCHs 1206 and 1207 transmitted in slot n, as an actual PHR based on actual PUSCH transmission. Alternatively, if power headroom reporting is triggered and the UE reports power headroom information to the base station, and if the UE does not support twoPHRmode (or the UE is not configured with twoPHRmode by the base station) as described above, the UE calculates a power headroom for the PUSCH 1207, which is associated with the second TCI and scheduled by the first DCI 1205, as an actual PHR based on actual PUSCH transmission, regardless of the difference between the most recently received DCI 1204 and the start time point of the first symbol of the PUSCH 1207 transmitted earlier. Alternatively, if power headroom reporting is triggered and the UE reports power headroom information to the base station, and if the UE does not support twoPHRmode (or the UE is not configured with twoPHRmode by the base station) as described above, the UE may calculate a power headroom for the PUSCH 1206 associated with the first TCI (or TCI-State or TCI-UL-State associated with the CORESET having a coresetPoolIndex value of 0), regardless of the difference between the most recently received DCI 1204 and the start time point of the first symbol of the PUSCH 1206 transmitted earlier. In this case, if the difference between the most recently received DCI 1204 and the start time point of the first symbol of the PUSCH 1206 transmitted earlier is equal to or greater than T_{proc,2} or

$${T}_{proc , 2}^{mux} ,$$

the UL may calculate a power headroom for the PUSCH 1206, which is associated with the first TCI, as an actual PHR based on actual PUSCH transmission. In addition, if the difference between the most recently received DCI 1204 and the start time point of the first symbol of the PUSCH 1206 transmitted earlier is smaller than T_{proc,2} or

$${T}_{p r oc , 2}^{m u x} ,$$

the UE calculates a power headroom for the PUSCH 1206, which is associated with the first TCI, as a virtual PHR based on reference PUSCH transmission. Alternatively, regardless of the difference between the most recently received DCI 1204 and the start time point of the first symbol of the PUSCH 1206 transmitted earlier, the UE may calculate a power headroom for the PUSCH 1206, which is associated with the first TCI, as an actual PHR based on actual PUSCH transmission.

In the third example of FIG. 12, the first DCI 1209 is associated with a coresetPoolIndex value of 1 and is used to schedule the PUSCH 1211 transmitted via a spatial domain filter (or UL beam) corresponding to the second TCI, and the second DCI 1208 is associated with a coresetPoolIndex value of 0 and is used to schedule the PUSCH 1210 transmitted via a spatial domain filter (or UL beam) corresponding to the first TCI. If power headroom reporting is triggered and the UE reports power headroom information to the base station, if the UE does not support twoPHRmode (or the UE is not configured with twoPHRmode by the base station) as described above, and if a difference between the most recently received DCI 1208 and a start time point of a first symbol of the PUSCH 1211 transmitted earlier is equal to or greater than T_{proc,2} or

$${T}_{p r oc , 2}^{m u x}$$

described above, the UE calculates a power headroom for the PUSCH 1210, which is associated with the first TCI (or TCI-State or TCI-UL-State associated with the CORESET having a coresetPoolIndex value of 0), as an actual PHR based on actual PUSCH transmission. Alternatively, if power headroom reporting is triggered and the UE reports power headroom information to the base station, if the UE does not support twoPHRmode (or the UE is not configured with twoPHRmode by the base station) as described above, and if the difference between the most recently received DCI 1208 and the start time point of the first symbol of the PUSCH 1211 transmitted earlier is equal to or greater than T_{proc,2} or

$${T}_{p r oc , 2}^{m u x}$$

described above, the UE calculates a power headroom for the PUSCH 1211, which is associated with the second TCI and transmitted earlier among the PUSCHs 1210 and 1211 transmitted in slot n, as an actual PHR based on actual PUSCH transmission. Alternatively, if power headroom reporting is triggered and the UE reports power headroom information to the base station, and if the UE does not support twoPHRmode (or the UE is not configured with twoPHRmode by the base station) as described above, the UE calculates a power headroom for the PUSCH 1211, which is associated with the second TCI and scheduled by the first DCI 1209, as an actual PHR based on actual PUSCH transmission, regardless of the difference between the most recently received DCI 1208 and the start time point of the first symbol of the PUSCH 1211 transmitted earlier. Alternatively, if power headroom reporting is triggered and the UE reports power headroom information to the base station, and if the UE does not support twoPHRmode (or the UE is not configured with twoPHRmode by the base station) as described above, the UE may calculate a power headroom for the PUSCH 1210 associated with the first TCI (or TCI-State or TCI-UL-State associated with the CORESET having a coresetPoolIndex value of 0), regardless of the difference between the most recently received DCI 1208 and the start time point of the first symbol of the PUSCH 1211 transmitted earlier. In this case, if the difference between the most recently received DCI 1208 and the start time point of the first symbol of the PUSCH 1211 transmitted earlier is equal to or greater than T_{proc,2} or

$${T}_{p r oc , 2}^{m u x} ,$$

the UE calculates a power headroom for the PUSCH 1210, which is associated with the first TCI, as an actual PHR based on actual PUSCH transmission, and if the distance between the most recently received DCI 1208 for scheduling of the PUSCH 1210 associated with the first TCI and the start time point of the first symbol of the PUSCH 1211 transmitted earlier is smaller than T_{proc,2} or

$${T}_{p r oc , 2}^{m u x} ,$$

the UE calculates a power headroom for the PUSCH 1210, which is associated with the first TCI, as a virtual PHR based on reference PUSCH transmission. Alternatively, regardless of the difference between the most recently received DCI 1208 and the start time point of the first symbol of the PUSCH 1211 transmitted earlier, the UE may calculate a power headroom for the PUSCH 1210, which is associated with the first TCI, as an actual PHR based on actual PUSCH transmission.
Case 2-2-3) In addition, PUSCH transmission associated with the first TCI (or scheduled by DCI in the PDCCH received on the first CORESET or associated with the CORESET having the coresetPoolIndex value of 0) and PUSCH transmission associated with the second TCI (or scheduled by DCI in the PDCCH received on the second CORESET or associated with the CORESET having coresetPoolIndex value is 1) may partially overlap or may not overlap in the time domain. In this case, if one of the two partially overlapping or non-overlapping PUSCHs is transmitted in slot n in which a PUSCH for power headroom reporting is transmitted, but the other PUSCH is transmitted across slot n and another slot (e.g., slot n+1) or transmitted in a slot other than slot n, the UE determines a type 1 power headroom report and a maximum transmission power, based on actual PUSCH transmission of the PUSCH scheduled by the first DCI (or DCI that the UE first starts receiving or DCI that the UE first completes receiving) or reference PUSCH transmission, regardless of the interval between the last symbol of the most recently received PDCCH and the first symbol of the first transmitted PUSCH. If the PUSCH scheduled by the first DCI is transmitted in slot n, the UE performs calculation as an actual PHR based on actual PUSCH transmission of the PUSCH scheduled by the first DCI, and if the PUSCH scheduled by the first DCI is transmitted in a slot other than slot n (e.g., transmitted in slot n+1 or across slot n and slot n+1), the UE performs calculation as a virtual PHR based on reference PUSCH transmission of the PUSCH scheduled by the first DCI.

Alternatively, if the interval between the last symbol of the most recently received PDCCH and the first symbol of the first transmitted PUSCH is equal to or greater than PUSCH preparation time T_{proc,2} or

$${T}_{p r oc , 2}^{m u x}$$

for PUSCH preparation time and multiplexing, the UE determines a type 1 power headroom and a maximum transmission power, based on actual PUSCH transmission of the PUSCH transmitted in slot n.

Alternatively, if the interval between the last symbol of the most recently received PDCCH and the first symbol of the first transmitted PUSCH is equal to or greater than PUSCH preparation time T_{proc,2} or

$${T}_{p r oc , 2}^{m u x}$$

for PUSCH preparation time and multiplexing, the UE determines a type 1 power headroom report and a maximum transmission power (configured maximum output power), based on actual PUSCH transmission transmitted via the spatial domain filter corresponding to the first TCI (or TCI-State or TCI-UL-State associated with the CORESET having a coresetPoolIndex value of 0) or reference PUSCH transmission. If the PUSCH associated with the first TCI is transmitted in slot n, the UE calculates an actual PHR based on actual PUSCH transmission of the PUSCH associated with the first TCI, and if the PUSCH associated with the first TCI is transmitted across slot n and another slot (e.g., slot n+1) or transmitted in a slot other than slot n, the UE calculates a virtual PHR based on reference PUSCH transmission of the PUSCH associated with the first TCI.

Alternatively, regardless of the interval between the last symbol of the most recently received PDCCH and the first symbol of the first transmitted PUSCH, the UE determines a type 1 power headroom report and a maximum transmission power, based on actual PUSCH transmission associated with the first DCI (or TCI-State or TCI-UL-State associated with the CORESET having a coresetPoolIndex value of 0) or reference PUSCH transmission using p0AlphaSetforPUSCH and pathlosReferenceRS-Id. In this case, if the interval between the last symbol of the most recently received PDCCH and the first symbol of the first transmitted PUSCH is equal to or greater than PUSCH preparation time T_{proc,2} or

$${T}_{p r oc , 2}^{m u x}$$

for PUSCH preparation time and multiplexing, the UE determines a type 1 power headroom report as an actual PHR and determines a maximum transmission power, based on actual PUSCH transmission associated with the first TCI (or TCI-State or TCI-UL-State associated with the CORESET having the coresetPoolIndex value of 0).

If the interval between the last symbol of the most recently received PDCCH and the first symbol of the first transmitted PUSCH is smaller than PUSCH preparation time T_{proc,2} or

$${T}_{p r oc , 2}^{m u x}$$

for PUSCH preparation time and multiplexing, and the PUSCH associated with the first TCI is scheduled by DCI in the most recently received PDCCH, the UE determines a type 1 power headroom report as a virtual PHR and determines a maximum transmission power, based on reference PUSCH transmission using p0AlphaSetforPUSCH and pathlosReferenceRS-Id associated with the first TCI (or TCI-State or TCI-UL-State associated with the CORESET having the coresetPoolIndex value of 0). Alternatively, if the UE determines a type 1 power headroom report and a maximum transmission power, based on PUSCH transmission associated with the first DCI (or TCI-State or TCI-UL-State associated with the CORESET having the coresetPoolIndex value of 0) regardless of the interval between the last symbol of the most recently received PDCCH and the first symbol of the first transmitted PUSCH, the UE may determine the type 1 power headroom report as an actual PHR and determine the maximum transmission power, based on actual PUSCH transmission associated with the first TCT (or TCI-State or TCI-UL-State associated with the CORESET having the coresetPoolIndex value of 0).

FIG. 13 illustrates an example of a case where two PUSCHs scheduled based on two DCIs associated with different values of coresetPoolIndex received at different time points are partially overlapping in the time domain, and one PUSCH is transmitted in slot n in which a PUSCH for power headroom reporting is transmitted, but the other PUSCH is transmitted in slot n and slot n+1 that is another slot.

Referring to FIG. 13, in the first example of FIG. 13, the first DCI 1300 is associated with a coresetPoolIndex value of 0 and is used to schedule the PUSCH 1302 transmitted via a spatial domain filter (or UL beam) corresponding to the first TCI, and the second DCI 1301 is associated with a coresetPoolIndex value of 1 and is used to schedule the PUSCH 1303 transmitted via a spatial domain filter (or UL beam) corresponding to the second TCI. If power headroom reporting is triggered and the UE reports power headroom information to the base station, and if the UE does not support twoPHRmode (or the UE is not configured with twoPHRmode by the base station) as described above, the UE performs calculation as an actual PHR based on actual PUSCH transmission of the PUSCH 1302 scheduled by the first DCI 1300, regardless of the interval between the last symbol of the most recently received DCI 1301 and the first symbol of the first transmitted PUSCH 1302. Alternatively, if power headroom reporting is triggered and the UE reports power headroom information to the base station, if the UE does not support twoPHRmode (or the UE is not configured with twoPHRmode by the base station) as described above, and if the interval between the last symbol of the most recently received DCI 1301 and the first symbol of the first transmitted PUSCH 1302 is equal to or greater than T_{proc,2} or

$${T}_{p r oc , 2}^{m u x} ,$$

the UE determines a type 1 power headroom and a maximum transmission power, based on actual PUSCH transmission of the PUSCH 1302 transmitted in slot n. Alternatively, if power headroom reporting is triggered and the UE reports power headroom information to the base station, if the UE does not support twoPHRmode (or the UE is not configured with twoPHRmode by the base station) as described above, and if the interval between the last symbol of the most recently received DCI 1301 and the first symbol of the first transmitted PUSCH 1302 is equal to or greater than T_{proc,2} or

$${T}_{p r oc , 2}^{m u x} ,$$

the UL calculates an actual power headroom based on actual PUSCH transmission of the PUSCH 1302 associated with the first TCI. Alternatively, if power headroom reporting is triggered and the UE reports power headroom information to the base station, and if the UE does not support twoPHRmode as described above, the UE determines a power headroom report and a maximum transmission power, based on the PUSCH 1302 associated with the first TCI, regardless of the interval between the last symbol of the most recently received DCI 1301 and the first symbol of the first transmitted PUSCH 1302. In this case, if the interval between the last symbol of the most recently received DCI 1301 and the first symbol of the first transmitted PUSCH 1302 is equal to or greater than T_{proc,2} or

$${T}_{p r oc , 2}^{m u x} ,$$

the UE performs calculation as an actual PHR based on actual PUSCH 1302 transmission associated with the first TCI.

In the second example of FIG. 13, the second DCI 1305 is associated with a coresetPoolIndex value of 1 and is used to schedule the PUSCH 1307 transmitted via a spatial domain filter (or UL beam) corresponding to the second TCI, and the second DCI 1301 is associated with a coresetPoolIndex value of 0 and is used to schedule the PUSCH 1306 transmitted via a spatial domain filter (or UL beam) corresponding to the first TCI. If power headroom reporting is triggered and the UE reports power headroom information to the base station, and if the UE does not support twoPHRmode (or the UE is not configured with twoPHRmode by the base station) as described above, the UE calculates a power headroom based the PUSCH 1306 scheduled by the first DCI 1304, regardless of the interval between the last symbol of the most recently received DCI 1305 and the first symbol of the first transmitted PUSCH 1307. In this case, since the PUSCH 1306 scheduled by the first DCI 1304 is transmitted across slot n and another slot (e.g., slot n+1), the UE performs calculation as a virtual PHR based on reference PUSCH transmission of the PUSCH 1306. Alternatively, if power headroom reporting is triggered and the UE reports power headroom information to the base station, if the UE does not support twoPHRmode (or the UE is not configured with twoPHRmode by the base station) as described above, and if the interval between the last symbol of the most recently received DCI 1305 and the first symbol of the first transmitted PUSCH 1307 is equal to or greater than T_{proc,2} or

$${T}_{p r oc , 2}^{m u x} ,$$

the UL determines a type 1 power headroom and a maximum transmission power, based on actual PUSCH transmission of the PUSCH 1307 transmitted in slot n. Alternatively, if, in this case, power headroom reporting is triggered and the UE reports power headroom information to the base station, if the UE does not support twoPHRmode (or the UE is not configured with twoPHRmode by the base station) as described above, and if the interval between the last symbol of the most recently received DCI 1305 and the first symbol of the first transmitted PUSCH 1307 is equal to or greater than T_{proc,2} or

$${T}_{p r oc , 2}^{m u x} ,$$

the UL Calculates a virtual power headroom based on virtual PUSCH transmission of the PUSCH 1306 associated with the first TCI. Alternatively, if power headroom reporting is triggered and the UE reports power headroom information to the base station, and if the UE does not support twoPHRmode (or the UE is not configured with twoPHRmode by the base station) as described above, the UE determines a power headroom report and a maximum transmission power, based on the PUSCH 1306 associated with the first TCI, regardless of the interval between the last symbol of the most recently received DCI 1305 and the first symbol of the first transmitted PUSCH 1307. In this case, although the interval between the last symbol of the most recently received DCI 1305 and the first symbol of the first transmitted PUSCH 1307 is equal to or greater than T_{proc,2} or

$${T}_{p r oc , 2}^{m u x} ,$$

since the PUSCH 1306 associated with the first TCI is transmitted across slot n and another slot (e.g., slot n+1), the UE calculates a virtual PHR based on reference PUSCH transmission of the PUSCH 1306 associated with the first TCI. The UE may calculate a value for type 1 power headroom reporting and determine a maximum transmission power, based on actual PUSCH transmission or reference PUSCH transmission by considering the cases above. The type 1 power headroom and maximum transmission power determined by the UE as described above may be reported to the base station via one of the following PUSCHs. In this case, before determining a power headroom and a maximum transmission power for each case described above, the UE may first select a PUSCH, via which a MAC CE for power headroom reporting is transmitted, by considering one or a combination of the following options:
The UE may transmit, on a PUSCH scheduled by first DCI (or DCI that the UE first starts receiving or DCI that the UE first completes receiving), a MAC CE for power headroom reporting.
The UE may transmit, on a PUSCH transmitted earlier, a MAC CE for power headroom reporting. In this case, a slot in which the PUSCH including the MAC CE for power headroom reporting is transmitted may be defined as slot n.
The UE may transmit, on two overlapping PUSCHs, a MAC CE for power headroom reporting. In this case, the common slot in which the PUSCHs including the MAC CE for power headroom reporting are transmitted may be defined as slot n, or a slot in which a PUSCH transmitted earlier among the two PUSCHs is transmitted may be defined as slot n. Alternatively, a slot in which a PUSCH scheduled by first DCI is transmitted may be defined as slot n.
The UE supports UL CA and may transmit, on a PUSCH transmitted to another serving cell, a MAC CE for power headroom reporting. In this case, a slot, in which the PUSCH transmitted to another serving cell and including the power headroom MAC CE is transmitted, may be defined as slot n, and if SCS of the serving cell to which the PUSCH including the MAC CE is transmitted is different from SCS of a serving cell which supports mDCI-based STxMP and determines a power headroom as described above, the power headroom is calculated based on slot n of the serving cell to which the PUSCH including the MAC CE is transmitted.

When the UE determines a value of a field for power headroom reporting and calculates a corresponding maximum transmission power for each case described above, a first type 1 power headroom report field and a first maximum transmission power field are associated with a first TCI (or scheduled by DCI in a PDCCH received on a first CORESET or associated with a CORESET having a coresetPoolIndex value of 0), and a second type 1 power headroom report field and a second maximum transmission power field are associated with a second TCI (or scheduled by DCI in a PDCCH received on a second CORESET or associated with a CORESET having a coresetPoolIndex value of 1).

However, differently, the UE may report a power headroom and a maximum transmission power for a PUSCH, for which an actual PHR has been calculated based on actual PUSCH transmission, via the first type 1 power headroom report field and the first maximum transmission power field, and may report a power headroom and a maximum transmission power for a PUSCH, for which a virtual PHR has been calculated based on reference PUSCH transmission, via the second type 1 power headroom report field and the second maximum transmission power field.

Alternatively, the UE may report a power headroom and a maximum transmission power for a PUSCH, which is transmitted earlier (having an earlier start symbol) among two PUSCHs transmitted in slot n, via the first type 1 power headroom report field and the first maximum transmission power field, and may report a power headroom and a maximum transmission power for a subsequently transmitted PUSCH (having a later start symbol) via the second type 1 power headroom report field and the second maximum transmission power field.

Alternatively, the UE may report a power headroom and a maximum transmission power for a PUSCH, which is completed earlier in transmission (having an earlier end symbol) among two PUSCHs transmitted in slot n, via the first type 1 power headroom report field and the first maximum transmission power field, and may report a power headroom and a maximum transmission power for a PUSCH, which is completed later in transmission (having a later end symbol), via the second type 1 power headroom report field and the second maximum transmission power field.

The aforementioned method may additionally be considered to configure the first type 1 power headroom report field and the first maximum transmission power field, and the second type 1 power headroom report field and the second maximum transmission power field, and if a PUSCH associated with each field cannot be determined using the aforementioned method, a PUSCH associated with each power headroom field and each maximum transmission power field may be determined according to a TCI state associated with each PUSCH.

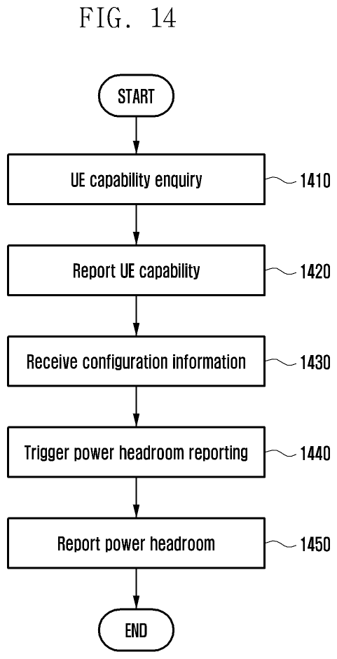

FIG. 14 is a diagram illustrating an operation of a UE according to an embodiment of the disclosure.

Referring to FIG. 14, in operation 1410, a UE may receive a UE capability enquiry from a base station. In addition, the UE may transmit, in operation 1420, a UE capability to the base station in response to the UE capability enquiry. The UE capability may include information indicating whether the UE supports twoPHRmode. In addition, the UE capability may include information indicating whether the UE supports mDCI STxMP transmission. Specific details are the same as described above, and will be thus omitted hereinafter.

Operation 1410 and operation 1420 may be omitted depending on a situation. For example, in a situation where the base station has already received the UE capability from the UE and stored the same, a subsequent operation may be performed without separately requesting a UE capability report.

The UE may receive power headroom-related configuration information, in operation 1430. The power headroom configuration information may include information on twoPHRmode. In a case where the UE does not support twoPHRmode, or twoPHRmode is not enabled in the power headroom-related configuration information, or in a case where twoPHRmode is enabled in the power headroom-related configuration information, a specific method of determining a power headroom is the same as described above, and descriptions thereof will be thus omitted hereinafter.

The power headroom-related configuration information may be included in an RRC message, and the RRC message may include an RRCReconfiguration message, an RRCSetup message, or the like. The RRC message may include at least one of, for example, information on an SRS resource set (e.g., srs-ResourceSetToAddModList or srs-ResourceSetToAddModListDCI-0-2), information on multipanelScheme (e.g., multipanelSchemeSDM or multipanelSchemeSFN), TCI-related information, STx-2panel information (STx-2panel information may refer to information indicating simultaneous uplink transmission via multiple panels in mDCI) that is information for supporting an mDCI STxMP technique, and configuration information on CORESETs having different values of coresetPoolIndex. For example, in order to configure the mDCI STxMP technique, the base station may configure, for the UE via the RRC message, STx-2panel information and CORESET configuration having different values of coresetPoolIndex.

The UE may identify whether power headroom reporting has been triggered, in operation 1440. For example, the power headroom reporting may be triggered when a timer included in the power headroom-related configuration information expires. However, the embodiment of the disclosure is not limited thereto, and power headroom reporting may be triggered even when other conditions are satisfied. In addition, the UE may report a power headroom to the base station, in operation 1450. A specific method of configuring the power headroom is the same as described above, and descriptions thereof will be thus omitted hereinafter.

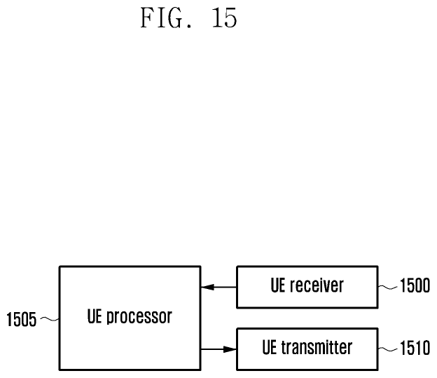

FIG. 15 illustrates a structure of a UE in a wireless communication system according to an embodiment of the disclosure.

Referring to FIG. 15, the UE may include a transceiver, which refers to a UE receiver 1500 and a UE transmitter 1510 as a whole, memory (not illustrated), and a UE processor 1505 (or UE controller or processor). The UE receiver 1500 and the UE transmitter 1510, the memory, and the UE processor 1505 may operate according to the above-described communication methods of the UE. However, components of the UE are not limited to the above-described example. For example, the UE may include a larger or smaller number of components than the above-described components. Furthermore, the transceiver, the memory, and the processor may be implemented in the form of a single chip.

The transceiver may transmit/receive signals with base stations. The signals may include control information and data. To this end, the transceiver may include an RF transmitter configured to perform amplification and up-conversion of a frequency of a transmitted signal, an RF receiver configured to perform low-noise amplification of a received signal and down-conversion of a frequency, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the UE. In addition, the memory may store control information or data included in signals transmitted/received by the UE. The memory may include storage media such as read only memory (ROM), random access memory (RAM), a hard disk (HDD), a compact disc-ROM (CD-ROM), and a digital versatile disc (DVD), or a combination of storage media. In addition, the memory may include multiple memories.

Furthermore, the processor may control a series of processes such that the UE can operate according to the above-described embodiments. For example, the processor may control components of the UE to receive DCI configured in two layers so as to simultaneously receive multiple PDSCHs. The processor may include multiple processors, and the processor may perform operations of controlling the components of the UE by executing programs stored in the memory.

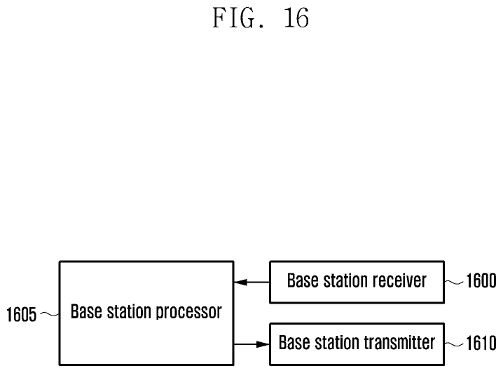

FIG. 16 illustrates a structure of a base station in a wireless communication system according to an embodiment of the disclosure.

Referring to FIG. 16, the base station may include a transceiver, which refers to a base station receiver 1600 and a base station transmitter 1610 as a whole, memory (not illustrated), and a base station processor 1605 (or base station controller or processor). The base station receiver 1600 and the base station transmitter 1610, the memory, and the base station processor 1605 may operate according to the above-described communication methods of the base station. However, components of the base station are not limited to the above-described example. For example, the base station may include a larger or smaller number of components than the above-described components. Furthermore, the transceiver, the memory, and the processor may be implemented in the form of a single chip.

The transceiver may transmit/receive signals with UEs. The signals may include control information and data. To this end, the transceiver may include an RF transmitter configured to perform amplification and up-conversion of a frequency of a transmitted signal, an RF receiver configured to perform low-noise amplification of a received signal and down-conversion of a frequency, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the UE. In addition, the memory may store control information or data included in signals transmitted/received by the base station. The memory may include storage media such as a ROM, a RAM, a hard disk, a CD-ROM, and a DVD, or a combination of storage media. In addition, the memory may include multiple memories.

The processor may control a series of processes such that the base station can operate according to the above-described embodiments of the disclosure. For example, the processor may control components of the base station to configure DCI configured in two layers including allocation information regarding multiple PDSCHs and to transmit the same. The processor may include multiple processors, and the processor may perform operations of controlling the components of the base station by executing programs stored in the memory.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including random access memory and flash memory, read only memory (ROM), electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on the FDD LTE system, other variants based on the technical idea of the embodiments may also be implemented in other communication systems such as TDD LTE, and 5G, or NR systems.

In the drawings in which methods of the disclosure are described, the order of the description does not always correspond to the order in which steps are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In addition, in methods of the disclosure, some or all of the contents of each embodiment may be implemented in combination without departing from the essential spirit and scope of the disclosure.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a communication system, the method comprising:
receiving, from a base station, a radio resource control (RRC) message including a power headroom reporting (PHR) configuration and a control resource set (CORESET) configuration;
identifying that a PHR is triggered; and
in case that two PHR mode is not included in the PHR configuration and two physical uplink shared channel (PUSCH) transmissions associated with different coresetPoolIndex values included in the CORESET configuration are overlapped in time, transmitting, to the base station, one PHR for a PUSCH transmission associated with coresetPoolIndex value 0.

2. The method of claim 1, wherein the RRC message includes information associated with simultaneous transmission with 2 Panel (sTx-2Panel) and sounding reference signal (SRS) configuration including information on SRS resource sets.

3. The method of claim 1, further comprising:
in case that the two PHR mode is not included in the PHR configuration and information on a multipanelScheme is configured, transmitting, to the base station, one PHR and one configured maximum output power associated with a first transmission configuration indicator (TCI) state.

4. The method of claim 1, further comprising:
transmitting, by the terminal to the base station, a capability message including information indicating whether the terminal supports the two PHR mode related to sTx-2Panel.

5. A method performed by a base station in a communication system, the method comprising:
transmitting, to a terminal, a radio resource control (RRC) message including a power headroom reporting (PHR) configuration and a control resource set (CORESET) configuration; and
in case that a PHR is triggered, receiving, from the terminal, one PHR for a physical uplink shared channel (PUSCH) transmission associated with coresetPoolIndex value 0 based on two PHR mode being not included in the PHR configuration and two PUSCH transmissions associated with different coresetPoolIndex values included in the CORESET configuration overlapping in time.

6. The method of claim 5, wherein the RRC message includes information associated with simultaneous transmission with 2 Panel (sTx-2Panel) and sounding reference signal (SRS) configuration including information on SRS resource sets.

7. The method of claim 5, further comprising:
in case that the two PHR mode is not included in the PHR configuration and information on a multipanelScheme is configured, receiving, from the terminal, one PHR and one configured maximum output power associated with a first transmission configuration indicator (TCI) state.

8. The method of claim 5, further comprising:
receiving from the terminal, a capability message including information indicating whether the terminal supports the two PHR mode related to sTx-2Panel.

9. A terminal in a communication system, the terminal comprising:
at least one transceiver;
at least one processor communicatively coupled to the at least one transceiver; and
at least one memory, communicatively coupled to the at least one processor, storing instructions executable by the at least one processor individually or in any combination to cause the terminal to:
receive, from a base station, a radio resource control (RRC) message including a power headroom reporting (PHR) configuration and a control resource set (CORESET) configuration,
identify that a PHR is triggered, and
in case that two PHR mode is not included in the PHR configuration and two physical uplink shared channel (PUSCH) transmissions associated with different coresetPoolIndex values included in the CORESET configuration are overlapped in time, transmit, to the base station, one PHR for a PUSCH transmission associated with coresetPoolIndex value 0.

10. The terminal of claim 9, wherein the RRC message includes information associated with simultaneous transmission with 2 Panel (sTx-2Panel) and sounding reference signal (SRS) configuration including information on SRS resource sets.

11. The terminal of claim 9, wherein the instructions executable by the at least one processor individually or in any combination further cause the terminal to:
in case that the two PHR mode is not included in the PHR configuration and information on a multipanelScheme is configured, transmit, to the base station, one PHR and one configured maximum output power associated with a first transmission configuration indicator (TCI) state.

12. The terminal of claim 9, wherein the instructions executable by the at least one processor individually or in any combination further cause the terminal to:
transmit, to the base station, a capability message including information indicating whether the terminal supports the two PHR mode related to sTx-2Panel.

13. A base station in a communication system, the base station comprising:
at least one transceiver;
at least one processor communicatively coupled to the at least one transceiver; and
at least one memory, communicatively coupled to the at least one processor, storing instructions executable by the at least one processor individually or in any combination to cause the base station to:
transmit, to a terminal, a radio resource control (RRC) message including a power headroom reporting (PHR) configuration and a control resource set (CORESET) configuration, and
in case that a PHR is triggered, receive, from the terminal, one PHR for a physical uplink shared channel (PUSCH) transmission associated with coresetPoolIndex value 0 based on two PHR mode being not included in the PHR configuration and two PUSCH transmissions associated with different coresetPoolIndex values included in the CORESET configuration overlapping in time.

14. The base station of claim 13, wherein the instructions executable by the at least one processor individually or in any combination further cause the base station to:
in case that the two PHR mode is not included in the PHR configuration and information on a multipanelScheme is configured, receive, from the terminal, one PHR and one configured maximum output power associated with a first transmission configuration indicator (TCI) state.

15. The base station of claim 13,
wherein the instructions executable by the at least one processor individually or in any combination further cause the base station to:
receive, from the terminal, a capability message including information indicating whether the terminal supports the two PHR mode related to simultaneous transmission with 2 Panel (sTx-2Panel), and
wherein the RRC message includes information associated with the sTx-2Panel and a sounding reference signal (SRS) configuration including information on SRS resource sets.
